(19) United States
(12) Patent Application Publication
(10) Pub. No.: US 2009/0128747 A1
(43) Pub. Date: May 21, 2009

(54) Method for Producing Cellulose Acylate Film, Polarizing Plate and Liquid Crystal Display

(75) Inventors: Susumu Sugiyama, Kanagawa (JP); Hajime Nakayama, Kanagawa (JP); Ikuko Ohgaru, Kanagawa (JP); Hirofumi Toyama, Kanagawa (JP); Yoshiaki Hisakado, Kanagawa (JP); Yoichi Maruyama, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku ,Tokyo (JP)

(21) Appl. No.: 11/989,599

(22) PCT Filed: Sep. 12, 2006
(86) PCT No.: PCT/JP2006/318453

§ 371 Date: Jan. 29, 2008

(30) Foreign Application Priority Data
Sep. 12, 2005 (JP) 2005-263668
Oct. 13, 2005 (JP) 2005-299129
Mar. 29, 2006 (JP) 2006-091751

(51) Int. Cl. G02F 1/1335; B29D 11/00; G02B 1/08

(52) U.S. Cl. 349/96; 264/1.34; 359/500

(57) ABSTRACT

A method for producing a cellulose acylate film is provided and includes the steps of: a stretching step of stretching a film; and a shrinking step of shrinking the film

### TECHNICAL FIELD

The present invention relates to a method for producing a cellulose acylate film, and also relates to a polarizing plate and a liquid crystal display.

### BACKGROUND ART

A liquid crystal display comprises a liquid crystal cell and a polarizing plate. The polarizing plate comprises a protecting film which is generally formed from cellulose acetate, and a polarizer, and the polarizing plate is obtained by, for example, dyeing a polarizer formed from polyvinyl alcohol film, with iodine, stretching the polarizer, and stacking protecting film on both sides of the polarizer. In a transmissive liquid crystal display, such a polarizing plate are attached on both sides of the liquid crystal cell, and one or more sheets of optical compensation film may be further disposed. In a reflective liquid crystal display, the arrangement is usually made in an order of a reflective plate, a liquid crystal cell, one or more sheets of optical compensation film, and a polarizing plate. The liquid crystal cell comprises liquid crystalline molecules, two sheets of substrates to encapsulate the liquid crystalline molecules, and an electrode layer to apply voltage on the liquid crystalline molecules. The liquid crystal cell performs the ON/OFF indication by means of the difference in the alignment state of the liquid crystalline molecules, and there have been suggested display modes such as TN (Twisted Nematic), IPS (In-Plane Switching), OCB (Optically Compensatory Bend), VA (Vertically Aligned), and ECB (Electrically Controlled Birefringence), which are applicable to both the transmissive type and the reflective type.

Among such LCDs, for the uses where high display quality is needed, 90 degree twisted nematic liquid crystal displays (hereinafter, referred to as TN mode), which use nematic liquid crystal molecules having positive dielectric anisotropy and are driven by thin film transistors, are predominantly used. However, TN mode display devices have a viewing angle characteristic that although the devices have excellent display (characteristics when viewed from the front, the contrast is lowered when viewed from an oblique direction, and tone reversal occurs in which the brightness is reversed in the gray-scale display, thus the display characteristics being deteriorated. Now, an improvement in this aspect is strongly desired.

Meanwhile, liquid crystal modes for wide viewing angle, such as the IPS mode, OCB mode and VA mode, are associated with a recent increase in the demand for liquid crystal TV's, and the share is ever extending. For the respective modes, enhancement in the display quality has been achieved every year, but color shift occurring when viewed from an oblique direction has not been improved.

In addition, it is known that for a retardation plate, particularly a ¼ wavelength plate, of a polymer alignment film, the formulae: 0.6<Δn·d(450)/Δn·d(550)<0.97 and 1.01<Δn·d(650)/Δn·d(550)<1.35 are satisfied (wherein Δn·d(λ) is the retardation of the polymer alignment film at a wavelength of λ nm) (JP-A No: 2000-137116).

### DISCLOSURE OF THE INVENTION

An object of an illustrative, non-limiting embodiment of the invention is to provide a cellulose acylate film, particularly for the VA, EPS or OCB mode liquid crystal display, which precisely optically compensates a liquid crystal cell of the display, and which has high contrast and an improved color shift that is dependent on the viewing direction during black display, a method for producing the same, and a polarizing plate using the cellulose acylate film.

Another object of an illustrative, non-limiting embodiment of the invention is to provide liquid crystal displays, particularly of the VA, IPS or OCB mode, in which contrast is improved, and the color shift that is dependent on the viewing direction during black display is improved.

The following measures can be taken to achieve the objects.

1) A method for producing a cellulose acylate film, comprising the steps of: a stretching step of stretching a film, and a shrinking step of shrinking the film.

2) The method according to 1) above, wherein the stretching step comprises stretching the film in a film of conveying direction (the film conveying direction), and the shrinking step comprises shrinking the film in a width direction of the film (the film width direction) while gripping the film.

3) The method according to 1) above, wherein the stretching step comprises stretching the film in the film width direction, and the shrinking step comprises shrinking the film in the film conveying direction.

4) The method according to any one of 1) to 3) above, wherein at least a part of the stretching step and at least a part of the shrinking step are performed simultaneously.

5) The method according to any one of 1) to 4) above, wherein a stretch ratio X % of the film in the stretching step and a shrink ratio Y % of the film in the shrinking step satisfies formula (Z):

400−4000/\sqrt{100+X}≧Y≧100−1000/\sqrt{100+X}.

6) The method according to any one of 1) to 5) above, wherein the stretching step and the shrinking step are performed at a temperature higher by 25 to 100° C. than a glass transition temperature of the film at the beginning of each step.

7) A cellulose acylate film produced by a method according to any one of 1) to 6) above.

8) The cellulose acylate film according to claim 7, which satisfies formula (A):

10≧|Rth(550)10%RH−Rth(550)60%RH|

wherein Rth(550) 10% RH and Rth(550) 60% RH are Rth(550) at 25° C. at 10% RH and 60% RH, respectively.

9) The cellulose acylate film according to 7) or 8) above, which has an in-plane retardation Re of 20 to 100 nm at a wavelength of 550 nm and has a retardation in the film thickness direction Rth of 100 to 300 nm at a Wavelength of 550 nm.

10) The cellulose acylate film according to any one of 7) to 9) above, wherein satisfies formulae (I) to (III):

0.4<{(Re(450)/Rth(450))/(Re(550)/Rth(550))}<0.95 and 1.05<{(Re(650)/Rth(650))/(Re(550)/Rth(550))}<1.9 (I)

0.1<(Re(450)/Re(550))<0.95 (II)

1.03<(Re(650)/Re(550))<1.93. (III)

wherein Re(λ) is an in-plane retardation Re (unit: nm) at a wavelength, of λ nm, and Rth(λ) is a retardation in the film thickness direction Rth (unit: nm) at a wavelength of λ nm.

11). The cellulose acylate film according to any one of 7) to 10) above, which comprises cellulose acylate satisfying formulae (IV) and (V).

2.0≦(DS2+DS3+DS6)≦3.0 (IV)

DS6/(DS2+DS3+DS6)≧0.315 (V)

wherein DS2 is a substitution degree of a hydroxyl group at 2-position of a glucose unit in the cellulose acylate, DS3 is a substitution degree of a hydroxyl group at 3-position of the glucose unit, and DS6 is a substitution degree of a hydroxyl group at 6-position of the glucose unit.

12) The cellulose acylate film according to any one of 7) to 11) above, which comprises a cellulose acylate satisfying formulae (VI) and (VII):

2.0≦A+B≦3.0 (VI)

0<B (VII)

wherein A is a substitution degree of a hydroxyl group in a glucose units of the cellulose acylate by an acetyl group, and B is a substitution degree of substitution of a hydroxyl group in the glucose unit by one of a propionyl group, a butyryl group and a benzoyl group.

13) The cellulose acylate film according to any one of 7) to 12), which comprises a retardation increasing agent.

14) A polarizing plate comprising: a polarizer; and a pair of protecting films sandwiching the polarizer, wherein at least one of the protecting films is a the cellulose acylate film according to any one of 7) to 13) above.

15) A liquid crystal display comprising the cellulose acylate film according to any one of 7) to 13) above, or the polarizing plate according to 14) above.

16) A liquid crystal display of IPS, OCB or VA mode, comprising a liquid crystal cell and a pair of polarizing plates sandwiching the liquid crystal cell, wherein at least one of the polarizing plates is the polarizing plate according to 14).

17) A VA mode liquid crystal display comprising a polarizing plate according to 14) above on the backlight side.

### DETAILED DESCRIPTION OF THE INVENTION

In the present specification, “45°”, “parallel” or “perpendicular” mean the angles are within the range of (the precise angle ±less than 5°). The deviation from the precise angle is preferably less than 4°, and more preferably less than 3°. For the angle, “+” means a clockwise direction, and “−” means an anticlockwise direction. The “slow axis” means a direction which gives the maximum refractive index. Additionally, the “visible region” refers to from 380 nm to 780 nm, and the wavelength for measuring the refractive index is, unless stated otherwise, a value at λ=550 nm in the visible region.

According to the present specification, the “polarizing plate” is used to mean, if not particularly stated otherwise, both a long polarizing plate and a polarizing plate-cut (according to the present specification, the term “cut” encompasses “punching”, “clipping” and the like) to die size to be installed in the liquid crystal display. Also, according to the present specification, the “polarizer” and the “polarizing plate” are distinctively used, but the “polarizing plate” is used to mean a layered product comprising the “polarizer”, and a transparent protecting film on at least one side of the “polarizer” to protect the polarizer.

According to the present specification, Re(λ) and Rth(λ) represent the in-plane retardation and the retardation in the thickness direction, respectively, at a wavelength of λ. Re(λ) is measured using KOBRA 21ADH or WR (manufactured by Oji Scientific Instruments, Ltd.), by irradiating a light at a wavelength of λ nm incidentally to the direction normal to the film.

When the film being measured is represented as a uniaxial or biaxial optical indicatrix, Rth(λ) is calculated by the following method.

For Rth(λ), the above-described Re(λ) is measured at six points by taking the in-plane slow axis (determined by KOBRA 21ADH or WR) as the tilting axis (rotating axis) (when there is no slow axis, an arbitrary direction in the film plane is taken as the rotating axis), and irradiating a light at a wavelength of λ nm incidentally to the film normal direction, from the respective tilting directions selected in an interval of 10° in the range from the normal direction to 50° on either side, and Rth(λ) is calculated based on the measured retardation values, assumed values for the average refractive indices, and the input film thickness, by using KOBRA 21ADH or WR.

In this regard, in the case of a film having a direction in which the retardation value would be zero at a certain tilting angle in the range of from the normal direction to the in-plane slow axis as the rotating axis, Rth(λ) is calculated by KOBRA 21 ADH or WR, after changing the symbol of the retardation value at a tilting angle larger than the tilting angle mentioned above, to negative.

Furthermore, retardation values may be measured from any two tilting directions, while taking the slow axis as the tilting axis (rotating axis) (when there is no slow axis, any direction in the film plane is taken as the rotating axis), based on the values, an assumed value for the average refractive index, and the input film thickness, according to formula (1) and formula (2).

$$Re ( θ ) = [ nx - \frac{( ny \times nz )}{\sqrt{{( ny sin ( {sin}^{- 1} ( \frac{sin ( - θ )}{nx} ) ) )}^{2} + {( nz cos ( {sin}^{- 1} ( \frac{sin ( - θ )}{nx} ) ) )}^{2}}} ] \times \frac{d}{cos ( {sin}^{- 1} ( \frac{sin ( - θ )}{nx} ) )} \qquad Formula ( 1 )$$

(Remarks: The above-mentioned Re(θ) represents the retardation value in a direction tilting from the normal direction at an angle of θ. In formula (1), nx represents the refractive index in the in-plane slow axis, ny represents the refractive index in a direction perpendicular to the in-plane nx; and nz represents the refractive index in a direction perpendicular to nx and ny.

Rth=((nx+ny)/2−nz)xd Formula 2

d represents a thickness of the film.)

In the case of a film in which the film being measured cannot be represented as a uniaxial or biaxial optical indicatrix, so-called an optic axis, Rth(λ) is calculated by the following method.

For Rth(λ), the above-mentioned Re(λ) is measured at 11 points by taking the in-plane slow axis (determined by KOBRA 21 ADH or WR) as the tilting axis (rotating axis) (when there is no slow axis, an arbitrary direction in the film plane is taken as the rotating axis), and irradiating a light at a wavelength of λ nm incidentally to the film normal direction, from the respective tilting directions selected in an interval of 10° in the range from −50° to +50° with respective to the film normal direction, and Rth(λ) is calculated based on the measured retardation values, assumed values for the average refractive indices, and the input film thickness, by using KOBRA 21 ADH or WR.

For the above measurement, the assumed values for average refractive indices can be taken from the Polymer Handboook (John Wiley & Sons, Inc.), and various catalogues of optical films for use. An average refractive index value that is not available as an existing value can be measured with an Abbe refractometer. The average refractive index values for main optical films are listed below: cellulose acylate (1.48), cycloolefin polymer (1.52), polycarbonate (1.59), polymethyl methacrylate (1.49), and polystyrene (1.59). When these assumed values of average refractive indices and film thicknesses are input, the KOBRA 21ADH or WR calculates nx, ny and nz. From these calculated nx, ny and nz, Nz= (nx−nz)/(nx−ny) is further calculated.

According to an exemplary embodiment of the invention, which was completed on the basis of the findings obtained as a result of assiduous investigation of the present inventors, a cellulose acylate film allows optical compensation in the black state of particularly the VA mode, EPS mode or OCB mode, for virtually all wavelengths. As a result, a liquid crystal display according to an exemplary embodiment of the invention reduces light leakage in an oblique direction during black display, thus remarkably improving the viewing angle contrast. Furthermore, since a liquid crystal display according to an exemplary embodiment of the invention can suppress light leakage in an oblique direction during black display in the Virtually entire visible light wavelength region, the traditional problem of color difference during black display, which is dependent on the viewing angle, is significantly improved.

According to an exemplary embodiment of the invention, an optical characteristic in which the wavelength dispersions of retardation differ when the incident light is in the normal direction and when the incident light is in an oblique direction tilted from the normal direction, for example, in the direction of a polar angle of 60°, is imparted to a cellulose acylate film, and this optical characteristic is actively used in optical compensation. The scope of the invention is not limited to the display mode of a liquid crystal layer (i.e., a liquid crystal cell), and can be used for liquid crystal displays having a liquid crystal layer of any display mode such as the VA mode, EPS mode, ECB mode, TN mode, OCB mode and the like.

Hereinafter, exemplary embodiments of the present invention will be described in detail.

(Method for Production of the Invention)

The present inventors have assiduously conducted investigation, and as a result, found that a cellulose acylate film having preferred optical properties as described above is obtained by means of a method for producing cellulose acylate film, comprising a stretching process for stretching the film and a shrinking process for shrinking the film.

Initiation of the shrinking process refers to the time when reduction of the dimension of a film substantially begins, and the reduction of the dimension of a film includes, for example, the reduction induced by exertion of an external physical force to the film, and the reduction not induced by exertion of an external physical force to the film, such as thermal shrinkage. Termination of the shrinking process refers to the time when reduction of the dimension of a film substantially ends.

Similarly, initiation of the stretching process refers to the time when increment of the dimension of a film substantially begins, and the increment of the dimension of a film is, for example, physically applying a stretching treatment by exerting force on the film. Termination of the stretching process refers to the time when the stretching treatment is physically terminated by stopping exertion of force to the film.

In the present invention, the method for producing cellulose acylate comprising a stretching process for stretching the film in the film conveying direction, and a shrinking process for shrinking the film in the film width direction while gripping the film, or the method for producing cellulose acylate comprising a stretching process for stretching the film in the film width direction and a shrinking process for shrinking the film in the film conveying direction, is preferably used.

First, the method for producing cellulose acylate comprising a stretching process for stretching the film in the film conveying direction, and a shrinking process for shrinking the film in the film width direction while gripping the film will be described.

In this case, the film is stretched in the film conveying direction, but for the method of stretching the film in the film conveying direction, a method of making a difference in the circumferential velocity of a plurality of rollers, and stretching a film in the longitudinal direction using the difference in the circumferential velocity of the rollers, is preferably used. Also, for the film production according to a solution flow casting method, when a film is flow cast on a stainless steel band or a drum, and the film is peeled off in a semi-dry state, a method of adjusting the speed of the film conveying rollers, and making the film winding rate faster than the film peeling rate, is also preferably used.

When the film is conveyed while gripping the film in the film width direction with an apparatus called tenter for fixing both edges of the film with clips or pins, and the width of the tenter is gradually narrowed, the film can be shrunken approximately perpendicularly to the stretching direction.

The stretching process and the shrinking process can be carried out sequentially, or sequentially in an order of either stretching/shrinking or shrinking/stretching.

Furthermore, it is also possible to carry out shrinking by gripping the film with a tenter which operates biaxially in the conveying direction and the width direction, such as in the chain mode, screw mode, pantagraph mode, linear motor mode or the like, and gradually narrowing the width of the tenter in the perpendicular direction, while stretching the film by gradually widening the distance between the clips in the conveying direction.

Meanwhile, in the method for producing cellulose acylate comprising a stretching process for stretching the film in the film width direction and a shrinking process for shrinking the film in the film conveying direction, it is possible to carry out shrinking by grapping the film with a tenter which operates biaxially in the conveying direction and the width direction, such as in the chain mode, screw mode, pantagraph mode, linear motor mode or the like, and gradually narrowing the distance between the clips in the conveying direction, while stretching the film in the film width direction.

The method of using a tenter which operates biaxially in the film conveying direction and the width direction, as described above, can be said to simultaneously perform at least a part of the stretching process and at least a part of the shrinking process. As a result of the research of the present inventors, it was found that such simultaneous treatment was advantageous in that it is easy to reduce any non-uniformity between stretching and shrinking in a film plane, which is called bowing, by adjusting the timing of the stretching and shrinking, draw ratio and speed.

Moreover, as a stretching apparatus which specifically performs a stretching process of stretching a film either in the longitudinal direction (the film conveying direction) or the width direction, while simultaneously shrinking in the other direction, and simultaneously increasing the film thickness, a FITZ machine manufactured by Ichikin Engineering Co., Ltd. can be preferably used. This apparatus is described in JP-A No. 2001-38802.

With regard to the stretch ratio for the stretching process and the shrink ratio for the shrinking process, the present inventors conducted assiduous researches, and as a result, they found that in order to satisfy the relationships of the above-mentioned formulae (II) and (III) to obtain Re in the desired range (20 to 100 nm), it is effective when the relationship between the stretch ratio X % for the stretching process and the shrink ratio Y % for the shrinking process satisfies the formula (Z).

400−4000/\sqrt{100+X}≧Y≧100−1000/\sqrt{100+X} (Z)

When the relationship between the stretch ratio and the shrink ratio is less than the lower limit of the formula (Z), in order to satisfy the relationships of the desired Re and the formulae (II) and (III), it is necessary to have any technological response such as combined use of special additives or a blend of polymers of different species, etc., and these cause other problems such as bleeding of those additives or the production cost being up. On the other hand, when the relationship between the stretch ratio and the shrink ratio exceeds the upper limit of the formula (Z), the stretch ratio and the film after the shrinking process have wrinkles and cannot be used as an optical compensation film.

In addition, the stretch ratio as described for the present invention means a ratio of the film length stretched after the stretching for the film length before the film stretching, while the shrinking ratio of the film length shrunk to the length before shrinking in the shrinking direction.

For the range satisfying the formula (Z), the stretch ratio is preferably 20 to 50%, and particularly preferably 25 to 45%. The shrink ratio is preferably 15 to 45%, and particularly preferably 20 to 40%.

For achieving the desired optical properties, it is preferable to carry out the stretching and shrinking processes at a temperature of (glass transition temperature at the beginning of each process +(25 to 100))° C. during the processes.

The film to be produced according to the production method of the invention preferably satisfies formula (A):

10≧|Rth(550 10%RH−Rth(550)60%RH| (A)

wherein Rth(550) 10% RH and Rth(550) 60% RH are Rth(550) at 25° C. at 10% RH and 60% RH, respectively.

That is, the above formula (A) indicates that the absolute value of the difference between the value of the retardation in the thickness direction Rth(λ) measured at 25° C. and 60% RH, and the same value measured at 25° C. and 10% RH is preferably 10 nm or less.

The absolute value of the difference in the value of the retardation in the thickness direction Rth measured at 25° C. and 60% RH and the same value measured at 25° C. and 10% RH is more preferably 5 nm or less.

Furthermore, the stretching process and shrinking process are preferably carried out at a temperature of 30° C. to 90° C. of the glass transition temperature of the film at the beginning of the stretching and shrinking treatment, and more preferably at a temperature of 40° C. to 80° C.

Measurement, of the glass transition temperature according to the invention is carried out such that, a specimen of a cellulose acylate film (unstretched) having a size of 5 mm×30 mm was wetted at 25° C. and 60% RH for 2 hours or longer, and then using a dynamic viscoelasticity measuring device “Vibron: DVA-225” (IT KEISOKUSEIGYO Co., Ltd.), under the parameters such as a grip distance of 20 mm, a heating rate of 2° C./min, a measuring temperature range from 30° C. to 200° C., and a frequency of 1 Hz, and with the ordinate indicating a logarithmic axis of the storage modulus and the abscissa indicating a linear axis of temperature (° C.), the temperature indicating a rapid decrease in the storage modulus, which is characteristic to the transition of the storage modulus from a solid region to a glass transition region, was taken as the glass transition temperature Tg. Specifically, on the obtained chart, a straight line 1 was drawn in the solid region, and a straight line 2 was drawn in the glass transition temperature, and the cross point of the straight line 1 and the straight line 2 indicates the temperature at which the storage modulus rapidly decreases upon temperature rise, and the film starts to soften, and the temperature at which transition to the glass transition region begins. Thus, the cross point was taken as the glass transition'temperature Tg (dynamic viscoelasticity).

Further, the temperature on the abscissa is the temperature at the film surface measured with a non-contact infrared thermometer.

The present invention can be carried out by wet stretching, in which the film produced according to the solution flow casting method is stretched in the middle of drying process. Also, after drying the film, the stretching treatment can be performed continuously, or the stretching treatment can be performed separately after winding. It is also possible to apply a film produced according to a melting method, which substantially does not involve solvents, to stretching. Stretching or shrinking of the film may be carried out in a single stage or in multiple stages. When performed in multiple stages, it is favorably carried out such that the product of the respective stretch ratios in a plurality of stages falls within the above-described preferred range. The stretching speed is preferably 5%/min to 1000%/min, and more preferably 10%/min to 500%/min. Stretching is preferably carried out with a heat roller, or/and a radiation heat source (IR heater, etc.) or hot air.

It is preferable to provide a preheating process, in which preliminary heating of the film is carried out before the stretching process. The temperature used for this preheating process is preferably (glass transition temperature+(25 to 100))° C. The heat treatment time is preferably 1 second to 3 minutes.

The heat treatment temperature at which the heat treatment may be carried out after the stretching process is preferably carried out at a temperature of 20° C. lower than the glass transition temperature of the cellulose acylate film to a temperature of 10° C. higher than the glass transition temperature, while the heat treatment time, is preferably 1 second to 3 minutes. The heating method may be zone-heating or partial heating using and infrared heater. Both edges of the film may be slit during or at the end of the process. It is preferable to recover such slit wastes and recycle them as the raw material.

Furthermore, the tenter is disclosed in JP-A No. 11-077718, which describes a technology of securing the prevention of quality deterioration, such as in planarity and the like, for the occasion of increasing the speed in the solution flow casting method or extending the web width, when a web is to be dried while maintaining the width by the tenter, by appropriately controlling the drying gas blowing method, angle of the blowing air, air speed distribution, air speed, air amount, temperature difference, difference in air amount, ratio of air amounts of the upper blown air and the lower blown air, use of high specific heat drying gas, and the like.

JP-A No. 11-077822 describes an invention of heat treating a stretched thermoplastic resin film after a stretching process, by providing a temperature gradient in the film width direction in an annealing process, in order to prevent unevenness generation.

Moreover, in order to prevent unevenness generation, JP-A No. 4-204503 describes an invention of stretching a film, while having a solvent content in the film of 2 to 10% based on the solid contents.

Also, in order to suppress any curling provided by the clip gripping width, JP-A No. 2002-248680 describes an invention of facilitating film conveying after a stretching process, by stretching at a tenter clip gripping width D≦(33/{log(stretch ratio)×log(volatiles)} to suppress curling.

Moreover, in order to simultaneously perform the high speed continuous film conveyance and stretching, JP-A No. 2002-337224 describes an invention of switching the tenter conveyance using pins in the anterior and clips in the posterior.

JP-A No. 2002-187960 describes an invention which can conveniently improve the viewing angle characteristics, and in order to improve the viewing angle, a cellulose ester dope solution is flow cast on a support for flow casting, and the web (film) peeled off from the support for flow casting is stretched to 1.0- to 4.0-fold in at least one direction, while the amount of residual solvent in the web remains 100% by weight or less, particularly in the range of 10 to 100% by weight, to impart optical biaxiality. In a more preferred embodiment, the web is stretched to 1.0- to 4.0-fold in at least one direction, while the amount of residual solvent in the web is 100% by weight or less, particularly in the range of 10 to 100% by weight.

In addition, in order to produce a retardation film having good sliding property and excellent transparency with less additive bleed-out and no interlayer delamination, JP-A No. 2003-014933 describes an invention in which a dope A containing a resin, additives and an organic solvent, and a dope B containing a resin and an organic solvent, with no additives or the amount of additives being smaller than that of dope A, are produced the dope A and the dope B are flow cast on a support to form a core layer and a surface layer, respectively; the organic solvent is evaporated until peeling off is possible, then the formed web is peeled off from the support; and the web is stretched to 1.1- to 1.3-fold in at least one axial direction, with the amount of the residual solvent in the resin film during the stretching is in the range of 3 to 50% by weight. Furthermore, as preferred embodiments, it is also described that the web is peeled off from the support and stretched to 1.1- to 3.0-fold in at least one axial direction at a stretching temperature in the range of 140° C. to 200° C.; that a dope A containing a resin an organic solvent, and a dope B containing a resin, microparticles and an organic solvent are produced, the dope A and the dope B are co-flow cast on a support to form a core layer and a surface layer, respectively, the organic solvent is evaporated until peeling off is possible, then the web is peeled off from the support, and the web is stretched to 1.1- to 3.0-fold in at least one axial direction, with the amount of residual solvent in the resin film during stretching being in the range of 3% by weight to 50% by weight, and further stretched to 1.1- to 3.0-fold in at least one axial direction at a stretching temperature in the range of 140° C. to 200° C.; that a dope A containing a resin, an organic solvent and additives, a dope B containing a resin and an organic solvent, with no additives or the amount of additives being smaller than that of dope A, and a dope C containing a resin, microparticles and an organic solvent are produced, the dope A, the dope B and the dope G are co-flow cast on a support to form a core layer, a surface layer and a surface layer on the opposite side of the dope B, respectively, the organic solvent is evaporated until peeling off is possible, then the web is peeled off from the support, and the web is stretched to 1.1- to 3.0-fold in at least one axial direction, with the amount of residual solvent in the resin film during stretching being in the range of 3% by weight to 50% by weight; that the web is stretched to 1.1 to 3.0-fold in at least one axial direction, with the amount of residual solvent in the resin film during stretching being in the range of 3% by weight to 50% by weight; that the amount of additives in the dope A is 1 to 30% by weight based oh the resin, the amount of additives in the dope B is 0 to 5% by weight based on the resin, and the additive is a plasticizer, an ultraviolet absorbent, or a retardation controlling agent; and that the organic solvent in the dope A and the dope B is methylene chloride or methyl acetate, contained in an amount of 50% by weight or more.

Moreover, in order to prevent web foaming during tenter drying, and to prevent dusting by improving the releasing property, JP-A No. 2003-004374 describes an invention relating a drying apparatus, in which the width of the drying apparatus is formed to be shorter than, the width of the web so that the hot air from the drying apparatus does not reach the two edges of the web.

In order to prevent web foaming during tenter drying, and to prevent dusting by improving the releasing property, JP-A No. 2003-019757 describes an invention for providing an air blocking sheet inside the two edge portions of the web so that the drying air does not reach the gripping chucks of the tenter.

In addition, in order to carry out drying more stably, JP-A NO. 2003-053749 describes an invention in which, when the thickness of the two edge portions of the film after drying that are held by a pin tenter is X μm, and the average thickness of the film product after drying is T μm, the relationships between X and T satisfies the formula (1): 40≦X≦200 when T v 60; the formula (2): 40+(T−60)×0.2≦X≦300 when 60<T≦120; and the formula (3): 52+(T−120)×0.2≦X≦400 when 120<T.

In order to prevent generation of wrinkles in a multistage tenter, JP-A No. 2-182654 describes an invention for separately cooling the clip chains on the right side and the left side, providing a heating chamber and a cooling chamber in the dryer of the multistage tenter.

In order to prevent web breakage, wrinkles and poor conveyance, JP-A No. 9-077315 describes an invention for increasing the pin density in the inside of a pin tenter, and decreasing the pin density in the outside.

Furthermore, in order to prevent web foaming or web attaching to the gripping means within the tenter, JP-A No. 9-085846 describes an invention for cooling the gripping pins of a tenter drying apparatus for the edge portion on both sides of a web to a temperature below the web foaming temperature using a transpiration type cooler, and simultaneously cooling the pins immediately before feeding the web to a temperature of (gelling temperature of the dope in the duct type cooler+15)° C. or lower.

In addition, in order to prevent crisscrossing of the pin tenter and to improve foreign substances, JP-A NO. 2003-103542 describes an invention relating to a solution film producing method, in which the insertion structure of a pin tenter is cooled so that the surface temperature of the web being in contact with the insertion structure does not exceed the web gelling temperature.

Furthermore, in order to prevent quality deterioration, such as in planarity, in the case of increasing the speed of solution flow casting or extending the web width in a tenter, JP-A No. 11-077718 describes an invention, in which to dry a web in the tenter, the conditions are set to give an air speed of 0.5 to 20 (40) m/s, a temperature distribution in the sidearm direction of 10% or less, a ratio of the amounts of air in the upper and lower portions of the web of 0.2 to 1, and a drying gas rate of 30 to 250 J/Kmol. Further, by leaving the web in the tenter to be dry, preferable drying conditions in accordance with the amount of residual solvent are disclosed. Specifically, it is described that after peeling off the web from the support, dry gas is blown to the web until the amount of residual solvent in the web reaches 4% by weight, the angle of gas blowing from the vent is in the range of 30° to 150° relative to the film surface, and by taking the difference between the upper limit and the lower limit to be within 20% of the upper limit, when the air speed on the film surface arranged in the extended direction of air blowing is taken as the upper limit of the air speed, so as to dry the web; that when the amount of residual solvent in the web is from 70% by weight to 130% by weight, the air speed of the dry gas from, a blowing type dryer onto the web surface is set to from 0.5 m/sec to 20 m/sec; that when the amount of residual solvent is from 4% by weight to less than 70% by weight, the web is dried with dry gas blowing at a blowing rate of the dry gas of 0.5 m/sec to 40 m/sec, to render the difference between the upper limit and the lower limit within 10% of the upper limit, based on the upper limit of the gas temperature in the drying gas temperature distribution in the web width direction; and that when the amount of residual solvent in the web is 4% by weight to 200% by weight, the ratio of blowing amount q of the dry gas blown from the vent of the blow dryer disposed on the upper part and the lower part of the conveyed web is set to 0.2≦q≦1. Moreover, in preferred embodiments, at least one gas is used as the drying gas, and the average specific heat is 31.0 J/K·mol to 250 J/K·mol; and that drying is carried out with a dry gas, in which the concentration of a liquid organic compound contained in the drying gas at normal temperature during the drying is 50% or less of the saturated vapor pressure; and the like.

In order to prevent deterioration of the planarity or coating due to any contaminant, JP-A No. 11-077719 describes an invention relating to an apparatus for producing TAG (triacetylcellulose), in which a heating unit is installed on the clips of the tenter. As a more preferred embodiment, it is described that from the time of releasing the web by the tenter clips to the time of carrying the web again, an apparatus for removing foreign substances generated at the part where the clips and the web are brought to contact is provided; that foreign substances are removed using a spraying gas or liquid, or a brush; that the residual amount at the time of contact between the clips or pins with the web is from 12% by weight to 50% by weight; that the surface temperature at the part where the clips or pins and the web are brought to contact is from 60° C. to 200° C. (more preferably, 80° C. to 120° C.); and the like.

In order to increase the productivity by making the planarity good, and improving the quality deterioration due to breakage in the tenter, JP-A No. 11-090943 describes an invention in which, for the tenter clips, the ratio of an arbitrary conveying length of a tenter Lt(m), and the total sum of the lengths in the conveying direction of the part where the tenter clips having the same, length as Lt holding the web Ltt(m), Lr=Ltt/Lt, is such that 1.0≦Lt≦1.99. In a more preferred embodiment, it is disclosed that the part holding the web is arranged without any gaps when seen from the web width direction.

In order to improve planarity deterioration and stability upon, feeding due to web loosening when a web is fed to a tenter, JP-A No. 11-090944 describes an invention in which an apparatus for producing a plastic film has a device for suppressing loosening of the web in the web width direction, in front of the tenter inlet. Moreover, as a more preferred embodiment, it is described that the suppressing device is a rotating roller which rotates in a range of angle of spreading in the width direction from 2 to 60°; that an air suction device is installed in the upper part of the web; that, a blower is installed which can blow air from the lower part of the web; and the like.

In purpose of preventing occurrence of loosening, which deteriorates the quality and productivity, JP-A No. 11-090945 describes an invention relating to a method for producing TAC by feeding a web peeled off from a support from an angle relative to the horizontal.

In order to make a film having stable properties, JP-A No. 2000-289903 describes an invention relating to a conveying apparatus for conveying a web while exerting tension in the clothing direction at a time point when the web is peeled off and has a solvent content of 50 to 12% by weight, which apparatus has a means for detecting the web width, a means for holding the web, and two or more variable folding points, so that the web width is calculated from the signals from the detection of the web width to modify the positions of the folding points.

Moreover, in order to obtain a film having excellent quality by improving the clipping property and preventing web breakage for a long time, JP-A No. 2003-033933 describes that guide plates for preventing Curling of the web edge portion are disposed on both right, and left sides near the tenter inlet, specifically, at least on the lower part among the upper part and lower part of the edges of both the right and left sides of the web, such that the web facing surfaces of the guide plates are constituted of resin parts for web contacting and metal parts for web contacting that are disposed in the web conveying direction. As a more preferred embodiment, it is described that the resin parts for web contacting of the web facing surfaces of the guide plates are disposed on the upstream side of the web conveying direction, while the metal parts for web contacting are disposed on the downstream side thereof; that the level difference (including slopes) between the resin parts for web contacting and the metal parts for web contacting of the guide plates is 500 μm or less; that the distances from the resin parts for web contacting of the guide plates and the metal parts for web contacting to the web in the width direction are respectively 2 to 150 mm; that the distances from the resin parts for web contacting of the guide plates and the metal parts for web contacting to the web in the web conveying direction are respectively 2 to 150 mm; that the resin parts for web contacting of the guide plates are provided by surface resin processing or resin coating on guide substrates made of metal; the resin parts for web contacting of the guide plates comprises a single resin product; that the distance between the web facing surfaces of the guide plates disposed on the upper and lower parts of the edge portions on both the right and left sides of the web, is 3 to 30 mm; that the distance between the web facing surfaces, of the guide plates disposed on the upper and lower sides of the edges on both right and left sides of the web is extended toward the width direction or toward the inside the web at a ratio of 2 mm or greater per 100 mm of the width; that the guide plates on the upper and lower sides on the edge portions of both the right and left sides of the web are disposed to be alternating along the web conveying direction, so that the distance between the two guide plates on the upper and lower sides is −200 to +200 mm; that the web facing surfaces of the upper guide plates are constituted of resin or metal only; that the resin parts for web contacting of the guide plates comprise Teflon (registered trademark), and the metal parts for web contacting comprises stainless steel; that the surface roughness of the web facing surfaces of the guide plates or the resin parts for web contacting and/or metal parts for web contacting, is 3 μm or less; and the like. Further, it is described that the positions for installing the upper and lower guide plates for preventing curling on the edge portions of the web, are preferably in between the end part for peeling off from the support, and the tenter inlet part, particularly preferably closer to the tenter inlet.

Moreover, in order to prevent web breakage or staining that occurs during drying in the tenter, JP-A No. 11-048271 describes an invention for stretching and drying a web with a width stretching apparatus at a time point after peeling, when the solvent content in the web is 50 to 12% by weight, and applying a pressure of 0.2 to 10 kPa on both sides of the web with a pressurizing apparatus at a time point when the solvent convent in the web is 10% by weight or less. As a more preferred embodiment, a method is described for terminating application of tension or applying a pressure on both sides of the web (film) at a time point when the solvent content is 4% by weight or more, in which when the pressure is applied using nip rolls, it is preferable to use 1 to 8 pairs of nip rolls, and the temperature for pressurization is preferably 100 to 200° C.

JP-A No. 2002-036266, which relates to an invention to obtain high quality thin TAC having a thickness of 20 to 85 μm, describes that, as a preferred embodiment, the difference in tension applied on the web along the web conveying direction, before and after the tenter, is set to 8 N/mm²or less; that after the peeling process, the preheating process for preheating the web and after the preheating process, the stretching process for stretching the web using the tenter and after the stretching process, a relaxation process for relaxing the web for an amount that is smaller than the amount stretched during the stretching process; and the like.

It is also disclosed that the temperature T1 during the preheating process and the stretching process is set to (glass transition temperature of the film Tg−60)° C. or higher, while the temperature during the relaxation process T2 is set to (T1−10)° C. or lower; the stretch ratio of the web during the stretching process is set to 0 to 30% as a ratio to the web width immediately before entering the stretching process, and the stretch ratio of the web during the relaxation process is set to 10 to 10%; and the like.

Moreover, JP-A No. 202-225054, which is aimed at thickness reduction and weight reduction of a film having a dry film thickness of 10 to 60 μm, with small moisture permeability and excellent durability, describes that shrinkage by drying is suppressed by retaining the width while holding both edges of the web with clips, after peeling off, until the amount of residual solvent in the web reaches 10% by weight, and/or stretching is carried out in the width direction, so as to form a film having a degree of planar orientation (S) represented by the formulae={(Nx+Ny)/2}−Nz (wherein Nx is the refractive index in a direction with the maximum refractive index in the film plane; Ny is the refractive index in a direction perpendicular to Nx in the plane; and Nz is the refractive index in the film thickness direction of the film), of 0.0008 to 0.0020; that the time taken in the procedure from flow casting to peeling off is 30 to 90 seconds; that the web after peeling off is stretched in the width direction and/or the longitudinal direction; and the like.

JP-A No. 2002-341144 describes a method for solution film production comprising a stretching process, in which the optical distribution is such that the mass concentration of the retardation increasing agent becomes higher as approaching toward the center in the film width direction, in order to suppress optical unevenness.

JP-A No. 2003-071863, which relates to an invention for obtaining a film having no haze, describes that the stretch ratio in the clothing direction is preferably 0 to 100%, and in the case of using the film as a polarizing plate protecting film, the stretch ratio is more preferably 5 to 20%, and most preferably 8 to 15%. On the other hand, in the case of using the film as a retardation film, the stretch ratio is more preferably 10 to 40%, and most preferably 20 to 30%. It is also described that it is possible to control Ro by means of the stretch ratio, and it is preferable to have higher stretch ratios because the obtained film has excellent planarity. Furthermore, in the case of operating a tenter, the amount of residual solvent in the film is preferably 20 to 100% by weight upon initiation of the tenter operation, while it is preferable to perform drying through the tenter until the amount of residual solvent in the film reaches 10% by weight, more preferably 5% by weight. Also, in the case of operating the tenter, the drying temperature is preferably 30 to 150° C., more preferably 50 to 120° C., and most preferably 70 to 100° C. It is also described that a lower drying temperature may result in less evaporation of ultraviolet absorbents, plasticizers and the like and may reduce process contamination; however, a higher drying temperature results in excellent planarity of the film.

JP-A No. 2002-248639, which relates to an invention for reducing any dimensional fluctuation in the breadth and length during storage under high temperature and high humidity conditions, describes an invention for a method for producing film by flow casting a cellulose ester solution on a support, continuously peeling off and drying the film, in which drying is carried out such that the dry shrink ratio satisfies the formula: 0≦dry shrink ratio (%)≦0.1×amount of residual solvent upon peeling off (%). Moreover, as a preferred embodiment, it is described that when the amount of residual solvent in the cellulose ester film after peeling off is in the range of 40 to 100% by weight, the amount of residual solvent is reduced by at least 30% by weight or more by means of tenter conveyor, while holding both edges of the cellulose ester film; that the amount of residual solvent at the inlet for tenter conveyor of the cellulose ester film after peeling off is 40 to 100% by weight, while the amount of residual solvent at the outlet is 4 to 20% by weight; that the tension for conveying the cellulose ester film by the tenter conveyor increases in the direction from the inlet to the outlet of the tenter conveyor; that the tension for conveying the cellulose ester film by the tentor conveyor, and the tension on the cellulose ester film in the width direction are approximately equal; and the like.

In addition, in order to obtain a film having a thin film thickness, optical isotropy and excellent planarity, JP-A No. 2000-239403 describes that film production is carried out, with the relationship between the proportion of residual solvent X upon peeling off, and the proportion of residual solvent Y upon feeding to the tenter, is in the range of 0.3X≦Y≦0.9X.

JP-A No. 2002-286933 describes, as the method for stretching a film produced by flow casting, a method of stretching under heating conditions and a method of stretching under solvent-containing conditions. In the case of stretching under heating conditions, it is preferable to stretch the resin at a temperature near or below the glass transition temperature of the resin; and on the other hand, in the case of stretching a film produced by flow casting, under solvent impregnating conditions, it is possible to stretch the film that is dried once, after being repeatedly contacted with a solvent and impregnated with the solvent.

(Cellulose Acylate)

For the raw material cotton of cellulose acylate, known raw materials can be used (see, for example, Journal of Technical Disclosure of Japan Institute of Invention and Innovation, No. 2001-1745). Synthesis of cellulose acylate can be also performed by a known method (see, for example, Migita et al., Wood Chemistry, Kyoritsu Shuppan, pp. 180-190 (1968)). The viscosity average degree of polymerization of the cellulose acylate is preferably 200 to 700, more preferably 250 to 500, and most preferably 250 to 350. The number, average molecular weight (Mn) of the cellulose ester used for the invention is preferably 10,000 to 150,000, the weight average molecular weight (Mw) is preferably 20,000 to 500,000, and the z-average molecular weight (Mz) is preferably 5,000 to 550,000. It is also preferable to have a narrow molecular weight distribution, Mw/Mn (wherein Mw is the mass average molecular weight, and Mn is the number average molecular weight), as measured by gel permeation chromatography. The specific value for Mw/Mn is preferably 1.5 to 5.0, more preferably 2.0 to 4.5, and most preferably 3.0 to 4.0.

The acyl group of the cellulose acylate is not particularly limited, but it is preferable to use an acetyl group, a propionyl group or a butyryl group, or a benzoyl group. The degree of substitution for the acyl group is preferably 2.0 to 3.0, and more preferably 2.2 to 2.95. According to the present specification, the degree of substitution of an acyl group is a value calculated according to ASTM D817. The acyl group is most preferably n acetyl group, and when cellulose acetate, in which the acyl group is an acetyl group, is to be used, the degree of acetalization is preferably 57.0 to 62.5%, and more preferably 58.0 to 62.0%. When the degree of acetalization is within the range, there is no change for Re to become greater than a desired value due to the conveying tension at the time of flow casting, the irregularity in the plane is small, and the change in the retardation value due to temperature and humidity is also small.

In particular, it is possible to obtain by substituting the hydroxyl group in the glucose unit which constitutes cellulose of the cellulose acylate film, with an acyl group having 2 or more carbon atoms. When the degree of substitution of the hydroxyl group at the 2-position of the glucose unit by an acyl group is called DS2, the degree of substitution of the hydroxyl group at the 3-position by an acyl group is called DS3, and the degree of substitution of the hydroxyl group at the 6-position by an acyl group is called DS6, if the formulae (IV) and (V) are satisfied, it becomes feasible to obtain desired Re and Rth. It is also preferable to have smaller fluctuation for the Re value due to temperature and humidity.

2.0≦(DS2+DS3+DS6)≦3.0 (IV)

DS6/(DS2+DS3+DS6)≧0.315 (V)

More preferably,

2.2≦(DS2+DS3+DS6)≦2.9 (IV)

DS6/(DS2+DS3+DS6)≧0.322 (V)

Alternatively, in particular, when the degree of substitution of the hydroxyl group of the glucose unit of cellulose acylate by an acetyl group is taken as A, and the degree of substitution of they hydroxyl group by a propionyl group or a butyryl group, or a benzoyl group is taken as B, if A and B satisfy the formulae (VI) and (VII), it becomes feasible to obtain desired Re and Rth. It is also preferable to realize high stretch ratios without breakage.

2.0≦A+B≦3.0 (VI)

0<B (VII)

More preferably,

2.6≦A+B≦3.0 (VI)

0.5≦B≦1.5. (VII)

(Polymers Other than Cellulose Acylate)

The method for obtaining a film having preferred optical properties by the method for production according to the invention, which comprises a stretching process for stretching the film and a shrinking process for shrinking the film, is not limited to cellulose acylate, but can be applied to general polymers that can be used in optical films, thus it being anticipated to have the same effect as cellulose acylate.

The polymer that can be used in optical films may be exemplified by polycarbonate copolymers, or polymer resins having cyclic olefin structure.

Examples of the polycarbonate copolymer include polycarbonate copolymers which comprise the repeating unit represented by the formula (A) and the repeating unit represented by the formula (B), wherein the repeating unit represented by the formula (A) above occupies 80 to 30 mol % of the total:

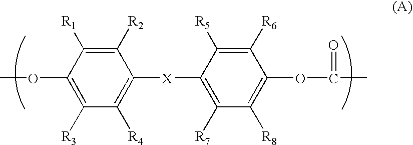

In the formula (A), R₁ to R₈ are each independently selected from a hydrogen atom, a halogen atom and a hydrocarbon group having 1 to 6 carbon atoms. Such hydrocarbon group having 1 to 6 carbon atoms may be exemplified by an alkyl group such as a methyl group, an ethyl group, an isopropyl group, a cyclohexyl group, or an aryl group such as a phenyl group. Among these, a hydrogen atom and a methyl group are preferred.

X is the following (X), and R₉ and R₁₀ are each independently a hydrogen, atom, a halogen atom, or an alkyl group having 1 to 3 carbon atoms. The halogen atom and the alkyl group having 1 to 3 carbon atoms may be exemplified by the same ones as described above.

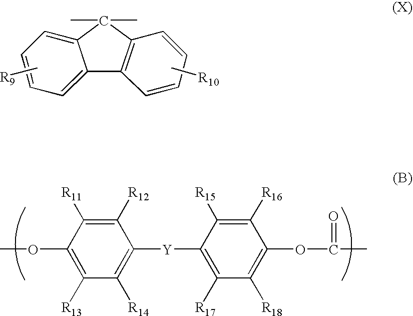

In the formula (B), R₁₁ to R₁₈ are each independently selected from a hydrogen atom, a halogen atom, and a hydrocarbon group having 1 to 22 carbon atoms. Such hydrocarbon group having 1 to 22 carbon atoms may be exemplified by an alkyl group such as a methyl group, an ethyl group, an isopropyl group, a cyclohexyl group or the like, or an aryl group such as a phenyl group, a biphenyl group, a terphenyl group or the like. Among these, a hydrogen atom and a methyl group are preferred.

Y is selected from the Y's group of me formulae below, and R₁₉ to R₂₁, R₂₃ and R₂₄ are each independently at least one group selected from a hydrogen atom, a halogen atom, and a hydrocarbon group having 1 to 22 carbon atoms. Such hydrocarbon group may be exemplified by the same ones as described above. R₂₂ and R₂₅ are each independently selected from a hydrocarbon group having 1 to 20 carbon atoms, and such hydrocarbon group may be exemplified by a methylene group, an ethylene group, a propylene group, a butylene group, a cyclohexylene group, a phenylene group, a naphthalene group, or a terphehylene group. For Ar₁ to Ar₃, an aryl group having 6 to 10 carbon atoms such as a phenyl group, a naphthyl group or the like may be mentioned.

(Y's group)

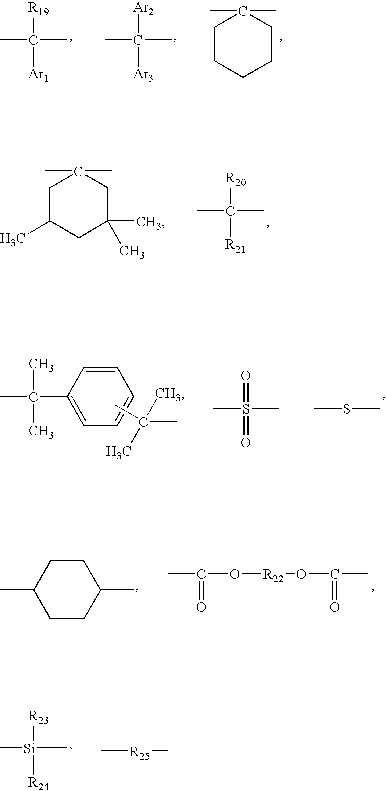

For the polycarbonate copolymer, a polycarbonate copolymer comprising 30 to 60 mol % of a repeating unit represented by the formula (C), and 70 to 40 mol % of a repeating unit represented by the formula (D).

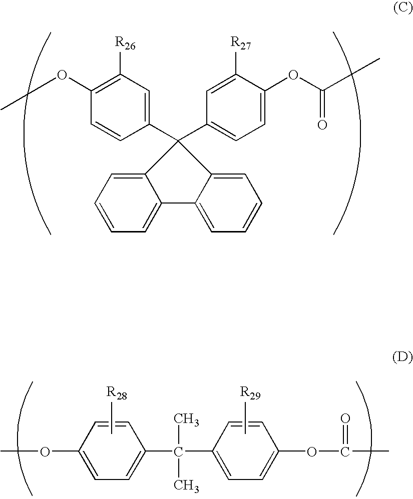

Even more preferably, it is a polycarbonate copolymer comprising 45 to 55 mol % of a repeating unit represented by the above formula (C), and 55 to 0.45 mol % of a repeating unit represented by the formula (D).

For the above formula (C), R₂₆ to R₂₇ are each independently a hydrogen atom or a methyl group, and preferably a methyl group from the viewpoint of handlability.

For the above formula (D), R₂₈ to R₂₉ are each independently a hydrogen atom or a methyl group, and preferably a hydrogen atom from the viewpoint of economical aspect and film characteristics.

The optical film according to the invention preferably uses a polycarbonate copolymer having the above-mentioned fluorene skeleton. For the polycarbonate copolymer having a fluorene skeleton, for example, a blend of polycarbonate copolymers comprising a repeating unit represented by the formula (A) and a repeating unit represented by the formula (B) at different compositional ratios is good, and the content of the formula (A) is preferably 80 to 30 mol %, more preferably 75 to 35 mol %, and even more preferably 70 to 40 mol %, of the entire polycarbonate copolymer.

The copolymer may be a combination of two or more species each of the repeating units represented by the formulae (A) and (B).

Here, the molar ratio can be determined with, for example, a nuclear magnetic resonance apparatus using the entire bulk of the polycarbonate constituting the optical film.

The polycarbonate copolymer can be produced according to a known method. Polycarbonate can be produced by suitably using polycondensation of a dihydroxy compound and phosgene, solution polycondensation method, or the like.

The intrinsic viscosity of the polycarbonate copolymer is preferably 0.3 to 2.0 dl/g. When the intrinsic viscosity is less than 0.3, the polycarbonate copolymer becomes brittle and cannot maintain mechanical strength. When the intrinsic viscosity is greater than 2.0, the solution viscosity increases too much, and there occurs a problem such as generation of dieline during the solution film production, or the purification after completion of the polymerization becomes difficult.

The optical film of the invention may be a composition (blend) of the polycarbonate copolymer and other polymeric compounds. In this case, the polymeric compound needs to be optically transparent, and thus is preferably ones that are compatible with the polycarbonate copolymer, or ones respectively having approximately the same refractive indices. Examples of the other polymer include poly(styrene-co-maleic anhydride) and the like, and the compositional ratio of the polycarbonate copolymer and the polymeric compound is 80 to 30% by weight of the polycarbonate copolymer and 20 to 70% by % eight of the polymeric compound, preferably 80 to 40% by weight of the polycarbonate copolymer and 20 to 60% by weight of the polymeric compound. Also in the case of a blend, two or more of the repeating units of the polycarbonate copolymer may be combined. In the case of a blend, the blend is preferably a compatible blend, but even though the blend is completely compatible, when the refractive indices of the components are adjusted, it is possible to suppress light diffraction among the components and to enhance transparency. In addition, the blend may be a combination of three or more materials, and may be a combination of a plurality of polycarbonate copolymers and other polymeric; compounds.

The weight average molecular weight of the polycarbonate copolymer is 1,000 to 1,000,000, and preferably 5,000 to 500,000. The weight average molecular weight of the other polymeric compound is 500 to 100,000, and preferably 1,000 to 50,000.

Examples of the polymer resin having a cyclic olefin structure (hereinafter, may be referred to as “cyclic polyolefinic resin” or “cyclic polyolefin”) include (1) norbornene-based polymers, (2) polymers of monocyclic cycloolefins, (3) polymers of cyclic conjugated diene, (4) vinyl aliphatic hydrocarbon polymers, and hydrides of (1) to (4). A preferred polymer for the invention is an addition (co)polymer cyclic polyolefin containing at least one repeating unit represented by the formula (1), and an addition (co)polymer cyclic polyolefin further containing at least one repeating unit represented by the formula (1), if necessary. An addition (co)polymer (including a ring-opened (co)polymer) containing at least one cyclic repeating unit represented by formula (III) can be also suitably used. An addition (co)polymer cyclic polyolefin containing at least one repeating unit represented by formula (III), and if necessary, further containing at least one repeating unit represented by formula (1), can be also favorably used.

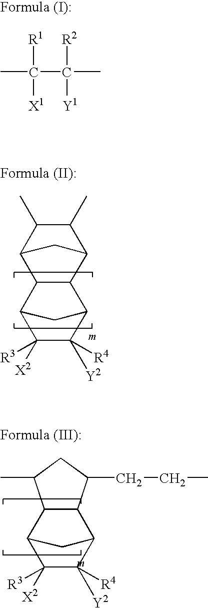

In the formula, m is an integer from 0 to 4. R¹ to R⁶ is each a hydrogen atom or a hydrocarbon group having 1 to 10 carbon atoms; X¹ to X³ and Y¹ to Y³ are each a hydrogen atom, a hydrocarbon group having 1 to 10 carbon atoms, a halogen atom, a halogen atom-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW, or (—CO)₂O, (—CO)₂NR¹⁵ consisting of X¹ and Y¹, X² and Y², or X³ and Y³. In addition, R¹¹, R¹², R¹³, R¹⁴, and R¹⁵ are each a hydrogen atom, or a hydrocarbon group having 1 to 20 carbon atoms; Z is a hydrocarbon group or a halogen-substituted hydrocarbon group; W is SiR¹⁶ₚD₃₋ₚ (R¹⁶ is a hydrocarbon group having 1 to 10 carbon atoms, D is a halogen atom, —OCOR¹⁶ or —OR¹⁶, and p is an integer from 0 to 3); and n is an integer from 0 to 10.

When a functional group having high polarity is introduced as the substituent for X¹ to X³ and Y¹ to Y³, the retardation in the thickness direction of the optical film (Rth) can be increased; thus enhancing the manifestation of the in-plane retardation (Re). When a film having high Re manifestation is stretched during the film formation process, the Re value can be increased. The norbornene-based addition (co)polymer is disclosed in JP-A No. 10-7732, WO 2002/504184, US 2004-229157 A1, WO 2004/070463 A1 or the like. The norbornene-based addition (co)polymer is obtained by addition polymerizing norbornene-based polycyclic unsaturated compounds. Also, if necessary, a norbornene-based polycyclic unsaturated compound can be addition polymerized with a conjugated diene such as ethylene, propylene, butene, butadiene, or isoprene; a non-conjugated diene such as ethylidenenorbornene; or a linear diene compound such as acrylonitrile, acrylic acid, methacrylic acid, maleic anhydride, an acrylic acid ester, a methacrylic acid ester, maleimide, vinyl acetate, vinyl chloride or the like. This norbornene-based addition (co)polymer is commercially available from Mitsui Chemicals, Inc. under the trade name of Apel, and there are available grades with different glass transition temperature (Tg), for example, APL8008T (Tg 70° C.), APL6013T (Tg 125° C.), APL6015T (Tg 145° C.) or the like. There are commercially available pellets from Polyplastics Co., Ltd., such as TOPAS8007, TOPAS6013, TOPAS6015 and the like. Also, Appear 3000 is commercially available from Ferrania SpA.

Norbornene-based polymer hydrides are disclosed in JP-A No. 1-240517, JP-A No. 7-196736, JP-A No. 60-26024, JP-A No. 62-19801, JP-A No. 2003-159767, JP-A No. 2004-309979 or the like, and such a polymer is produced by subjecting a polycyclic unsaturated compound to addition polymerization or ring-opening metathesis polymerization, and then hydrogenating the resulting product. For the norbornene-based polymer used for the invention, R⁵ to R⁶ are each preferably a hydrogen atom or —CH₃; X³ and Y³ are each prefefably a hydrogen atom, Cl, or —COOCH₃; and groups other than them are appropriately selected. These norbornene-based resins are commercially available from JSR Corp. under the trade name of Arton G or Arton F, and from Nippon Zeon Co., Ltd. under the trade name of Zeonor ZF14, Zeonor ZF16, Zeonex 250 or Zeonex 280, which are available for use.

(Method for controlling Re: retardation increasing agent having a maximum absorption wavelength (λmax) shorter than 250 nm)

In order to control the absolute value of Re of the cellulose acylate film of the invention, it is preferable to use a compound having a maximum absorption wavelength (λmax) shorter than 250 nm with respect to the ultraviolet absorption spectrum of the solution, as a retardation increasing agent. When such a compound is used, the absolute value, can be controlled without substantially changing the wavelength dependency of Re in the visible region.

The term “retardation increasing agent” means an “additive” which causes that a cellulose acylate film containing the additive has an Re value higher by 20 nm or greater (when, calculated in terms of a film thickness of 80 μm), as measured at a wavelength of 550 nm, compared with the Re value of a cellulose acylate film produced in the same manner except the addition of the additive, as measured at a wavelength of 550 nm. An increase in the Re is preferably 30 nm or greater, more preferably 40 nm or greater, and most preferably 60 nm or greater.

From the viewpoint of the function of the retardation increasing agent, rod-shaped compounds are preferred, and compounds having at least one aromatic ring are preferred, with those having at least two aromatic rings being more preferred.

The rod-shaped compound preferably has a linear molecular structure. A linear molecular structure means that the molecular structure of a rod-shaped compound when being thermodynamically the most stable structure, is linear. The thermodynamically most stable structure can be determined by a crystal structure analysis, or molecular orbital calculation, and for example, molecular orbital calculation can be performed using a molecular orbital calculating software (e.g., WinMOPAC 2000 available from Fujitsu, Ltd.), to determine a molecular structure having the smallest heat of formation for the compound. The phrase “a molecular structure is linear” implies that for the thermodynamically most stable structure that can be determined by calculation as described above, the angle of the molecular structure is 140° or greater.

The rod-shaped compound preferably exhibits liquid crystallinity. It is more preferable that the rod-shaped compound exhibits liquid crystallinity (having thermotropic liquid crystallinity) upon heating. The liquid crystal phase is preferably nematic phase or smectic phase.

Preferred compounds are described in JP-A No. 2004-4550, but are not limited to those. Two or more of such rod-shaped compound having a maximum absorption wavelength (λmax) shorter than 250 nm in the ultraviolet absorption spectrum of the solution, may be used in combination.

The rod-shaped compound can be synthesized according to the methods described in the literature. Exemplary literatures include Mol. Cryst. Liq. Cryst., Vol. 53, p. 229 (1979); Mol. Cryst. Liq. Cryst., Vol. 89, p. 93 (1982); Mol. Cryst. Liq. Cryst., Vol. 145, p. 111 (1987); Mol. Cryst. Liq. Cryst., Vol. 170, p. 43 (1989); J. Am. Chem. Soc, Vol. 113, p. 1349 (1991); J. Am. Chem. Soc, Vol. 118, p. 5346 (1996); J. Am. Chem. Soc, Vol. 92, p. 1582 (1970); J. Org. Chem., Vol. 40, p. 420 (1975); and Tetrahedron, vol. 48, No. 16, p. 3437 (1992).

The amount of the retardation increasing agent to be added is preferably 0.1 to 30% by weight, more preferably 0.5 to 20% by weight, of the amount of cellulose acylate.

(Method for Controlling Rth: Retardation Increasing Agent having a Maximum Absorption Wavelength (λmax) Longer than 250 nm)

In order to manifest a desired Rth, it is preferable to use a retardation increasing agent.

Here, the “retardation increasing agent” means an “additive” means an “additive” which causes that a cellulose acylate film containing the additive has an Rth value higher by 20 nm or greater (when calculated in terms of a film thickness of 80 μm), as measured at a wavelength of 550 nm, compared with the Rth value of a cellulose acylate film produced in the same manner except the addition of the additive, as measured at a wavelength of 550 nm. An increase in the Rth is preferably. 30 nm or greater, more preferably 40 nm or greater, and most preferably 60 nm or greater.

The retardation increasing agent is preferably a compound having at least two aromatic rings.

The retardation increasing agent is used in an amount ranging from preferably 0.01 to 20 parts by weight, more preferably from 0.1 to 10 parts by weight, even more preferably from 0.2 to 5 parts by weight, and most preferably from 0.5 to 2 parts by weight, relative to 100 parts by weight of cellulose acylate. Two or more retardation increasing agents may be used in combination.

The retardation increasing agent preferably has the maximum absorption in a wavelength region of 250 to 400 nm, and preferably does not substantially absorb in the visible region.

The retardation increasing agent for controlling Rth preferably does not affect Re, which is manifested by stretching, and preferably, a disc-shaped compound is used therefor.

The disc-shaped compound contains an aromatic heterocyclic ring, in addition to the aromatic hydrocarbon ring, and in particular, the aromatic hydrocarbon ring is particularly preferably a 6-membered ring (i.e., a benzene ring).

The aromatic heterocyclic ring is generally an unsaturated heterocyclic ring. The aromatic heterocyclic ring is preferably a 5-membered, 6-membered or 7-membered ring, and more preferably a 5-membered or 6-membered ring. The aromatic heterocyclic ring has in general the maximum number of double bonds. The heteroatom is preferably a nitrogen atom, ah oxygen atom or a sulfur atom, and particularly preferably a nitrogen atom. Examples of the aromatic heterocyclic ring include a furan ring, a thiophene ring, a pyrrole ring, an oxazole ring, an isoxazole ring, a thiazole ring, an isothiazole ring, an imidazole ring, a pyrazole ring, a furazane ring, a triazole ring, a pyrane ring, a pyridine ring, a pyridazine ring, a pyrimidine ring, a pyrazine ring, and a 1,3,5-triazine ring. Specifically, for example, the compounds specified in JP-A No. 2001-166144 are favorably used.

The aromatic compounds are used in an amount of 0.01 to 20 parts by weight relative to 100 parts by weight of cellulose acylate. The aromatic compounds are preferably used in an amount of 0.05 to 15 parts by weight, more preferably 0.1 to 10 parts by weight, relative to 100 parts by weight of cellulose acylate. Two or more compounds may be used in combination.

(Method for Controlling Rth: Method Involving Optically Anisotropic Layer)

As a method for controlling Rth without affecting Re that is manifested by stretching, a method of coating and installing an optically anisotropic layer, by means of a liquid crystal layer or the like is favorably used.

As a specific example of the liquid crystal layer, a method of aligning discotic liquid crystals such that the angle between the disci-shaped plane and the above-mentioned optical film plane is within 5° (JP-A No. 10-312166), and a method of aligning rod-shaped liquid crystals such that the angle between the longest diameter of the ellipse and the above-mentioned optical film plane is within 5° (JP-A No. 2000-304932) may be mentioned.

The cellulose acylate film having an optically anisotropic layer (also referred to as optical compensation film) contributes to extension of the viewing angle contrast, and reduction in color difference depending on the viewing angle in liquid crystal displays, in particular, those OCB mode and VA mode liquid crystal displays. The optical compensation film may be disposed between the polarizing plate on the viewer's side and the liquid crystal cell, or may be disposed between the polarizing plate on the backside and the liquid crystal cell, or may be disposed on both sides. For example, the optical compensation film can be introduced into the inside of a liquid crystal display as an independent member, or may be introduced into, the inside of a liquid crystal display as an element of the polarizing plate, to the protecting film for protecting the polarizer, by imparting optical characteristics to the optical compensation film to function as a transparent film. An alignment film for controlling the alignment of the liquid crystalline compound in the optically anisotropic layer may be disposed between the cellulose acylate film and the optically anisotropic layer. Furthermore, as long as the optical characteristics to be described later are satisfied, the cellulose acylate and optically anisotropic layer may respectively consist of two or more layers.

The optically anisotropic layer will be explained in more detail.

(Optically Anisotropic Layer)

The optically anisotropic layer may be directly formed on the surface of a cellulose acylate film, or may be formed on an alignment film, which is first formed on the cellulose acylate film. Alternatively, it is also possible to transfer a liquid crystalline compound layer formed on some other substrate onto the cellulose acylate film, using an adhesive, bonding agent or the like.

For the liquid crystalline compound used for the formation of an optically anisotropic layer, rod-shaped liquid crystalline compounds, and disc-shaped liquid crystalline compounds (hereinafter, disc-shaped liquid crystalline compounds may be sometimes referred to as “discotic liquid crystalline compounds”) may be mentioned. The rod-shaped liquid crystalline compounds and discotic liquid crystalline compounds may be polymeric liquid crystals or oligomeric liquid crystals. Furthermore, the compound finally contained in the optically anisotropic layer does not necessarily need to exhibit liquid crystallinity, and for example, in the case of using an oligomeric liquid crystalline compound for the production of an optically anisotropic; layer, the compound may be crosslinked and does not show liquid crystals during the process for forming the optically anisotropic layer.

(Rod-Shaped Liquid Crystalline Compound)

As the rod-shaped liquid crystalline compound that can be used for the invention, azomethines, azoxys, cyanobiphenyls, cyanophenyl esters, benzoic acid esters, cyclohexariecarboxylic acid phenyl esters, cyariophenylcyclohexanes, cyano-substituted phenylpyrimidines, alkoxy-substituted phenylpyrimidines, phenyldioxanes, tolanes, and alkenylcyclohexylbenzonitriles are favorably used. In addition, the rod-shaped liquid crystalline compounds also include metal complexes. Further, liquid crystal polymers containing a rod-shaped liquid crystalline compound among the repeating units can be also used, that is, the rod-shaped liquid crystalline compound may be bound to (liquid crystal) polymers.

For the rod-shaped, liquid crystalline compounds, descriptions are found in Kikan Kagaku Sosetsu, vol. 22, Chemistry of Liquid Crystals (1994), The Chemical Society of Japan, Chapters 4, 7 and 11; and Liquid Crystal Device Handbook, Japan Society for the Promotion of Science, Committee No. 142, Chapter 3.

The birefringence of the rod-shaped liquid crystalline compound used for the invention is preferably in the range of 0.001 to 0.7.

The rod-shaped liquid crystalline compound preferably has a polymerizable group for the purpose of fixing the alignment state. The polymerizable group is preferably an unsaturated polymerizable group or an epoxy group, more preferably an unsaturated polymerizable group, and most preferably an ethylenic unsaturated polymerizable group.

(Discotic Liquid Crystalline Compound)

The discotic liquid crystalline compound includes the benzene derivatives described in C. Destrade, et al., Mol. Cryst, Vol. 71, p. 111 (1981); the truxene derivatives described in C. Destrade, et al., Mol. Cryst., Vol. 122, p. 141 (1985) and Physics Lett. A, Vol. 78, p. 82 (1990); cyclohexane derivatives described in B. Kohne, et al., Angew. Chem., Vol. 96, p. 70 (1984); and aza-crown-based or phenylacetylene-based macrocycles described in J. M. Lehn, et al., J. Chem. Commun., p. 1794 (1985), and Zhang, et al., J. Am. Chem. Soc, Vol. 116, p. 2655 (1994).

The discotic liquid crystalline compound also includes those compounds exhibiting liquid crystallinity, having a structure in which straight-chained alkyl groups, alkoxy groups or substituted benzoyloxy groups are radially substituting the parent nucleus at the molecular core, as side chains to the parent nucleus. The discotic liquid crystalline compound is preferably a compound which has rotating symmetry in the molecule or an aggregate of molecules, thereby being able to induce uniform alignment.

As described above, when an optically anisotropic layer is formed from a liquid crystalline compound, the compound that is finally contained in the optically anisotropic layer is not necessarily required to exhibit liquid crystallinity. For example, when a low molecular weight, discotic liquid crystalline compound has a thermoreactive or photoreactive group, which undergoes a reaction induced by heat or light, and the discotic liquid crystalline compound undergoes polymerization or crosslinking to attain high molecular weight and to form an optically anisotropic layer, the compound contained in the optically anisotropic layer may have already lost liquid crystallinity. Preferred examples of the discotic liquid crystalline compound are described in JP-A No. 8-50206. Polymerization of the discotic liquid crystalline compounds is described in JP-A No. 8-27284.

In order to immobilize the discotic liquid crystalline compound by polymerization, it is necessary to bind a polymerizable group to the disc-shaped core of the discotic liquid crystalline compound as a substituent. However, if the polymerizable group is directly attached to the disc-shaped core, it becomes difficult to maintain the alignment state for the polymerization reaction. Thus, it is preferable to introduce a linking group between the disc-shaped core and the polymerizable group.

According to the invention, the molecules of the rod-shaped compound or the disc-shaped compound in the optically anisotropic layer are immobilized in the aligned state. The average alignment direction of the molecular symmetric axis of the liquid crystalline compound at the interface on the optical film side, intersects with the slow axis in the plane of the optical film at an angle of approximately 45°.

In addition, according to the invention, the term “approximately 45°” refers to an angle in the range of 45°±5°, preferably 42 to 48°, and more preferably 43 to 47°.

The average alignment direction of the molecular symmetric axis of the liquid crystalline compound can be adjusted generally by selecting the material for the liquid crystalline compound or the alignment film, or by selecting the rubber treatment method.

According to the invention, for example, in the case of producing an optical compensation film of the OCB mode, the alignment film for the formation of optically anisotropic layer is produced by a rubbing treatment, and a rubbing treatment is performed in a direction of 45° relative to the slow axis of the cellulose acylate film. Then, an optically anisotropic layer in which the average alignment direction of the molecular symmetric axis of the liquid crystalline compound, at least at the cellulose acylate film interface, is at 45° relative to the slow axis of the cellulose acylate film, can be formed.

For example, the optical compensation film can be continuously produced using a long-shaped cellulose acylate film of the invention, in which the slow axis is perpendicular to the long direction. Specifically, a coating solution for alignment-film formation is continuously coated on the surface of a long-shaped cellulose acylate film to produce a film, then the surface of the film is continuously subjected to a rubbing treatment in a direction at 45° to the long direction to produce an alignment film. Next, on the produced alignment film, a coating solution for optically anisotropic layer formation containing a liquid crystalline compound is continuously coated, and the molecules of the liquid crystalline compound are aligned and immobilized as such to produce an optically anisotropic layer. Thus, a long-shaped optical compensation film can be continuously produced. The optical compensation film produced to be long-shaped is cut into desired shapes before being mounted in the liquid crystal display.

Furthermore, relative to the average-alignment direction of the molecular symmetric axis on the surface side (air side) of the liquid crystalline compound, the average alignment direction of the molecular symmetric axis of the liquid crystalline compound on the air interface side is preferably approximately 45°, more preferably 42 to 48°, and even more preferably 43 to 47°, relative to the slow axis of the film. The average alignment direction of the molecular symmetric axis of the liquid crystalline compound on the air interface side can be in general adjusted by selecting the type of the liquid crystalline compound, or the type of additives that are to be used together with the liquid crystalline compound. Examples of the additives used with the liquid crystalline compound include plasticizers, surfactants, polymerizable monomers, polymers and the like. The degree of change in the alignment direction of the molecular symmetric axis can be also adjusted, in the same manner as described above, by selecting the liquid crystalline compound and the additives. In particular, for the surfactant, it is preferable to use one which is compatible with the control of surface tension of the above-mentioned coating solution.

The plasticizer, surfactant and polymerizable monomer to be used together with the liquid crystalline compound preferably have compatibility with the discotic liquid crystalline compound, thus not causing any change in the tilt angle of the liquid crystalline compound or impairing the alignment Polymerizable monomers (e.g., compounds having a vinyl group, a vinyloxy group, an acryloyl group and a methacryloyl group) are preferred. The amount of the compound to be added is generally in the range of 1 to 50% by weight, and preferably in the range of 5 to 30% by weight, based on the liquid crystalline compound. In addition, when monomers having four or more polymerizable, reactive functional groups are used in mixture, the adhesion between the alignment film and the optically anisotropic layer can be enhanced.

In the case of using a discotic liquid crystalline compound as the liquid crystalline compound, it is preferable to use a polymer which has compatibility with the discotic liquid crystalline compound to a certain extent, and causes a change in the tilt angle in the discotic liquid crystalline compound.

Examples of such polymer include cellulose esters. Preferred examples of the cellulose ester include cellulose acetate, cellulose acetate propionate, hydroxypropylcellulose and cellulose acetate butyrate. In order not to impair the alignment of the discotic liquid crystalline compound, the amount of the polymer to be added is preferably in the range of 0.1 to 10% by weight, more preferably in the range of 0.1 to 8% by weight, and even more preferably in the range of 0.1 to 5% by weight, based on the discotic liquid crystalline compound.

The discotic/nematic phase to solid phase transition temperature of the discotic liquid crystalline compound is preferably 70 to 300° C., and more preferably 70 to 170° C.

According to the invention, Re(550) of the optically anisotropic layer is preferably 0 to 300 nm, more preferably 0 to 200 nm, and even more preferably 0 to 100 nm. Rth(550) in the thickness direction of the optically anisotropic layer is preferably 20 to 400 nm, and more preferably 50 to 200 nm. The thickness of the optically anisotropic layer is preferably 0.1 to 20 μm, more preferably 0.5 to 15 μm, and most preferably 1 to 10 μm.

The cellulose acylate film that is favorably used for the invention can be obtained by forming a film using a solution in which the above-mentioned specific cellulose acylate and, if necessary, additives in an organic solvent.

(Additives)

For the additives that can be used in the cellulose acylate solution according to the invention, for example, plasticizer, ultraviolet absorbent, anti-degradant, retardation (optical anisotropy) manifesting agent, retardation (optical anisotropy) decreasing agent, wavelength dispersion adjusting agent, dyes, microparticles, delamination accelerating agent, infrared absorbent and the like may be mentioned. According to the invention, it is preferable to use a retardation increasing agent. Further, it is preferable to use at least one of the plasticizer, ultraviolet absorbent and delamination accelerating agent.

These may be solid or liquid. That is, the additives are particularly limited regarding the melting point or boiling point. For example, an ultraviolet absorbent at 20° C. or lower and an ultraviolet absorbent at 20° C. or higher can be mixed and used, or plasticizers can be similarly mixed and used, whose examples are described in JP-A No. 2001-151901 and the like.

(Ultraviolet Absorbent)

For the ultraviolet absorbent, any kind of compound can be selected in accordance with the purpose of the invention, and absorbents such as salicylic acid esters, benzophenones, benzotriazoles, benzoates, cyanoacrylates, nickel complex salts and the like can be used, with benzophenones, benzotriazoles and salicylic acid esters being preferred.

Examples of the benzophenone-based ultraviolet absorbent include 2,4-dihydroxybenzophenon, 2-hydroxy-4-acetoxybenzophenone, 2-hydroxy-4-methoxybenzophenone, 2,2′-dihydroxy-4-methoxybenzophenone, 2,2′-dihydroxy-4,4′-methoxybenzophehone, 2-hydroxy-4-n-octoxybenzophenone, 2-hydroxy-4-dodecyloxybenzophenone, 2-hydroxy-4-(2-hydroxy-3-methacryloxy)propoxybenzophenone and the like.

Examples of the benzotriazole-based ultraviolet absorbent include 2-(2′-hydroxy-3′-tert-butyl-5′-methylphenyl)-5-chlorbenzotriazole, 2-(2′-hydroxy-5′-t-butylphenyl)benzotriazole, 2-(2′-hydroxy-3′,5′-di-t-arnyrphenyl)benzotriazole, 2-(2′-hydroxy-3′,5′-di-t-butylphenyl)-5-chlorbenzotriazole, 2-(2′-hydroxy-5′-t-octylphenyl)benzotriazole and the Tike.

The salicylic acid esters include phenyl salicylate, p-octylphenyl salicylate, p-tert-butylphenyl salicylate and the like.

Among these exemplified ultraviolet absorbents, particularly 2-hydroxy-4-methoxybenzophenone, 2,2′-dihydroxy-4,4′-methoxybenzbphenone, 2-(2′-hydroxy-3′-t-butyl-5′-methylphenyl)-5-chlorbenzotriazole, 2-(2′-hydroxy-5′-t-butylphenyl)benzotriazole, 2-(2′-hydroxy-3′,5′-di-t-amylphenyl)benzotriazole, 2-(2′-hydroxy-3′,5′-di-t-butylphenyl)-5-chlorbenzotriazole are particularly preferred.

For the ultraviolet absorbent, it is preferably to use a combination with a plurality of other absorbents having different absorption wavelengths, because high blocking effect can be obtained in a wide wavelength range. The ultraviolet absorbent for liquid crystals preferably has excellent absorption power for ultraviolet rays with wavelengths of 370 nm and shorter in view of preventing deterioration of liquid crystals, while preferably has less absorption of visible light with wavelengths of 400 nm or longer in view of liquid crystal display properties. In particular, preferred ultraviolet absorbents include the above-mentioned benzotriazole compounds, benzophenone compounds and salicylic acid ester compounds. Among those, benzotriazole compounds are preferred since they cause less useless coloration against cellulose esters.

Furthermore, for the ultraviolet absorbent, the compounds described in JP-A No. 60-235852, JP-A No. 3-199201, JP-A No. 5-1907073, JP-A No. 5-194789, JP-A No. 5-271471, JP-A NO. 6-107854, JP-A No. 6-118233, JP-A No. 6-148430, JP-A No. 7-11055, JP-A No. 7-11056, JP-A No. 8-29619, JP-A No. 8-239509, and JP-A No. 2000-204173 also can be used.

The amount of the ultraviolet absorbent to be added is preferably 0.001 to 5% by weight, and more preferably 0.01 to 1% by weight, based on the cellulose acylate. When the amount to be added is 0.001% by weight or more, the effect of addition can be sufficiently expressed, which is preferable, while when the amount to be added is 5% by weight or less, the bleed-out of the ultraviolet absorbent on the film surface can be suppressed, which is preferable.

Also, the ultraviolet absorbent may be added at the same time with the cellulose acylate upon dissolution, or may be added to the dope after dissolution. In particular, it is preferable to add an ultraviolet absorbent solution to the dope immediately before flow casting using a static mixer or the like, because the spectrometric absorption characteristics can be easily adjusted.

(Anti-Degradant)

The anti-degradant can prevent deterioration or decomposition of cellulose triacetate or the like. The anti-degradant may be exemplified by butylamine, hindered amine compounds (JP-A No. 8-325537), guanidine compounds (JP-A No. 5-271471), benzotriazole-based UV absorbents (JP-A No. 6-235819), benzophenone-based UV absorbents (JP-A NO. 6-118233) and the like.

(Plasticizer)

The plasticizer is preferably a phosphoric acid ester or a carboxylic acid ester. Examples of the phosphoric acid ester plasticizer include triphenyl phosphate (TPP), tricresyl phosphate (TCP), cresyldiphenyl phosphate, octyldiphenyl phosphate; biphenyldiphenyl phosphate (BDP), trioctyl phosphate, tributyl phosphate and the like; examples of the carboxylic acid ester plasticizer include dimethyl phthalate (DMP), diethyl phthalate (DEP), dibutyl phthalate (DBP), didctyl phthalate (DOP), diphenylphthalate (DPP), diethylhexyl phthalate (DEHP), triethyl o-acetylcitrate (OACTE), tributyl o-acetylcitrate (OACTB), acetyltriethyl citrate, acetyltributyl citrate, butyl oleate, methylacetyl ricinolate, dibutyl sebacate, triacetine, tributyline, butylphthalylbutyl glycolate, ethylphthafylethyl glycolate, methylphthalylethyl glycolate, butylphthalylbutyl glycolate and the like. The plasticizers used for the invention are preferably selected from these exemplified plasticizers. It is still preferable that the plasticizer is a (di)pentaerythritol ester, a glycerol ester, and a diglycerol ester.

(Delamination Accelerator)

Examples of the delamination accelerator include ethyl esters of citric acid.

(Infrared Absorbent)

Examples of the infrared absorbent are described in, for example, JP-A No. 2001-194522.

(Time for Addition, and the Like)

Although these additives may be added at any stage during the dope preparing process, a preparation step of adding the additives may be further employed as the final step of the dope preparation process. The amount of addition is not particularly limited, so long as the desired effect thereof can be achieved.

When the cellulose acylate film is multilayered, individual layers may contain different types of additives in various amounts. These techniques have been conventionally known, as reported in, for example, JP-A-2001-151902.

It is preferable to appropriately select the types and the amount of addition of these additives so as to adjust the glass transition temperature Tg of the cellulose acylate film, which is measured with a dynamic viscoelasticity meter (VIBRON:DVA-225 manufactured by IT KEISOKUSEIGYO Co., Ltd.), to 70 to 150° C. and the elastic modulus, which is measured with a tensile test machine (STROGRAPHY R2 manufactured by TOYO SEIKI KOGYO Co.), to 1500 to 4000 MPa. It is more preferable that the glass transition temperature Tg is 80 to 135° C. while the elastic modulus is 1500 to 3000 MPa. That is to say, the cellulose acylate film preferably used for the invention preferably has the glass transition temperature Tg and the elastic modulus to be within the respective ranges as defined above, from the viewpoint of handlability in the processing of polarizing plates or the assembling of liquid crystal displays.

Furthermore, for the additives, those described in detail in Japan Institute, of Invention and Innovation Journal of Technical Disclosure No. 2001-1745 (Mar. 15, 2001, Japan Institute of Invention and Innovation), from p. 16 and on can be appropriately used.

(Retardation Decreasing Agent)

The retardation decreasing agent that is used for decreasing optical anisotropy of the cellulose acylate film will be described.

By using a compound which suppresses the cellulose acylate in the film from aligning in the plane and in the film thickness direction, the optical anisotropy can be sufficiently decreased to bring Re and Rth to zero or near zero. Thus, the compound decreasing optical anisotropy is advantageous if it is sufficiently compatible with cellulose acylate, and the compound itself does hot have a rod-shaped structure or a planar structure. Specifically, when the retardation decreasing agent has a plurality of planar functional groups such as aromatic groups, it is advantageous if the retardation decreasing agent has the functional groups in the same plane but in non-planar manner.

(logP Value)

In the case of producing a cellulose acylate film having low optical anisotropy, as described in the above, a compound having an octanol/water partition coefficient (logP value) of 0 to 7 is preferred among the compounds which decrease optical anisotropy by suppressing cellulose acylate in the film from aligning in the plane and in the film thickness, direction. When the logP value of the compound is 7 or less, the compound has good compatibility with cellulose acylate, and does not cause inconveniences such as clouding, dusting or the like of the film, which is preferable.

Furthermore, when the logP value of the compound is 0 or greater, the hydrophilicity is not increased too high, and does not deteriorate water resistance of the cellulose acylate film, which is preferable. The logP value is more preferably in the range of 1 to 6, and particularly preferably in the range of 1.5 to 5.

Measurement of the octanol/water partition coefficient (logP value) can be carried out according to a flask immersion method described in JIS Z-7260-107 (2000). Further, the octanol/water partition coefficient (logP value) allows conjecture by computational chemistry techniques or empirical methods, instead of actual measurement.

Preferred computational methods include Crippen's fragmentation method {“J. Chem. Inf. Comput. Sci.”, Vol. 27, p. 21 (1987)}, Viswanadhan's fragmentation method {“J. Chem. Inf. Comput. Sci.”, Vol. 29, p. 163 (1989)}, Broto's fragmentation method {“Eur. J. Med. Chem.-Chim. Theor.”, Vol. 19, p. 71 (1984)}, and the like, and Crippen's fragmentation method {“J. Chem. Inf. Comput. Sci.”, Vol. 27, p. 21 (1987)} is more preferred.

When the logP value of a certain compound is found to be different by the measuring method or computational method, it is preferable to determine as to whether the compound is within the above-described range by Crippen's fragmentation method.

(Properties of Compound Decreasing Optical Anisotropy)

The compound decreasing optical anisotropy may or may not contain an aromatic group. The compound decreasing optical anisotropy preferably has a molecular weight of 150 to 3000, more preferably 170 to 2000, and particularly preferably 200 to 1000. Within this range of molecular weight, the compound may have a specific monomer structure, or may have an oligomer structure or polymer structure combining a plurality of the certain monomer units.

The compound decreasing optical anisotropy is preferably a liquid at 25° C. and a solid having a melting point of 25 to 250° C., and more preferably a liquid at 25° C. and a solid having a melting point of 25 to 200° C. Furthermore, the compound decreasing optical anisotropy preferably does not volatilize during the process of dope flow casting and drying for the production of cellulose acylate film.

The amount of the compound decreasing optical anisotropy to be added is preferably 0.01 to 30% by weight, more preferably 1 to 25% by weight, and particularly preferably 5 to 20% by weight of cellulose acylate.

The compound decreasing optical anisotropy may be used individually or as an arbitrary mixture of two or more compounds.

Addition of the compound decreasing optical anisotropy may be performed at any time during the process for dope production, and may be at the final stage of the dope production process.

For the compound decreasing optical anisotropy, it is preferable that the average content of the compound in the portion extending from the surface of at least one side to 10% of the overall film thickness is 80 to 99% of the average content of the compound in the central portion of the cellulose acylate film. The amount of the compound decreasing optical anisotropy present can be determined by measuring the amount of the compound at the surface and in the central portion by the method of using infrared absorption spectrum described in JP-A No. 8-57879, or the like.

(Dye)

According to the invention, dyes for color adjustment also may be added. The content of the dyes is preferably 10 to 1000 ppm, and more preferably 50 to 500 ppm, as a weight ratio with respect to cellulose acylate. When dyes are contained as such, light piping of the cellulose acylate film can be reduced, thus improving yellow tone. Such compounds may be added together with cellulose acylate or a solvent in the beginning of the production of a cellulose acylate solution, or may be added during or after the production of the solution. Also, the compounds may be added to an ultraviolet absorbent solution that is added in-line. The dyes described in JP-A No. 5-34858 can be used.

(Matting Agent Microparticles)

It is preferable that the cellulose acylate film according to the invention contains microparticles as a matting agent. Examples of the microparticles that can be used in the invention include, silicon dioxide, titanium dioxide, aluminum oxide, zirconium oxide, calcium carbonate, calcium carbonate, talc, clay, calcined kaolin, Calcined calcium silicate, hydrated calcium silicate, aluminum silicate, magnesium silicate and/calcium phosphate. The microparticles preferably contain silicon in view of having low turbidity, and in particular, silicon dioxide is preferred.

The microparticles of silicone dioxide preferably have an average primary particle size of 20 nm or less and an apparent specific gravity of 70 g/L or greater. Microparticles having a small average primary particle size of 5 to 16 nm are still preferred, since the haze of the resultant film can be lowered thereby. The apparent specific gravity is preferably 90 to 200 g/L or greater, and more preferably 100 to 200 g/L or greater. A higher apparent specific gravity makes it possible to prepare a dispersion of higher concentration, thereby improving haze and aggregates, which is preferable.

In the case of using microparticles of silicon dioxide as the matting agent, the amount of use is preferably 0.01 to 0.3 parts by weight relative to 100 parts by weight of the polymer components including cellulose acylate.

These microparticles form secondary particles having an average particle size of usually 0.1 to 3.0 μm, but in a film, these microparticles exist as aggregates of primary particles and form irregularities of 0.1 to 3.0 μm in height on the film surface. The average particle size of the secondary particles is preferably from 0.2 μm to 1.5 μm, more preferably from 0.4 μm to 1.2 (am, and most preferably from 0.6 μm to 1.1 μm. When the average particle size is less than 1.5 μm, there is no occurrence that haze becomes much too strong, while when the average particle size is larger than 0.2 μm, an effect of inhibiting creak is sufficiently manifested.

The primary or secondary particle size of the microparticles is determined by observing a particle, in the film under a scanning electron microscope and measuring the diameter of a circumcircle of the particle as the particle size. 200 particles are observed at various sites, and the mean value is taken as the average particle size.

For the microparticles of silicon dioxide, commercially available products such as, for example, AEROSIL R972, R972V, R974, R812, 200, 200V, 300, R202, OX50, TT600 (each manufactured by Nippon Aerosil Co., Ltd.) can be used. For the microparticles of zirconium oxide, commercially available products marketed under the trade name of, for example, AEROSIL R976 and R811 (each manufactured by Nippon Aerosil Co., Ltd.) can be used.

Among these products, “AEROSIL 200V” and “AEROSIL R972V” are particularly preferred, since they are microparticles of silicon dioxide having an average primary particle size of 20 nm or less and an apparent specific gravity of 0.70 g/L or greater, and exert an effect of significantly lowering the coefficient of friction while maintaining the turbidity of the optical film at a low level.

According to the invention, in order to obtain a cellulose acylate film having particles with a small average secondary particle size, some techniques may be proposed for the preparation of a dispersion of microparticles. For example, the microparticles are mixed with a solvent with stirring to prepare a dispersion of microparticles. Then, this dispersion of microparticles is added to a small amount of a cellulose acylate solution that has been prepared separately, and dissolved therein under stirring. Then, the resulting solution mixture is further mixed with a main cellulose acylate dope solution. This is a preferable preparation method from the viewpoints of achieving high dispersability of the silicon dioxide microparticles, and causing less re-aggregation of the silicon dioxide microparticles. An alternative method comprises adding a small amount of a cellulose ester to a solvent, dissolving it with stirring, then adding microparticles thereto, dispersing the microparticles using a disperser to give an additive solution of microparticles, and then sufficiently mixing the additive solution of microparticles with a dope solution in an in-line mixer. The invention is not limited to these methods, but in the case of mixing and dispersing the silicon dioxide microparticles in a solvent, the concentration of silicon dioxide is preferably 5 to 30% by weight, more preferably 10 to 25% by weight, and most preferably 15 to 20% by weight.

A higher dispersion concentration is preferred, since the solution turbidity with respect to the amount added is lowered, and the haze and aggregation are improved thereby. The amount of the matting agent added into the final dope solution of cellulose acylate is preferably 0.01 to 1.0 g, more preferably 0.03 to 0.3 g, and most preferably 0.08 to 0.16 g, per 1 m².

For the solvent to be used, lower alcohols, preferably such as methyl alcohol, ethyl alcohol, propyl alcohol, isopropyl alcohol, butyl alcohol and the like may be mentioned. Solvents other than lower alcohols are not particularly limited, but it is preferable to use solvents that are employed during the production of cellulose ester films.

Next, the above-described organic solvent for dissolving the cellulose acylate that is favorably used for the invention will be described.

According to the invention, the organic solvent that can be used may be either a chlorinated solvent comprising a chlorinated organic solvent as the main solvent, or a non-chlorinated solvent not containing any chlorinated organic solvents.

(Chlorinated Solvent)

In preparing the cellulose acylate solution according to the invention, chlorinated organic solvents are favorably used as the main solvent. According to the invention, the type of the chlorinated organic solvent is not particularly limited, as long as the object of dissolving cellulose acylate and forming a film by flow casting can be achieved. For such chlorinated organic solvent, dichloromethane and chloroform are preferred, and dichloromethane is particularly preferred. Moreover, it is also possible to use a mixture an organic solvent other than chlorinated organic solvents, without any problem. In this case, dichloromethane is preferably used in an amount of at least 50% by weight of the total amount of organic solvents.

Now, other organic solvents that can be used in combination with the chlorinated organic solvents for the invention will be described.

That is, as preferable examples of other organic solvents, the solvents selected from esters, ketones, ethers, alcohols, hydrocarbons and the like, respectively having 3 to 12 carbon atoms, are preferred. The esters, ketones, ethers and alcohols may have cyclic structures. It is also possible to use compounds having two or more functional groups of esters, ketones and ethers (i.e., —O—, —CO— and —COO—) as the solvent, and these compounds may have other functional groups such as, for example, an alcoholic hydroxyl group, at the same time. In the case of a solvent having two or more types of functional groups, it will be acceptable if the carbon number thereof falls within a regular range concerning a compound having any functional group. Examples of the ester having 3 to 12 carbon atoms include ethyl formate, propyl formate, pentyl formate, methyl acetate, ethyl acetate, pentyl acetate and the like. Examples of the ketone having 3 to 12 carbon atoms include acetone, methyl ethyl ketone, diethyl ketone, diisobutyl ketone, cyclopentanone, cyclohexanone, methylcyclohexanone and the like. Examples of the ether having 3 to 12 carbon atoms include diisopropyl ether, dimethoxymethane, dimethoxyethane, 1,4-dioxane, 1,3-dioxolane, tetrahydrofuran, anisole, phenetol and the like. Examples of the organic solvent having two or more types of functional groups include 2-ethoxyethyl acetate, 2-methoxyethanol, 2-butoxyethanol and the like.

The alcohol to be used in combination with the chlorinated organic solvent may be preferably a straight-chained or branched alcohol; or may be a cyclic alcohol. Among those, saturated aliphatic hydrocarbons are preferred. The hydroxyl group of the alcohol may be any of primary to tertiary hydroxyl groups. Examples of the alcohol include methanol, ethanol, 1-propanol, 2-propanol, 1-butanol, 2-butanol, t-butanol, 1-pentanol, 2-methyl-2-butanol and cyclohexanol. As the alcohol, fluorinated alcohols are also used, and examples thereof include 2-fluoroethariol, 2,2,2-trifluoroethanol, 2,2,3,3-tetrafluoro-1-propanol and the like. In addition, the hydrocarbon may be straight-chained or branched, or may be cyclic. Aromatic hydrocarbons and aliphatic hydrocarbons may all be used. The aliphatic hydrocarbons may be either saturated or unsaturated. Examples of the hydrocarbon include cyclohexane, hexane, benzene, toluene and xylene.

Examples of the combination of a chlorinated organic solvent with another organic solvent are as follows, but the invention is not limited thereto.

Dichloromethane/methanol/ethanol/butanol= 80/1075/5 (parts by weight),

Dichloromethane/acetone/methanol/propanol=80/10/5/5 (parts by weight),

Dichloromethane/methanol/butanol/cyclohexane=80/10/5/5 (parts by weight),

Dichloromethane/methyl ethyl ketone/methanol/butanol=80/10/5/5 (parts by weight),

Dichloromethane/acetone/methyl ethyl ketone/ethanol/isopropanol=75/8/5/5/7 (parts by weight),

Dichloromethane/cyclopentanone/methanol/isopropanol=80/7/5/8 (parts by weight),

Dichloromethane/methyl acetate/butanol=80/10/10 (parts by weight),

Dichloromethane/cyclphexanone/methanol/hexane=70/20/5/5 (parts by weight),

Dichloromethane/methyl ethyl ketone/acetone/methanol/ethanol=50/20/20/5/5 (parts by weight),

Dichloromethane/1,3-dioxolane/methanol/ethanol=70/20/5/5 (parts by weight),

Dichloromethane/dioxane/acetone/methanol/ethanol=60/20/5/5 (parts by weight),

Dichloromethane/acetone/cyclopentanone/ethanol/isobutanol/cyclohexane=65/10/10/5/5/5 (parts by weight),

Dichloromethane/methyl ethyl ketone/acetone/methanol/ethanol=70/10/10/5/5 (parts by weight),

Dichloromethane/acetone/ethyl acetate/ethanol/butanol/hexane=65/10/10/5/5/5 (parts by weight),

Dichloromethane/methyl acetoacetate/methanol/ethanol=65/20/10/5 (parts by weight),

Dichloromethane/cyclopentanone/ethanol/butanol=65/20/10/5 (parts by weight).

(Non-Chlorinated Solvent)

Next, non-chlorinated organic solvents that are preferably used in preparing the cellulose acylate solution preferably used for the invention will be described. According to the invention, the type of the non-chlorinated organic solvent is not particularly limited, as long as the object of dissolving cellulose acylate and forming a film by flow casting can be achieved. For the non-chlorinated organic solvent, the solvents selected from esters, ketones and ethers, respectively having 3 to 12 carbon atoms, are preferred. The esters, ketones and ethers may have cyclic structures. It is also possible to use compounds having two or more functional groups of esters, ketones and ethers (i.e., —O—, —CO— and —COO—) as the main solvent, and these compounds may have other functional groups such as, for example, an alcoholic hydroxyl group. In the case of a main solvent having two or more types of functional groups, it will be acceptable if the carbon number thereof falls within a regular range concerning a compound having any functional group. Examples of the ester having 3 to 12 carbon atoms include ethyl formate, propyl formate, pentyl formate, methyl acetate, ethyl acetate and pentyl acetate. Examples of the ketone having 3 to 12 carbon atoms include acetone, methyl ethyl ketone, diethyl ketone, diisobutyl ketone, cyclopentanone, cyclohexanone, methyl cyclohexanone and methyl acetylacetate. Examples of the ether having 3 to 12 carbon atoms include diisopropyl ether, dimethoxymethane, dimethoxyethane, 1,4-dioxane, 1,3-dioxolane, tetrahydrofuran, anisole and phenetol. Examples of the organic solvent having two or more types of functional groups include 2-ethoxyethyl acetate, 2-methoxyethanol and 2-butoxyethanol.

The non-chlorinated organic solvent to be used for cellulose acylate as described above is selected in accordance with various viewpoints, but it is favorable to take the following points into consideration.

That is to say, for the non-chlorinated solvent, a solvent mixture comprising the above-described non-chlorinated organic solvent as the main solvent is preferred, particularly a solvent mixture comprising three or more types of different solvents. Such solvent mixture may comprise at least one selected from among methyl acetate; ethyl acetate, methyl formate, ethyl formate, acetone, dioxolane, dioxane and mixtures thereof as a first solvent; a second solvent selected from ketones having from 4 to 7 carbon atoms and acetoacetic acid esters; and a third solvent selected from alcohols and hydrocarbons, respectively having 1 to 10 carbon atoms, more preferably alcohols having from 1 to 8 carbon atoms. Furthermore, when the first solvent is a mixture of two or more types of solvents, it is possible to employ no second solvent. More preferably, the first solvent is methyl acetate, acetone, methyl formate, ethyl formate or a mixture thereof, while the second solvent is methyl ethyl ketone, cyclopentanone, cyclohexanone or methyl acetylacetate, or possibly a mixture thereof.

The alcohol to be used as the third solvent may be straight-chained, branched or cyclic. Inter alia, saturated aliphatic hydrocarbon chains are preferred. The hydroxyl group in the alcohol may be any of primary to tertiary hydroxyl groups. Examples of the alcohol include methanol, ethanol, 1-propanol, 2-propanol, 1-butanol, 2-butanol, t-butanol, 1-pentanol, 2-methyl-2-butanol and cyclohexanol. For the alcohol, fluorinated alcohols having part or all of the hydrogens in the hydrocarbon chain substituted by fluorine may be also used. Examples thereof include 2-fluoroethanol, 2,2,2-trifluoroethanol, 2,2,3,3-tetrafluoro-1-propanol and the like.

Furthermore, the hydrocarbon may be straight-chained, branched or cyclic. Aromatic hydrocarbons and aliphatic hydrocarbons may all be used. The aliphatic hydrocarbons may be either saturated or unsaturated. Examples of the hydrocarbon include cyclohexane, hexane, benzene, toluene and xylene.

These alcohols and hydrocarbons to be used as the third solvent may be employed individually or as a mixture of two or more species. Specific examples of the compound that is preferred as the third solvent include alcohols such as methanol, ethanol, 1-propanol, 2-propanol, 1-butanol, 2-butanol and cyclohexanol; and hydrocarbons such as cyclohexane, hexane and the like, with methanol, ethanol, 1-propanol, 2-propanol and 1-butanol being particularly preferred.

Concerning the mixing ratio of the three solvents in the solvent mixture described above, it is preferable that the content of the first solvent amounts to 20 to 95% by weight, the content of the second solvent amounts to 2 to 60% by weight and the content of the third solvent amounts to 2 to 30% by weight. It is still preferable that the content of the first solvent is 30 to 90% by weight, the content of the second solvent is 3 to 50% by weight, and the content of the third alcohol is 3 to 25% by weight, based on the total amount of the solvent mixture. It is particularly preferable that the content of the first solvent is 30 to 90% by, weight, the content of the second solvent is 3 to 30% by weight, and the content of an alcohol employed as the third solvent is 3 to 15% by weight.

The non-chlorinated organic solvents to be used for the invention are described in more detail in the Journal of Technical Disclosure by Japan Institute of Invention and Innovation, No. 2001-1745 (Mar. 3, 2001, Japan Institute of Invention and Innovation), p. 12 to 16.

Examples of the combination of non-chlorinated organic solvents that are preferable for the invention are as follows, but the invention is not limited thereto.

Methyl acetate/acetone/methanol/ethanol/butanol=75/10/5/5/5 (parts by weight),

Methyl acetate/acetone/methanol/ethanol/propanol=75/10/5/5/5 (parts by weight),

Methyl acetate/acetone/methanol/ethanol/cyclohexane=75/10/5/5/5 (parts by weight),

Methyl acetate/acetone/ethanol/butanol=81/8/7/4 (parts by weight),

Methyl acetate/acetone/ethanol/butanol=82/10/4/4 (parts by weight),

Methyl acetate/acetone/ethanol/butanol=80/10/4/6 (parts by weight),

Methyl acetate/methyl ethyl ketone/methanol/butanol=80/10/5/5 (parts by weight),

Methyl acetate/acetone/methyl ethyl ketone/ethanol/isopropanol=75/8/5/5/7 (parts by weight),

Methyl acetate/cyclopentanone/methanol/isopropanol= 80/70/5/8 (parts by weight),

Methyl acetate/acetone/butanol=85/10/5 (parts by weight),

Methyl acetate/cyclopentanone/acetone/methanol/butanol=60/15/14/5/6 (parts by weight),

Methyl acetate/cyclohexanone/methanol/hexane=70/20/5/5 (parts by weight),

Methyl acetate/methyl ethyl ketone/acetone/methanol/ethanol=50/20/20/5/5 (parts by weight),

Methyl acetate/1,3-dioxolane/methanol/ethano=±70/20/5/5 (parts by weight),

Methyl acetate/dioxane/acetone/methanol/ethanol=60/20/10/5/5 (parts by weight),

Methyl acetate/acetone/cyclopentanone/ethanol/isobutanol/cyclohexane=65/10/10/5/5/5 (parts by weight),

Methyl formate/methyl ethyl ketone/acetone/methanol/ethanol=50/20/20/5/5 (parts by weight),

Methyl, formate/acetone/ethyl acetate/ethanol/butanol/hexane=65/10/10/5/5/5 (parts by weight),

Acetone/methyl acetoacetate/methanol/ethanol=65/20/10/5 (parts by weight),

Acetone/cyclopentanone/ethanol/butanol=65/20/10/5 (parts by weight),

Acetone/1,3-dioxolane/ethanol/butanol=65/20/10/5 (parts by weight),

1,3-dioxolane/cyclohexanone/methyl ethyl ketone/methanol/butanol=55/20/10/5/5/5 (parts by weight).

It is also possible to use a cellulose acylate solution prepared by the following method.

A method which comprises preparing a cellulose acylate solution using methyl acetate/acetone/ethanol/butanol=81/8/7/4 (parts by weight), filtering, concentrating, and then adding 2 parts by weight of butanol thereto,

A method which comprises preparing a cellulose acylate solution using methyl acetate/acetone/ethanol/butanol=84/10/4/2 (parts by weight), filtering, concentrating, and then adding 4 parts by weight of butanol thereto,

A method which comprises preparing a cellulose acylate solution using methyl acetate/acetone/ethanol= 84/10/6 (parts by weight), filtering, concentrating, and then adding 5 parts by weight of butanol thereto.

In addition to the non-chlorinated organic solvents as described above, the dope to be used for the invention may further contain dichloromethane in an amount of up to 10% by weight based on the total amount of organic solvent.

(Characteristics of Cellulose Acylate Solution)

The cellulose acylate solution is a solution in which cellulose acylate is dissolved in the above-described organic solvent, and the concentration thereof is preferably in the range of 10 to 30% by weight, more preferably 13 to 27% by weight, and particularly preferably from 15 to 25% by weight, from the viewpoint of suitability for film-forming and flow casting.

The method of adjusting the cellulose acylate solution to such concentration range may be carried out by adjusting to a predetermined concentration during the step of dissolution, or alternatively, a solution of low concentration (for example, 9 to 14% by weight) may be prepared in advance, which is subsequently adjusted, by the concentration process to be described later, to a solution of a predetermined high concentration. It is also possible that a cellulose acylate solution of a high concentration is prepared in advance, and then various additives may be added to give a cellulose acylate solution of a predetermined low concentration. Any method may be used without any problem, so long as the cellulose acylate solution has a definite concentration that is favorably used according to the invention.

Next, according to the invention, it is preferable that when the cellulose acylate solution is diluted with an organic solvent having the same composition to a concentration of 0.1 to 5% by weight, the cellulose acylate aggregates in the diluted solution have a molecular weight of 150,000 to 15,000,000, from the viewpoint of their solubility in the solvent. The aggregate molecular weight is more preferably 180,000 to 9,000,000. This aggregate molecular weight can be determined by the static light scattering method. In this case, it is preferable that the dissolution is achieved to give a radius of inertia, which is determined at the same time, of 10 to 200 nm, and more preferably from 20 to 200 nm. It is also preferable to achieve the dissolution to give a second virial coefficient of −2×10⁻⁴ to +4×10⁻⁴, and more preferably −2×10⁻⁴ to +2×10⁻⁴.

Here, the definitions of the aggregate molecular weight, the radius of inertia and the second virial coefficient will be described. These terms are measured by using the static light scattering method in accordance with the following procedures. Although the measurements are carried out in a dilute region as a matter of convenience, these data reflect behaviors of the dope in the high concentration region according to the invention.

First, cellulose acylate is dissolved in a solvent to be used in the dope to give solutions having concentrations of 0.1% by weight, 0.2% by weight, 0.3% by weight and 0.4% by weight. To prevent moisture absorption, cellulose acylate that has been dried at 120° C. for 2 hours is employed and weighed at 25° C. at 10% RH. Dissolution is carried out in accordance with the method employed in dissolving the dope (normal temperature dissolution, cold dissolution, hot dissolution). Subsequently, these solutions and the solvent are filtered through 0.2 μm Teflon filters. Then, static light scattering of each filtered solution is measured at 25° C. at from 30° to 140° at an interval of 10°, using a light scattering measuring device, “DLS-700” (Otsuka Electronics Co., Ltd.). The obtained data are then analyzed by the BERRY plotting method. In addition, the refractive index required in the analysis is measured using the value of the solvent determined by using an ABBE refractometer, and the concentration gradient (dn/dc) of the refractive index is measured using a differential refractometer “DRM-1021” (Otsuka Electronics Co., Ltd.), using the solvent and solutions employed in the light scattering measurement.

(Preparation of Dope)

Next, the preparation of a cellulose acylate solution (dope) for flow casting and film formation will be described. The method of dissolving cellulose acylate is not particularly limited, and may be carried out by normal temperature dissolution cold dissolution, hot dissolution, or a combination thereof: These methods are described in, for example, JP-A No. 5-163301, JP-A No: 61-106628, JP-A No. 58-127737, JP-A No. 9-95544, JP-A No. 10-95854, JP-A No. 10-45950, JP-A No. 2000-53784, JP-A No. 11-322946, JP-A No. 11-322947, JP-A No. 2-276830, JP-A No. 2000-273239, JP-A No. 11-71463, JP-A No. 04-259511, JP-A No: 2000-273184, JP-A No. 11-323017, JP-A No. 11-302388 and the like, as the method for preparing cellulose acylate solutions.

These techniques of dissolving cellulose acylate in organic solvents as described above are applicable to the present invention, within the appropriate scope of the invention. These techniques can be carried out in accordance with the method described in detail in the Journal of Technical Disclosure of Japan Institute of Invention and Innovation, No. 2001-1745 (Mar. 15, 2001, Japan Institute of Invention and Innovation), p. 22 to 25. Moreover, the cellulose acylate dope solution preferably used for the invention is usually subjected to solution concentration and filtration, and these are described in detail in the Journal of Technical Disclosure of Japan Institute of Invention and Innovation, No. 2001-1745 (Mar. 15, 2001, Japan Institute of Invention and Innovation), p. 25. In the case of dissolving at a high temperature, a temperature equal or higher than the boiling point of the organic solvent employed is used in most cases, and in that case, dissolution is performed under elevated pressure.

From the viewpoint of easiness in flow casting, it is preferable that the cellulose acylate solution has a viscosity and a dynamic storage modulus respectively falling within the ranges to be specified below. The values are measured using 1 mL of a sample solution and a rheometer “CLS 500” and using a “Steel Cone” having a diameter of 4 cm/2° (both manufactured by TA Instruments, Inc.). The measurement is made by varying the temperature within a range of 40° C. to −10° C. at a rate of 2° C./min using an Oscillation Step/Temperature Ramp, and the static non-Newtonian viscosity n*(Pa·s) at 40° C. and the storage modulus G′(Pa) at −5° C. are measured. Before starting the measurement, the sample solution is preliminarily maintained at the measurement starting temperature, until the solution temperature becomes steady.

According to the invention, it is preferable that the viscosity at 40° C. is 1 to 400 Pa·S, and the dynamic storage modulus at 15° C. is 500 Pa or greater. It is more preferable that the viscosity at 40° C. is 10 to 200 Pa·S, and the dynamic storage elastic modulus at 15° C. is 100 to 1,000,000 Pa. Moreover, a higher dynamic storage modulus is preferred at a lower temperature. For example, in the case of having a support for flow casting at −5° C., the dynamic storage modulus at −5° C. is preferably 10,000 to 1,000,000 Pa·S, while in the case of having a support at −50° C., the dynamic storage modulus at −50° C. is preferably 10,000 to 5,000,000 Pa·s.

The characteristic of the present invention resides in that use of the specific cellulose acylate as described above results in a dope having a high concentration, and a cellulose acylate solution having a high concentration and excellent stability can be obtained without resort to a mean such as concentration. In order to further facilitate the dissolution, the cellulose acylate may be dissolved at a low concentration and then concentrated using a concentrating means. The concentration method is not particularly limited, but for example, a method which comprises supplying a low concentration solution in between a cylinder and the rotatory orbit of the periphery of rotatory blades rotating therein in the peripheral direction, and varying the temperature in the solution so as to evaporate the solvent, thereby obtaining a solution at high concentration (see, for example, JP-A No. 4-25911, etc.); a method which comprises jetting a heated low concentration solution from a nozzle into a container, flash-evaporating the solvent until the solution hits against the inner wall of the container, withdrawing the solvent vapor from the container, and then drawing a solution having a high concentration from the bottom of the container (for example, methods described in U.S. Pat. No. 2,541,012, U.S. Pat. No. 2,858,229, U.S. Pat. No. 4,414,341, U.S. Pat. No. 4,505,355, etc.), and the like may be used.

The dope solution is preferably filtered, before flow casting, with the use of an appropriate filter material made of, for example, a metallic wire or flannel to thereby eliminate undissolved materials and foreign matters such as dirt and impurities. When filtering the cellulose acylate solution, it is preferable to use a filter having an absolute filtration precision of 0.1 to 0.100 μm, more preferably to use a filter having an absolute filtration precision of 0.5 to 25 μm. The thickness of the filter is preferably 0.1 to 10 μm, and more preferably 0.2 to 2 μm. In this case, it is preferable to perform the filtration under a filtration pressure of 1.6 MPa or lower, more preferably 1.2 MPa or lower, even more preferably 1.0 MP or lower, and particularly preferably 0.2 MPa or lower. As the filter material, it is preferable to use known materials such as glass fiber, cellulose fiber, filter paper or a fluororesin such as tetrafluoroethylene resin, and the like. Among these, ceramics, metals and the like are preferably used therefor. The viscosity of the cellulose acylate solution immediately before film formation may fall within a range allowing flow casting during the film formation. It is preferable to adjust the viscosity to 10 Pa·S to 2000 Pa·S, more preferably 40 Pa·S to 500 Pa·S, and even more preferably 40 Pa·S to 500 Pa·S. The temperature in this step is not particularly limited as long as it is the temperature for flow, casting, but is preferably −5 to +70° C., and more preferably −5 to +55° C.

(Film Formation)

The cellulose acylate film according to the invention can be obtained by film-forming with the use of the cellulose acylate solution as described above. Concerning the film-forming method and apparatus, a solvent flow cast film-forming method and a solvent flow cast film-forming apparatus that are conventionally employed in forming cellulose acylate films may be used. A dope (a cellulose acylate solution) prepared in a dissolution machine (pot) is first stored in a storage pot and, after defoaming, the dope is subjected to the final preparation. Then, the dope is discharged from a dope outlet and fed into a pressure die through, for example, a pressurizable constant-rate gear pump, which can feed the dope at a constant rate with high accuracy depending on the rotational speed. From the pipe sleeve (slit) of the pressure die, the dope is uniformly flow cast onto a metallic support that is continuously running in the flow casting unit. At the point of peeling where the metallic support has almost rounded, the half-dried dope film (also called a web) is peeled from the metallic support. The obtained web is clipped at both ends and dried by conveying with a tenter while maintaining the width constant. Subsequently, the web is conveyed with a group of rolls in a dryer to terminate the drying, and then is wound with a winder in a predetermined length. Combination of the tenter and the dryer with a group of rolls may vary depending on the purpose. In the solvent flow cast film-forming method used to produce functional protective films for electronic displays, a coating apparatus is frequently employed, in addition to the solvent flow cast film-forming apparatus, for the purpose of surface processing of the film by providing, for example, an undercoating layer, an antistatic layer, an anti-halation layer, a protective layer or the like. Next, each of the production processes will be briefly illustrated, but the invention is not restricted thereto.

In forming a cellulose acylate film by the solvent casting method, the cellulose acylate solution (dope) thus prepared is first flow cast on a drum or a band, and the solvent is evaporated to form a film. Before the flow casting, it is preferable to adjust the concentration of the dope to have a solid content of 5 to 40% by weight. It is preferable that the drum or band surface has a mirror finished surface. It is preferable that the dope is flow cast on a drum or a band having a surface temperature of 30° C. or lower, and a metallic support temperature of −10 to 20° C. is particularly preferred. In the invention, it is also possible to employ the methods described in JP-A No. 2000-301555, JP-A No. 2000-301558, JP-A No. 07-032391, JP-A No. 03-193316, JP-A No. 05-086212, JP-A No. 62-037113, JP-A No. 02-276607, JP-A No. 55-014201, JP-A No. 02-111511 and JP-A No. 02-208650.

(Layered Casting)

A cellulose acylate solution may be flow cast as a single layer solution on a smooth band or drum employed as a metallic support. Alternatively, a plurality of cellulose acylate solutions may be flow cast in two or more layers. In the case of flow casting a plurality of cellulose acylate solutions, individual solutions may be flow cast respectively from a plurality of casting ports provided on the metallic support along the running direction at certain intervals, and be laminated to obtain a film. For example, the methods described in JP-A No. 61-158414, JP-A No. 1-122419 and JP-A No. 11-198285 may be applied. Alternatively, a cellulose acylate solution may be flow cast from two casting ports to form a film, and for example, the methods described in JP-B No. 60-27562, JP-A No. 61-94724, JP-A No. 61-947245, JP-A No. 61-104813, JP-A No. 61-158413 and JP-A No. 6-134933 may be used. It is also possible to adopt the cellulose acylate film flow casting method reported in JP-A No. 56-162617, which comprises wrapping a high-viscosity cellulose acylate solution flow with a low-viscosity cellulose acylate solution and simultaneously extruding both of these high-viscosity and low-viscosity cellulose acylate solutions. Moreover, it is also a preferred embodiment to employ the methods of JP-A No. 61-94724 and JP-A No. 61-94725 in which the outer solution contains an alcoholic solvent, which is a poor solvent, in a larger amount than the inner solution. It is also possible to employ the method of, for example, JP-B No. 44-20235, which comprises using two casting ports, peeling a film that has been formed on a metallic support through the first casting port, and then effecting the second flow casting on the side which is in contact with the metallic support face, to construct a multilayered film. The cellulose acylate solutions to be flow cast may be the same or different, without particular limitation. To impart functions to a plurality of cellulose acylate layers, cellulose acylate solutions corresponding to the respective functions may be extruded from the respective ports. It is also possible to flow cast the cellulose acylate solution simultaneously with other functional layers (for example, an adhesive layer, a dye layer, an antistatic layer, an anti-halation layer, an ultraviolet absorbing layer, a polarizing layer, etc.).

To achieve a desired film thickness by using a conventional single layer solution, it is necessary to extrude a cellulose acylate solution having a high concentration and a high viscosity. In this case, the poor stability of the cellulose acylate solution frequently causes problems such as machine troubles due to the formation of solid matters and surface irregularities. These problems can be overcome by flow casting a plurality of cellulose acylate solutions through a plurality of casting ports in relatively small amounts. Thus, highly viscous solutions can be simultaneously extruded on a metallic support, and thus an excellent film having improved surface smoothness can be obtained. In addition, use of thick cellulose acylate solutions contributes to the reduction in the drying load, and the resulting film in turn can be produced at an elevated production speed.

In the case of co-flow casting, the inner thickness and the outer thickness are not particularly limited, but it is preferable that the outer thicknesses 1 to 50%, and more preferably 2 to 30%, of the total film thickness. In the case of simultaneous flow casting of three or more layers, the total film thickness of the layer which is in contact with the metallic support and the layer which is in contact with the atmosphere is defined as the outer thickness. In the co-flow casting, it is also, possible to co-flow cast cellulose acylate solutions differing from each other in the concentrations of additives such as a plasticizer, an ultraviolet absorbent, a matting agent, and the like as described above, thus to form a cellulose acylate film of a laminated structure. For example, a cellulose acylate film composed of a skin layer/a core layer/a skin layer can be formed thereby. For example, a matting agent can be added in a larger amount to the skin layers or exclusively to the skin layers. A plasticizer and an ultraviolet absorbent may be added in larger amounts to the core layer than to the skin layer or exclusively to the core layer. It is also possible to use different types of plasticizers or ultraviolet absorbents to the core layer and the skin layers. For example, at least any of a less volatile plasticizer and ultraviolet absorbent may be added to the skin layers, while a plasticizer having an excellent plasticizing effect or an; ultraviolet absorbing agent showing favorable ultraviolet absorption properties may be added to the core layer. It is also a preferred embodiment to add a peeling accelerator exclusively to the skin layer in the metallic support side. Since the solution is gelled by cooling the metallic support by the cooling drum method, it is also preferred to add an alcohol, which is a poor solvent, in a larger amount to the skin layers. The skin layers and the core layer, may have different Tgs. It is preferable that the Tg of the core layer is lower than the Tg of the skin layer. Also, the skin layers and the core layer may show different viscosities of the cellulose acylate solutions of the flow casting step. If is preferable that the viscosity of the skin layers is lower than the viscosity of the core layer, but the viscosity of the core layer may be lower than the viscosity of the skin layers.

(Flow Casting)

For the method of flow casting a solution, there are a method in which a prepared dope is uniformly extruded from a pressure die to a metallic support, a method of using a doctor blade, in which a dope once cast on a metallic support is treated with a blade to control the film thickness, and a method of using a reverse roll coater, in which the film is controlled with a coater rotating in the reverse direction, and the like. The pressure die method is favorable. There have been known pressure dies of coat hunger type and T-die type and each of them can be preferably employed. In addition to the methods cited above, use can be made of various methods for forming films by casting cellulose acylate solutions which have been conventionally known. By setting conditions while considering the differences in boiling point among solvents employed, effects similar to reported in the documents can be established. As the continuously ruing metallic, support to be used in forming the cellulose acylate film according to the invention, use may be made of a drum having chrom-plated and mirror finished surface or a stainless belt (also called a band) having polished and mirror finished surface.

To produce the cellulose acylate film according to the invention, one or more, pressure dies may be provided above the metallic support. It is preferred to employ one or two pressure dies. In the case of providing two or more pressure dies, the dope to be cast may be divided into portions in various amounts appropriate for individual dies. It is also possible to feed the dope in various amounts into the dies by using a plurality of precise constant-rate pumps. The temperature of the cellulose acylate solution to be cast preferably ranges from −10 to 55° C., and more preferably from 25 to 50° C. The temperature may be maintained at the same level throughout the process or vary in different processes. In the case of varying, the temperature should attain the desired level immediately before the flow casting.

(Drying)

On the metallic support relating to the production of the cellulose, acylate film, the dope is dried generally by a method of blowing a hot air stream from the front face side of the metallic support (a drum or a belt), that is, the web surface on the metallic support; a method of blowing a hot air stream form the back face of the drum or the belt; a liquid heat transfer method comprising bringing a temperature-controlled liquid into contact with the belt or the drum from the back face (i.e., the opposite face of the dope casting surface), thus heating the drum or the belt by heat-transfer and controlling the surface temperature; or the like. The back face liquid heat transfer method is preferred. Before the flow casting, the surface temperature of the metallic support may be at an arbitrary level, so long as it is not higher than the boiling points of the solvents employed in the dope. In order to facilitate the drying or reduce the fluidity on the metallic support, it is preferable to set the surface temperature to a level lower by 1 to 10° C. than the boiling point of a solvent having the lowest boiling point among the solvents employed, which would not apply to the case where the dope having been cast is stripped without cooling and drying.

In order to inhibit light leakage when the polarizing plate is viewed from a tilt, it is necessary to dispose the transmissive axis of the polarizer and the in-plane slow axis of the cellulose acylate film in parallel. Since the transmissive axis of the polarizer in a roll film shape that is continuously produced is generally in parallel with the width direction of the roll film, in order to continuously bond the polarizer in a roll film shape and the protecting film formed from the cellulose acylate film in a rolled film shape, the in-plane slow axis of the protecting film in the roll film shape is needed to be in parallel with the width direction of the film. Therefore, it is preferable to stretch more along the width direction. The stretching treatment may be conducted during the film forming process, or the film-formed and wound original film may be stretched. In the former case, stretching may be carried out with residual solvent still being contained, and stretching can be performed preferably with an amount of residual solvent of 2 to 30% by weight.

The film thickness of the cellulose acylate film according to the invention obtained after drying varies depending on the purpose of use. It preferably ranges from 5 to 500 μm, more preferably from 20 to 300 μm, and particularly preferably from 30 to 150 μm. To use in a VA liquid crystal display, the film thickness is preferably 40 to 100 μm. The adjustment of the film thickness may favorably done by adjusting the concentration of solid contents contained in the dope, the slit interval of the die sleeve, the extrusion pressure from the die, the speed of the metal support or the like, in order to achieve a desired thickness.

The width of the cellulose acylate film thus obtained is preferably 0.5 to 3 m, more preferably 0.6 to 2.5 m, and even more preferably 0.8 to 2.2 m. It is preferable to wind the film in a length of 100 to 10,000 m per roll, more preferably 500 to 7,000 m, and even more preferably 1,000 to 6,000 m. In the winding step, it is preferable to provide a knurling at least at one end, and the width of the knurling is preferably 3 mm to 50 mm, and more preferably 5 mm to 30 mm, while the height thereof is preferably 0.5 to 500 μm, and more preferably 1 to 200 μm. Knurling may be made either at one end or both ends.

It is preferable that the fluctuation in the Re₅₉₀ value in the film width direction is ±5 nm, more preferably ±3 nm. The fluctuation in the Rth₅₉₀ value in the width direction is preferably ±10 nm, and more preferably ±5 nm. It is also preferable that the fluctuations in the Re value and the Rth value in the longitudinal direction also fall within the same ranges as in the width direction.

The cellulose acylate film of the invention is used as a protecting film for polarizing plate, and in particular, can be preferably used as a retardation film corresponding to various liquid crystal modes.

In the case of using the cellulose acylate film of the invention as a retardation film, preferable optical characteristics of the cellulose acylate film differ in accordance with the liquid crystal mode.

For the OCB mode, the cellulose acylate film preferably has an Re of 10 to 100 nm, more preferably 20 to 70 nm, and preferably an Rth of 50 to 300 nm, more preferably 100 to 250 nm.

For the VA mode, the cellulose acylate film preferably has an Re of 20 to 150 nm, more preferably 30 to 120 nm, and an Rth of 50 to 300 nm, more preferably 120 to 250 nm.

For the TN mode, the cellulose acylate film preferably has an Re of 0 to 50 nm, more preferably 2 to 30 nm, and an Rth of 10 to 200 nm, more preferably 30 to 150 nm.

For the IPS mode, the cellulose acylate film preferably has an Re of 0 to 5, more preferably 0 to 2, and an Rth of −20 to 20, more preferably −10 to 10.

In the OCB mode and TN mode, an optically anisotropic layer is coated on a cellulose acylate film having the retardation values, and can be used as an optical compensation film.

In addition, the birefringence (Δn:nx−ny) of the cellulose acylate film is preferably in the range of 0.00 to 0.002 μm. The birefringence in the thickness direction {(nx+ny)/2−nz} of the support film and the opposing film is in the range of 0.00 to 0.04 μm.

In the case of using the cellulose acylate film favorably used for the invention in the VA mode, there are available two types, such as a form of using one sheet on both sides of the cell, thus using two sheets in total (two-sheet type), and a form of using one sheet on either of the upper or lower side of the cell (one-sheet type).

In the case of the two-sheet type, Re(590) is preferably 20 to 100 nm, more preferably 30 to 70 nm, while Rth(590) is preferably 70 to 300 nm, more preferably 100 to 200 nm.

In the case of the one-sheet type, Re(590) is preferably 30 to 150 nm, more preferably 40 to 100 nm, while Rth(590) is preferably 100 to 300 nm, more preferably 150 to 250 nm.

The fluctuation in the angle of the in-plane slow axis of the cellulose acylate film that is favorably used for the invention, is preferably in the range of −2° to +2°, more preferably in the range of −1° to +1°, and most preferably in the range of −0.5° to 0.5°, with respect to the reference direction of the roll film. Here, the reference direction refers to the longitudinal direction of the roll film in the case of longitudinally stretching the cellulose acylate film, and refers to the width direction of the roll film in the case of laterally stretching.

It is preferable for the cellulose acylate film according to the invention that the difference between the Re value at 25° C. and 10% RH (Re_{10%}) and the Re value at 25° C. and 80% RH (R_{80%}), that is, ΔRe(=Re_{10%}−Re_{80%}) is 0 to 10 nm, and the difference between the Rth value at 25° C. and 10% RH (Rth_{10%}) and the Rth value at 25° C. and 80% RH (Rth_{80%}), that is, ΔRth(=Rth_{10%}−Rth_{80%}) is 0 to 30 nm, from the viewpoint of lessening color change in a liquid crystal display with the passage of time.

It is also preferable for the cellulose acylate film according to the invention that the equilibrium moisture content at 25° C. and 80% RH is preferably 3.2% or less, from the viewpoint of lessening color change of a liquid crystal display with the passage of time.

The moisture content is measured by the Karl Fischer method with the use of a sample (7 mm×35 mm) of the cellulose acylate according to the invention, a moisture content meter and a sample dryer (“CA-03”, “VA-05” both manufactured by Mitsubishi Chemical Co.). The water content (g) is divided by the sample weight (g).

It is also preferable for the cellulose acylate film according to the invention that the water vapor permeability (converted in terms of 80 μm in film thickness) is preferably 400 g/m²·24 hr to 1800 g/m²·24 hr, from the viewpoint of lessening color change of a liquid crystal display with the passage of time.

The water vapor permeability is decreased with an increase in the film thickness of a cellulose acylate film and is increased with a decrease in the film thickness. It is therefore necessary to convert the water vapor permeability of a sample with any film thickness by providing a standard film thickness. For the present invention, the standard film thickness was 80 μm, and the film thickness was calculated by the following equation (13):

(water vapor permeability converted as film thickness of 80 μm=measured water vapor permeability×measured film thickness ηm/80 μm. Equation (13)

Water vapor perm]eability can be measured in accordance with the method described in “Polymer Properties II” (Kobunshi Jikken Koza 4, published by Kyoritsu Shuppan), p. 285-294: Measurement of Vapor Permeability (Mass-method, Thermometer method, Vapor pressure method, Adsorption method).

Elastic modulus is measured as follows. A cellulose acylate film sample 10 mm×150 mm was conditioned at 25° C. and 60% RH for 2 hours or longer, and then the elastic modulus was measured with a tensile test machine (STROGRAPHY R2 manufactured by Toyo Seiki Kogyo Co.) at a distance between chucks of 100 mm, at a temperature of 25° C., and at a stretching speed of 10 mm/min.

The coefficient of moisture absorption expansion was determined from the value obtained by measuring the dimension of a film which had been left to stand at 25° C. and 80% RH for 2 hours or longer with a pin gauge, L_{80%}, and the value obtained by measuring the dimension of a film which had been left to stand at 25° C. and 10% RH for 2 hours or longer with a pin gauge, L_{10%}, by means of the following equation (14):

(L_{80%}−L_{10%})/(80% RH−10% RH)×10⁶ Equation (14)

The cellulose acylate film that is favorably used for the invention preferably has a haze of 0.01 to 2%. Here, the haze can measured as follows.

The haze is measured by using a cellulose acylate film sample 40 mm×80 mm at 25° C. and 60% RH with the use of a haze meter “HGM-2DP” (Suga Shikenki Co., Ltd.), according to JIS K-6714.

The cellulose acylate film that is favorably used for the invention shows a weight change of preferably 0 to 5% when allowed to stand at 80° C. and 90% RH for 48 hours.

The cellulose acylate film that is favorably used for the invention shows a dimensional change of preferably 0 to 5%, when allowed to stand at 60° C. and 95% RH for 24 hours, and also when allowed to stand at 90° C. and 5% RH for 24 hours.

The photoelastic coefficient is preferably 50×10⁻³ cm²/dyne or less, from the viewpoint of lessening color change of a liquid crystal display with the passage of time.

The photoelastic coefficient is measured by exerting a tensile stress in the longitudinal direction to a cellulose acylate film sample 10 mm×100 mm of the according to the invention, and measuring the retardation with an ellipsometer “M150” (JASCO Inc.). Then, the photoelastic coefficient is calculated based on the change in retardation due to the stress.

(Melt Film Formation)

The method for producing the optical film of the invention may be melt film formation. The raw material polymer and other raw materials such as additives are heated to melt, and the result may be extruded to form a film by injection molding. Alternatively, the film may be formed into a film by inserting the raw materials between two sheets of heated plates and pressing.

The temperature for heating and melting is not particularly limited, as long as it is a temperature for melting the raw material polymer all uniformly. Specifically, the polymer is heated to a temperature above the melting point or the softening point. In order to obtain a uniform film, it is preferable to heat and melt the polymer at a temperature higher than the melting point of the raw material polymer, preferably a temperature of 5 to 40° C. higher than the melting point, particularly preferably a temperature of 8 to 30° C. higher than the melting point.

(Alignment Film)

The optical compensation film may have an alignment film between the cellulose acylate film of the invention and an optically anisotropic layer. Alternatively, it is also acceptable to use an alignment film only when producing an optically anisotropic layer, and after producing the optically anisotropic layer on an alignment film, to transfer the optically anisotropic layer only onto the cellulose acylate film of the invention.

According to the invention, the alignment film is preferably a layer comprising a crosslinked polymer. The polymer used in the alignment film may be a self-crosslinkable polymer or a polymer crosslinkable with the use of a crosslinking agent. The alignment film can be formed by using a polymer with functional groups or a polymer having functional groups introduced, to induce an interpolymeric reaction by means of light, heat, pH change or the like; or can be formed by introducing a binding group derived from a crosslinking agent, between polymers using a crosslinking agent, which is a highly reactive compound, and crosslinking the polymers.

The alignment film comprising a crosslinked polymer can be usually formed by coating a coating solution containing the polymer or a mixture of the polymer and a crosslinking agent on a support, and then forming a film by heating or the like.

According to the rubbing process to be described later, it is preferable to increase the degree of crosslinking in order to suppress any dusting in the alignment film. When the degree of crosslinking is defined as the value obtained by subtracting the ratio of the amount of the crosslinking agent that is remaining after crosslinking, to the amount of the crosslinking agent added to the coating solution, (Ma/Mb), from 1 (1−(Ma/Mb)), the degree of crosslinking is preferably 50% to 100%, more preferably 65% to 100%, and most preferably 75% to 100%.

According to the invention, the polymer used for the alignment film that can be used is a self-crosslinkable polymer or a polymer crosslinked by a crosslinking agent. Of course, a polymer having both of the functions can be also used. Examples of the polymer include polymethyl methacrylate, acrylic acid/methacrylic acid copolymer, styrene/maleimide copolymer, polyvinyl alcohol and modified polyvinyl alcohol, poly(N-methylolacrylamide), styrene/vinyltoluene copolymer, chlorosulfonated polyethylene, nitrocellulose; polyvinyl chloride, chlorinated polyolefin, polyester, polyimide, vinyl acetate/vinyl chloride copolymer, ethylene/vinyl acetate copolymer, carboxymethylcellulose, gelatin, polyethylene, polypropylene, polycarbonate and the like, and compounds such as silane coupling agents. Preferred examples of the polymer include water-soluble polymers such as poly(N-methylolacrylamide), carboxymethylcellulose, gelatin, polyvinyl alcohol and modified polyvinyl alcohol, preferably gelatin, polyvinyl alcohol and modified polyvinyl alcohol, and particularly preferably, polyvinyl alcohol and modified polyvinyl alcohol.

When polyvinyl alcohol and modified polyvinyl alcohol are directly, introduced to the cellulose acylate film of the invention, a method of providing a hydrophilic undercoat layer, or a method of applying saponification treatment is preferably used.

Among these polymers, polyvinyl alcohol or modified polyvinyl alcohol is preferred.

The polyvinyl alcohol has, for example, a degree of saponification of 70 to 100%, and in general, preferably a degree of saponification of 80 to 100%, and more preferably, a degree of saponification of 82 to 98%. The degree of polymerization is preferably in the range of 100 to 3000.

For the modified polyvinyl alcohol, modification products of polyvinyl alcohol such as those obtained by modification by copolymerization (for example, having COONA, Si(OX)₃, N(CH₃)₃. Cl, C₉H₁₉COO, SO₃Na, C₁₂H₂₅ and the like introduced as the modifying group), those obtained by modification by chain transfer (for example, having COONa, SH, SC₁₂H₂₅ and the like introduced as the modifying group), those obtained by modification by block copolymerization (for example, having COOH, CONH₂, COOR, C₆H₅ and the like introduced as the modifying group), and the like may be mentioned. The degree of polymerization is preferably in the range of 100 to 3000. Among these, an unmodified or modified polyvinyl alcohol having a degree of saponification of 80 to 100% is preferred and more preferably an unmodified or alkylthio-modified polyvinyl alcohol having a degree of saponification of 85 to 95%.

The polyvinyl alcohol preferably has a crosslinking polymerization active group introduced so as to impart adherence between the cellulose acylate film and the optically anisotropic layer, and a preferred example is described in detail in JP-A No. 8-338913.

In the case of using a hydrophilic polymer such as polyvinyl alcohol in the alignment film, it is preferable to control the moisture content, preferably to 0.4% to 2.5%, and more preferably to 0.6% to 1.6%, from the viewpoint of film hardness. The moisture content can be measured with a commercially available moisture content measuring device according to the Karl Fischer method.

In addition, the alignment layer preferably has a film thickness of 10 μm or less.

The cellulose acylate film of the invention has an Re(550) in the range of 20 to 100 nm, and an Rth(550) in the range of 100 to 300 nm.

In particular, in the case of using as an optical compensation film in a VA mode liquid crystal display, when compensation is made using only one sheet on one side of the liquid crystal cell, it is preferable that Re(550) is in the range of 40 to 100 nm, and Rth(550) is in the range of 160 to 300 nm, while it is more preferable that Re(550) is 45 to 80 nm; and Rth(550) is 170 to 250 nm.

Meanwhile, as the optical compensation film in a VA mode liquid crystal display, when compensation is made using two sheets on both sides of the liquid crystal cell, it is preferable that Re(550) is in the range of 20 to 100 nm, and Rth(550) is in the range of 100 to 200 nm, while it is more preferable that Re(550) is 25 to 80 nm, and Rth(550) is 100 to 15.0 nm.

Furthermore, the cellulose acylate film of the invention preferably satisfies the formulae (I) to (III):

0.4<{(Re(450)/Rth(450))/(Re(550)/Rth(550))}<0.95 and 1.05<{(Re(650)/Rth(650))/(Re(550)/Rth(550))}<1.9 Formula (I)

0.1<(Re(450)/Re(550))<0.95 Formula (II)

1.03<(Re(650)/Re(550))<1.93 Formula (III)

More preferably,

0.5<{(Re(450)/Rth(450))/(Re(550)/Rth(550))}<0.9 and 1.1{(Re(650)/Rth(650))/(Re(550)/Rth(550))}<1.7 Formula (I)

0.2<(Re(450)/Re(550))<0.9 Formula (II)

1.1<(Re(650)/Re(550))<1.7. Formula (III)

(Polarizing Plate)

According to the invention, there is provided a polarizing plate comprising a polarizer and a pair of protecting films having the polarizer interposed therebetween, in which at least one of the protecting films is the cellulose acylate film described above. For example, a polarizing plate produced by dyeing a polarizer formed from polyvinyl alcohol film or the like with iodine, stretching the result, and laminating it with protecting films on both sides thereof, can be used. The polarizing plate is disposed on the outer side of the liquid crystal cell. It is preferable to dispose a pair of polarizing plates, each of which comprises a polarizer and a pair of protecting films having the polarizer interposed therebetween, so that a liquid crystal cell is interposed between the polarizing plates. In addition, the protecting film disposed on the liquid crystal cell is preferably the cellulose acylate film of the invention, or an optical compensation film.

<<Adhesive>>

The adhesive for the polarizer and the protecting films is not particularly limited, but PVA resins (including PVA modified with acetoacetyl group, sulfonic acid group, carboxyl group, oxyalkylene group or the like), or aqueous solutions of boron compounds may be mentioned, among which PVA resins are preferred. The thickness of the adhesive layer is preferably 0.01 to 10 μm, and particularly preferably 0.05 to 5 μm, after drying.

<<Consistent Production Process for Polarizer and Protecting Film>>

The polarizing plate, usable for the invention can be produced by stretching a film for polarizer, and then subjecting the film to a drying process of shrinking and reducing the volatile fraction, but it is preferable to have a post-heating process after or during the drying process, to attaching a protecting film on at least, one side thereof. A specific method for attaching comprises attaching the protecting film to the polarizer using an adhesive, while both of the edges are held, during the film drying process, and then trimming the edges. Alternatively, there is a method of releasing the film for polarizer from the edge holding units after drying, trimming both of the edges, and then attaching protecting films. For the trimming method, general techniques can be used, such as a method of cutting with a cutter such as knife blade or the like, a method of using a laser, and the like. After bonding the protecting film, the assembly is preferably heated in order to dry the adhesive, and to improve the polarizing function. The heating conditions may vary depending on the adhesive, but for water-based systems, the temperature is preferably 30° C. or higher, more preferably 40° C. to 100° C., and even more preferably 50° C. to 90° C., It is more preferable to conduct these processes in a consistent line from the viewpoints of performance and production efficiency.

<<Performance of Polarizing Plate>>

It is preferable for the polarizing plate of the invention to have optical properties and durability (short-term and long-term preservability) that are equivalent or better than the performance of commercially available super high contrast products (for example, HLC2-5618 manufactured by Sanritz Corp., etc.). Specifically, it is preferable for the polarizing plate if the transmission of visible light is 42.5% or greater, the degree of polarization {(Tp−Tc)/(Tp+Tc)}½≧0.9995 (provided that Tp is the parallel transmission, and Tc is the cross transmission), the change in the light transmission before and after allowing the polarizing plate to stand in an atmosphere at 60° C. and 90% RH for 500 hours, and in a dry atmosphere at 80° C. for 500 hours, is preferably 3% or less, more preferably 1% or less, based on the absolute value of the light transmission, and the change in the degree of polarization under such circumstances is preferably 1% or less, more preferably 0.1% or less, based on the absolute value of the degree of polarization.

(Surface Treatment of Cellulose Acylate Film)

If necessary, the cellulose acylate film according to the invention may be surface-treated to thereby improve the adhesion thereof to various functional layers (for example, ah undercoat layer and a back layer). As the surface treatment, glow discharge treatments ultraviolet irradiation treatment, corona discharge treatment, flame treatment and acid- or alkali-treatment can be used. The glow discharge treatment as used herein may be either low-temperature plasma treatment under a low gas pressure of 10⁻³ to 20 Torr, or plasma treatment under atmospheric pressure. Examples of a plasma excitable gas, which is a gas plasma, excited under the above conditions, include argon, helium, neon, krypton, xenon, nitrogen, carbon dioxide, Freons such, as tetrafluoromethane, and mixtures thereof. These gases are described in detail in the Journal of Technical Disclosure of Japan Institute of Invention and Innovation, No. 2001-1745 (Mar. 15, 2001, Japan Institute of Invention and Innovation), p. 30 to 32. In the plasma treatment under atmospheric pressure which is attracting public attention in recent years, irradiation energy, of, for example, from 20 to 500 kGy under 10 to 1000 KeV, and more preferably from 20 to 300 kGy under 30 to 500 Kev. Among these treatments, alkali saponification is particularly favorable because of being highly effective as a surface treatment of a cellulose acylate film.

(Alkali Saponification Treatment)

The alkali saponification treatment is preferably carried out by directly dipping the cellulose acylate film in a bath containing a saponifying solution, or coating the cellulose acylate film with a saponifying solution. Examples of the coating method include dip coating, curtain coating, extrusion coating, bar coating and extrusion slide coating. As the solvent of the alkali saponification coating solution, it is preferable to select a solvent which has excellent wettability for coating the cellulose acylate film with the saponifying solution, and which is capable of maintaining the film surface in a favorable state without causing any irregularity on the cellulose acylate film surface. More specifically, an alcoholic solvent is preferred, and isopropyl alcohol is particularly preferred. It is also possible to employ an aqueous solution of a surfactant as the solvent. As the alkali in the alkali saponification coating solution, an alkali soluble in the above-mentioned solvent is preferred, and KOH or NaOH is more preferred. The saponification coating solution preferably has a pH value of 10 or higher, more preferably 12 or higher. The alkali saponification reaction is carried out preferably for 1 second to 5 minutes, more preferably for 5 seconds to 5 minutes, and particularly preferably for 20 seconds to 3 minutes. After the alkali, saponification reaction, it is preferable to wash the surface coated with the saponification solution with water or an acid, followed by washing with water.

The polarizing plate according to the invention preferably has an optically anisotropic layer on the protecting film. The optically anisotropic layer is not limited in the material, and may comprising a liquid crystalline compound, a non-liquid crystalline compound, an inorganic compound, an organic/inorganic complex compound or the like. For the liquid crystalline, compound, a low molecular weight compound having a polymerizable group is aligned, and then the alignment is immobilized by polymerization effected by light or heat; or a liquid crystalline polymer is heated to align, and then cooled to immobilize the alignment in a glassy state. As the liquid crystalline compound, compounds having a disc-shaped structure, compounds having a rod-shaped structure, and compounds having a structure showing optical biaxiality can be used. As the non-liquid crystalline compound polymers having aromatic rings such as polyimides, polyesters and the like can be used.

The formation of an optically anisotropic layer can be carried out by a variety of techniques such as coating, vapor deposition, sputtering and the like.

In the case of providing an optically anisotropic layer on the protecting film of a polarizing plate, an adhesive layer is provided on the outer side of the optically anisotropic layer, further from the polarizer side.

Moreover, it is preferable that the polarizing plate according to the invention has at least one of a hard coat layer, an antiglare layer and an antireflective layer provided on the surface of a protective film on at least one side of the polarizing plate. That is, it is preferable that a protective film (TAC2) disposed on the side that is opposite to the liquid crystal cell when employed in a liquid crystal display, has a functional film such as an anti-reflective layer provided thereon. It is preferable to provide at least one of a hard coat layer, an anti-glare layer and an anti-reflective as such a functional layer. It is unnecessary to form the respective layers individually. For example, it is possible to impart an anti-glare function to the anti-reflective layer or the hard coat layer, so as to make the anti-reflective layer to serve as an anti-glaring anti-reflective layer, instead of providing two layers of an anti-reflective layer and an anti-glare layer.

[Anti-Reflective Layer]

It is appropriate in the invention to employ an anti-reflective layer having at least a light scattering layer, and a lower refractive index layer laminated in this order on a protective film, or an anti-reflective layer having a medium refractive index layer, a higher refractive index layer and a lower refractive index layer laminated in this order on a protective film. Hereinafter, preferable examples thereof will be described. Also, in the constitution of the former, the reflectance of a mirror finished surface is generally 1% or greater, and is referred to as a Low Reflection (LR) film. In the constitution of the latter, it is possible to achieve a reflectance of a mirror finished surface of 0.5% or less, and thus, the film is referred to as an Anti-Reflection (AR) film.

(LR Film)

Now, a preferable example of an anti-reflective layer having a light scattering layer and a lower refractive index layer on a protective film of the polarizing plate will be described.

It is preferable that the light scattering layer contains matting particles. It is preferable that the refractive index of the part of the light scattering layer other than the matting particles is in the range of 1.50 to 2.00. It is also preferable that the refractive index of the lower refractive index layer is in the range of 1.20 to 1.49. According to the invention, the light scattering layer has anti-glare and hard coat-properties, and thus may be composed of a single layer or multiple layers, such as 2 to 4 layers.

To achieve a sufficient anti-glare performance and a uniform matting appearance observed with the naked eye, it is preferable that the anti-reflective layer has such surface irregularity as expressed in an average center line roughness Ra of 0.08 to 0.40 μm; ah average 10 score roughness Rz of not more than 10 times as much as Ra, an average peak-valley distance Sm of 1 to 100 μm; a standard deviation of the peak height measured from the deepest point of 0.5 μm or less; a standard deviation of the average peak-valley distance Sm based on the center line of 20 μm or less; and a ratio of the surface with an oblique, angle of 0 to 5° of 1.0% of more.

Under a C light source, it is also preferable that reflective light shows tint values a* of −2 to 2 and b* of −3 to 3, and a ratio of the minimum refractive index to the maximum refractive index of 0.5 to 0.99 within a range of from 380 nm to 780 nm. This is because a neutral tint of the reflective light can be thus obtained. It is also preferable that the b* value of transmitted light is from 0 to 3, since yellow tone during white display can be reduced thereby when applied to a display device. Furthermore, it is preferable that, in the case of inserting a lattice (120 μm×40 μm) between a surface light source and the anti-reflective film, and the brightness distribution is determined on the film, with the standard deviation of the brightness distribution being 20 or less. This is because the glareness can be reduced thereby, when the film according to the invention is employed in a high definition panel.

Concerning the optical characteristics, it is preferable that the anti-reflective layer usable in the invention has a specular reflectance of 2.5% or less, a transmittance of 90% or more, and a 60°glossiness of 70% or less, to thereby suppress reflection of external light and improve visibility. It is more preferable that the specular reflectance is 1% or less, and most preferably 0.5% or less. It is preferable to achieve a haze of 20% to 50%; art inner haze/total haze ratio of 0.3 to 1; a decrease from the haze up to the light scattering layer to the haze after the formation of the lower refractive index layer, of not more than 15%; a transmissive image clearness at a frame width of 0.5 mm of 20% to 50%; and a transmission ratio of perpendicularly transmitted light/the direction inclining by 2° to the perpendicular direction, of 1.5 to 5.0, in view of preventing glareness on a high definition LCD panel and reducing unsharpness in characters.

(Low Refraction Index Layer)

The refraction index of the low refraction index layer according to the present invention is preferably 1.20 to 1.49, and more preferably 1.30 to 1.44. The low refraction index layer is preferable to meet the formula (19) in view of low reflection characteristic.

(m/4)λ×0.7<n_{L}d_{L}<(m/4)λ×1.3 Formula (19)

Here, m is a positive odd number, n_{L} is a refraction index of the low refraction index layer, and d_{L} is a thickness of the low refraction index layer. λ is a wavelength, and preferably from 500 to 550 nm.

Hereinafter, materials useful for mellow refraction layer will be described.

The low refraction index layer is preferable to contain fluoride containing polymer as a low refraction index binder. The fluoride containing polymer is preferably one whose kinetic friction coefficient is 0.03 to 0.20, contact angle against water is 90 to 120°, and the sliding angle of distilled water is 70° or less, and capable of cross-linking by heat or de-ionized radio active ray. In the case of combining the polarizing plate according to the present invention to an image display device, it is preferable to select an adhesive available in market which has low parting property since it is easily separated after sealing or memo attachment and its parting property is preferable to be 500 gf or less, more preferably 300 gf or less, and most preferably 100 gf or less when measured using a tensile test machine. It is preferable to have surface hardness of 0.3 GPa or more, and more preferably 0.5 GPa or more when measured using a micro hardness tester, since the less scratch occurs, the higher the surface hardness is.

For the fluoride containing polymer serving as the low refractive layer, a hydrate of a silane compound containing a perfluoroalkyl group for example, (heptadecafluoro-1,1,2,2-tetrahydrodecyl)triethoxy silane, its dehydrate, and a fluoride containing copolymer with a unit capable of crosslink with a fluoride containing monomer are exemplified.

For the fluoride containing monomer, there are a fluoro-olefin (for example, fluoro-ethylene, vinylidene-fluoride, tetrafluoro-ethylene, perfluoro-octylethylene, hexafluoro-propylene, perfluoro-2,2-dimethyl-1,3-dioxol etc.), alkylester derivatives obtained from (meth)acrylic acid partially or completely substituted with fluoride (for example, viscose 6FM (Osaka organochemical Inc.), M-2020(Daikin industry Inc., etc.), and vinylether partially or completely substituted with fluoride are exemplified. Perfluoro-olefin is more preferable, and hexafluoro-propylene is most preferable in view of refractive index, solubility, transparency, availability etc.

For the unit capable of crosslink, a unit obtained by polymerization of the monomers containing self crosslinking functional group, with the molecule such as glycidyl (meth)acrylate and glycidylvinylether, a unit obtained by polymerization of monomers with a carboxyl group, hydroxyl group, amino group, sulfonyl group and the like (for example, (meth)acrylic acid, methyol (meth)acrylate, hydroxylalkyl (meth)acrylate, arylalkylate, hydroxyethylvinylether, hydroxybutylvinylether, maleic acid, crotonic acid etc.), and a unit obtained by introducing a cross linkable group such as (meth)acryloyl group onto such unit through polymerizing reaction, (for example, a method of reacting acrylic chloride onto hydroxyl group) are exemplified.

Besides of the fluoride containing monomer and the unit capable of cross-linking, a monomer containing no fluoride atom can be added for the polymerization in view of solubility into a solvent and transparency of the layer.

A monomer which can be used together is not especially limited, and olefin (ethylene, propylene, isoprene, vinylchloride, vinylidenechloride, etc.), ester acrylate(methyl acrylate, methyl acrylate, ethyl acrylate, 2-ethylhexyl acrylate), ester methacrylate(methyl methacrylate, ethyl methacrylate, butyl methacrylate, ethyleneglycoldimethacrylate, etc.), styrene derivatives(styrene, divinylbenzene, vinyltoluene, α-methylstyrene, etc.), vinylether(methylvinylether, ethylvinylether, cyclohexylvinylether, etc.), vinylester (vinylacetate, vinylpropionate, vinylcinnamate, ect), acrylamide(N-t-butylacrylamide, N-cyclohexylacrylamide, ect.), methacrylamide, acrylonitril derivatives and the like are exemplified.

As disclosed in JP-A Nos. 10-2538 and 10-147739, a hardening agent can be added to the above-mentioned polymer.

(Light Scattering Layer)

A light scattering layer is formed for the purpose of giving the film light scattering property by surface scattering or internal scattering and hard coating property which improves the anti-scratch property of the film. Thus, a binder for improving hard coating property, matt particles contributing to light scattering property, and, if necessary, an inorganic filler contributing to high refraction index, anti-shrinking property due to cross linking and high strength can be added. The light scattering layer functions as an anti-glare layer, and thus the polarizing plate is equipped with the anti-glare layer.

The thickness of the light scattering layer is, in view of giving hard coating property, preferable between 1 to 10 μm, and more preferable between 1.2 to 6 μm. In case the thickness of the light scattering layer is less than the minimum value, the hardness becomes deteriorated. On the other hand, the light scattering layer thicker than the maximum value is not preferable either since its curl and brittleness are increased, thus processibility being worse.

For the binder of the light scattering layer, a polymer having a saturated hydrocarbon main chain or a polyether main chain is preferable, and a polymer with a saturated hydrocarbon main chain is more preferable. In addition, it is preferable that the binder polymer has a cross-linking structure. For a binder polymer having a saturated hydrocarbon main chain, a polymer of unsaturated ethylene monomers is preferable. For a binder polymer having a saturated hydrocarbon main chain and a cross-linking structure, a (co)polymer of the monomers having at least 2 unsaturated ethylene functional groups is preferable. In order for the binder polymer to have a high refractive index, the monomer is preferable to contain one or more atom(s) selected from the group consisting of an aromatic ring, halogen atom except fluoride, sulfur, phosphorous and nitrogen.

For the monomer having at least 2 of unsaturated ethylene groups, an ester of polyhydric alcohol and (meth)acrylic acid (for example, ethyleneglycoldi(meth)acrylate, butanedioldimeth)acrylate, hexanedioldi(meth)arcylate, 1,4-cyclohexanediacrylate, pehtaerythritoltetra(meth)acrylate, pentaeiythritoltri(meth)acrylate, trimethylolpropanetri(meth)acryiate, trimethylolethanetri(meth)acrylate, diperitaerythritoltetra(meth)acrylate, dipentaerythritolpenta(meth)acrylate, dipentaerythritolhexa(meth)acrylate, penraerythritolhexa(meth)acrylate, 1,2,3-cyclohexonetetramethacrylate, polyurethanepolyacrylate, polyesterpolyacrylate), its ethyleneoxide derivatives, vinylbenzen and its derivatives (for example, 1,4-divinylbenzene, 4-vinylbenzoate-2-acryloylethylester, 1,4-divinylcyclohexanone), vinylsulfone (for example, divinylsulfone), acrylamide (for example, methylenebisacrylamide), and methacrylamide are exemplified. 2 or more kinds of these monomers can be used together.

For a specific example of a high refractive monomer, there is bis(4-methacryloylthiophenyl)sulfide, vinylnaphthalene,vinylphenylsulfide, 4-methacryloxyphenyl-4-methoxyphenylthioether and the like. 2 or more kinds of these monomers can also be used together.

The polymerization of the monomers having the unsaturated ethylene group can be performed by irradiation of an ionized radio active ray or by heating in the presence of a photo radical initiator or a thermal radical initiator. That is, a coating composition is prepared containing the monomers with unsaturated ethylene group, a photo radical initiator or a thermal radical initiator, a matt particle, and an inorganic filler, the coating composition is applied onto a protective film, and then an ionized radio active ray or heat is applied to cause the polymerizing reaction, thus obtaining a hardened anti-reflective layer. In this case, a well known photo radical initiator can be employed.

For the polymer having a polyether main chain, a ring opening polymer of a multi-functional epoxy compound is preferable, a ring opening polymerization of a multi-functional epoxy compound can occur by applying an ionized radio active ray or heat in the presence of a photo acid generator or thermal acid generator. That is, a coating composition containing the multi-functional epoxy compound, a photo acid generator or a thermal acid generator, a matt particle, and an inorganic filler is prepared, the composition is coated on a protective layer, and then an ionized radio active ray or heat is applied to cause the polymerizing reaction, thus obtaining a hardened anti-reflective layer.

In stead of the monomer having at least 2 of unsaturated ethylene group, it is also possible to introduce a cross-linking functional group into a polymer using a monomer with the cross-linking functional group, and then introduce a cross-linking structure into a binder polymer through the reaction of the cross-linking group.

Specific example of the cross-linking functional group, there include an isocyanate group, an epoxy group, an aziridine group, an oxazoline group, an aldehyde group, a carbonyl group, a hydrazine group, a carboxyl group, methylol group and an active methylene group. A metal alkoxide such as vinylsulfonate, acid anhydride, cyanoacrylate derivatives, melamine, etherized methylol, ester, urethane, and tetramethoxysilane can be used as a monomer for introducing the cross-linking structure. In addition, a functional group such as a block isocyanide group which shows a cross-linking property in the result of decomposition can also employed. That is, the cross-linking functional group according to the present invention may be one showing instant reactive property or one showing the reactive property after decomposition. The binder, polymer with such cross-linking functional group is subject to coating and heating to form a cross-linking structure.

The light scattering layer, for the purpose of anti-glare effect, contains matt particles greater than the filler particles, in the average diameter of 1 to 10 μm and desirably 1.5 to 7.0 μm, for example, inorganic compound particles or resin particles. Specific examples of the matt particle include inorganic compound particles such as silica particle and TiO₂ particle; and resin particles such as acryl particle, cross-linking acryl particle, polystyrene particle, cross-linking styrene particle, melamine resin particle, benzoguanamine resin particle. Among them, cross-linking acryl particle, cross-linking acrylstyrene particle, and silica particle are more desirable. The shape of the matt particle can be a spherical type or an amorphous type.

It is possible to use 2 or more kinds of matt particles together which have different sizes from each other. It is possible to make the matt particle with relatively larger size contribute to anti-glare property, and make the matt particle with relatively small size contribute to the other optical property.

The distribution of diameter size of the matt particle is desirable to have mono-distribution. The much the diameter size of each particle is same, the better. For example, In the case of defining a particle whose particle diameter is greater over 20% than the average particle diameter as a rough particle, the ratio of the rough particle is preferable to be 1% or less than the total number of the particle, more preferable to be 0.1% or less, and most preferable to be 0.01% or less. The matt particles with such particle size distribution can be obtained by classification after a conventional synthetic reaction. The more the number of classification or the stronger the intensity of the classification a matt agent with better distribution characteristics can be obtained.

It is preferable that the matt particle is present in the light scattering layer in amount of 10 to 1,000 mg/m², and more preferably 100 to 700 mg/m². The particle size distribution of the matt particles is measured by a Coulter counter method, and the measured distribution is recalculated into particle size distribution.

In addition to the matt particles, it is preferable that the light scattering layer contains inorganic filler selected among titan, zirconium, aluminum, indium, zinc, tin, and antimony, in the average diameter of 0.2 μm or less, preferably 0.1 μm or less, and more preferably 0.6 μm or less in order to have high refraction index.

On the other hand, In the case of attempting to make the difference of refraction index of the matt particle great, a silicon oxide can be used for the light scattering layer employing matt particles with high refraction index in order to keep the refraction index of the layer low. Preferable diameter is same as the inorganic filler.

Specific, examples of the inorganic filler employed for the light scattering layer include TiO₂, ZrO₂, Al₂O₃, In₂O₃, ZnO, SnO₂, Sb₂O₃, ITO, SiO₂ and the like. TiO₂ and ZrO₂ are especially preferable in view of high refraction index. It is preferable to performing silane coupling treatment or titan coupling treatment on the surface of the inorganic filler. For this purpose, a surface treatment agent with a functional group capable to react with a binder on the surface of the filler can be preferably used.

The preferable amount of the inorganic filler is 10 to 90% based on the total weight of the light scattering layer, more preferably 20 to 80%, and most preferably 30 to 75%.

Such filler has a diameter sufficiently smaller than the wavelength of light, thus not causing scattering. Also, a disperse in which the fillers are dispersed in a binder polymer moves a uniform material.

The refraction index of a mixture bulk of the binder of the light scattering layer and the inorganic filler is preferably 1.50 to 2.00, and more preferably 1.51 to 1.80. The refraction index can be within such range by properly selecting the binder and the inorganic filler. How to select those is experimentally well known.

The coating composition for forming the light scattering layer can further contain a fluoride surfactant, a silicon surfactant or both of them in order to prevent coating unevenness, drying unevenness, unevenness defects and the like and secure surface uniformity. Especially, a fluoride surfactant is more preferable in that it can effectively prevent coating unevenness, drying unevenness, unevenness defects on the anti-reflective layer in a relatively small amount. High surface uniformity can make high speed coating process possible, thus improving the process productivity.

(AR Film)

Hereinafter, an anti-reflective film (AR film), formed of subsequently laminated medium refraction index layer, high refraction index layer and low refraction index layer on the protective film will be described.

The anti-reflective film having at least medium refraction index layer, high refraction index layer and low refraction index layer (the most outer layer) subsequently laminated on the protective film meets the following refraction index condition:

The refraction index of the high refraction index layer>the refraction index of the medium refraction index layer>the refraction index of the protective film>the refraction index of the low refraction index layer

In addition, a hard coat layer can be disposed between the protective film and the medium refraction index layer. Also, it can be formed of a medium refraction index hard coat layer, high refraction index layer and low refraction index layer, for example, such as an anti-reflective film disclosed in JP-A Nos. 8-122504, 8-110401, 10-30090, 2002-243906, 2000-111706 and the like. It is also possible to additionally give each layer another function, for example, an anti-contaminative low refraction index layer and anti-electrostatic high refraction index layer (for example, JP-A Nos. 10-206603, and 2002-243906).

The anti-reflective film is preferable to have haze in amount of 5% or less, and more preferably 3% or less. The surface hardness of the film is preferable to be H or higher, more preferably 2H or higher, and most preferably 3H or higher, when measured by pencil hardness test according to JIS K-5400.

(High Refraction Index Layer and Medium Refraction Index Layer)

The high refraction index layer of the anti-reflective film is a hard layer containing at least of high refractive inorganic micro-particles whose average diameter is 100 nm or less and a matrix binder.

For the high refractive inorganic micro-particle, there are an inorganic compound whose refraction index is 1.65 or higher, and more preferably 1.9 or higher. For example, there are oxide of Ti, Zn, Sb, Sn, Zr, Ce, Ta, La, In, etc. and a complex oxide containing its metal atom.

For such micro-particle, there are one whose surface is subject to surface treatment using a surface treatment agent (for example, silane coupling agent: JP-A Nos. 11-295503, 11-153703, and 2000-9908, anion compound or an organic metal coupling agent: JP-A No. 2001-310432, etc.), and one with a core-shell structure in which high refraction index particles forms the core region (JP-A No. 2001-166104), one which is used together with a specific dispersing agent (for example, JP-A No. 11-153703, U.S. Pat. No. 6,210,858, JP-A No. 2002-277609, etc.).

For material forming of the matrix, there are a conventional thermal plastic resin, a hard resin surface film and the like.

Preferably, there are a composition containing a poly-functional compound with at least 2 of polymerizing group selected among a radical polymerization group, a cation polymerizing group, and both of them; a composition containing an organic metal compound with a hydrolysable group; a composition containing a partial condensate; and its combination composition, as disclosed in, for example, JP-A Nos. 2000-47004, 2001-315242, 2001-31871, 2001-296401, etc.

A colloidal-metal oxide obtained from the hydrolysis condensate of a metal alkoxide, and a hard film obtained from a metal alkoxide are also preferable, as disclosed in, for example, JP-A No. 2001-293818.

The refraction index of the high refraction index layer is preferable to be 1.70 to 2.20. The thickness of the high refraction index layer is preferable to be 5 nm to 10 μm, and more preferably 10 nm to 1 μm.

The refraction index of the medium refraction index layer is adjusted to be between the refraction index of the high refraction index layer and the refraction index of the low refraction index layer. The refraction index of the medium refraction index layer is preferable to be 1.50 to 1.70. Its thickness is preferable to be 5 nm to 10 μm, and more preferably 10 nm to 1 μm.

(Low Refraction Index Layer)

The low refraction index layer is subsequently laminated on the high refraction index layer. The refraction index of the low refraction index layer is preferably 1.20 to 1.55, and more preferably 1.30 to 1.50.

The low refraction index layer is preferable to form the most outer layer with the anti-scratch characteristics and anti-contamination characteristics. In order to improve the anti-scratch characteristics, it is effective to give lubricous Characteristics on its surface, and a thin layer conventionally formed by introducing silicon, fluoride and the like can be employed.

For the fluoride containing compound, a compound containing a cross-linking functional group or a polymerizing functional group which contains fluoride atom in amount of 35 to 80 weight % is preferable, for example, a compound disclosed in [0018] to [0026] of JP-A No. 9-222503, [0019] to [0030] of JP-A No. 11-38202, [0027] to [0028] of JP-A No. 2001-40284, JP-A No. 2000-284102 and the like.

The refraction index of the fluoride containing compound is preferable to be 1.35 to 1.50, and more preferably 1.36 to 1.47.

The silicon compound is preferable to have a poly-siloxane structure and contain a hardening functional group or polymerizing functional group within its polymer chain, and preferable to form a cross-linking structure in the layer. For example, there are a reactive silicon (for example, “Silaprene” (Chiso Inc.)), polysiloxane with silanol groups at its both ends (JP-A No. 11-258403) and the like.

The polymerization of fluoride containing polymer, siloxane polymer or the combination thereof which has a cross-linking or polymerizing functional group is preferably performed by coating a coating composition for a most outer layer containing a polymerization initiator, a sensitizer and the like, and then irradiating light or heating the coating layer, thus forming the low refraction index layer.

A sol/gel hardening layer is also preferable which is obtained by hardening an organic metal compound such as a silane coupling agent and a silane coupling agent containing a specific fluoride containing hydrocarbon group in the presence of a catalyst through condensation reaction.

For example, there are polyfluoroalkyl group containing compound or its partial hydrolysis condensate (JP-A Nos. 58-142958, 58-147483, 58-147484, 9-157582, and 11-106704), a silyl compound containing a fluoride containing long chain group, i.e., poly(perfluoroalkylether) functional group (JP-A Nos. 2000-117902, 2001-48590, and 2002-53804) and the like.

Besides the above-mentioned compounds, the low refraction, index layer can further contain a filler {for example, a low refractive inorganic compound whose primary average diameter is 1 to 150 nm such as silane dioxide (silica), fluoride containing particle (fluomagesium, fluorocalcium, fluorobarium), an organic micro-particle disclosed in [0020] to [0038] of JP-A No. 11-3820 and the like}, a silane coupling agent, a lubricant, a surfactant, etc.

In case that the low refraction index layer is disposed below the most outer layer, it is preferable that the low refraction index layer is formed by a vapor phase method (vacuum deposition method, a sputtering method, an ion-plating method, a plasma CVD method, etc.) A coating method is advantageous in view of lowing production cost.

The thickness of the low refraction index; layer is preferable to be 30 to 200 nm, more preferably 50 to 150 nm, and the most preferably 60 to 120 nm.

### (Hard Coat Layer)

The hard coat layer is formed on the protective film in order to give the protective film employing the anti-reflective film physical hardness. Especially, it is preferable to be formed between the protective film and the high refraction index layer. The hard coat layer is preferable to be formed by cross-linking reaction or polymerization of a photo and/or thermal hardening compound. The hardening functional group of the hardening compound is preferable to be a photo-polymerizable functional group. An organic metal compound containing a hydrolysable functional group or an organic alkoxysilyl compound is also preferable.

A specific example of these compounds can be as same as exemplified for the high refraction index layer. A specific composition of the hard coat layer is disclosed in, for example, JP-A Nos. 2002-144913, and 2000-9908, WO 00/46617 pamphlet, etc.

The high refraction index layer can function as a hard coat layer at the same time. In that case, it is preferable to uniformly disperse micro-particles into the hard coat layer using the same method as mentioned in the high refractive index layer.

The hard coat layer is preferable to contain particles in average diameter of 0.2 to 10 μm so as to perform anti-glaring function, thus functioning as an anti-glaring layer at the same time.

The thickness of the hard coat layer can be set variously according to its use, and is preferable to be 0.2 to 10 μm, and more preferably 0.5 to 7 μm.

The surface hardness of the hard coat layer is preferable to be H or higher, more preferably 2H or higher, and the most preferably 3H or higher, when it is measured by JIS K-5400 pencil hardness test. In JIS K-5400 test, the smaller the friction of samples before and after the test, the better.

(Layers Other than the Anti-Reflective Layer)

Additionally, a fore scattering layer, a primer layer, an anti-electrostatic layer, a lower coat layer, a protective layer and the like can be formed.

(Anti-Electrostatic Layer)

In case the an anti-electrostatic layer is formed, it is preferable to give conductivity whose volume resistance is 10⁻⁸ (Ω/cm³) or less. Even though it is possible to give volume resistance as much as 10⁻⁸ (Ω/cm³) using a hygroscopic substance, a water-soluble inorganic salt, or a surfactant thereof, a cation polymer, an anion polymer, a colloidal silica, etc. However, in this case, there is a problem that hygroscopic value is high and it is hard to secure sufficient conductivity in a low hygroscopic condition. In this regard, a metal oxide is preferable as a conductive layer. It is not desirable to use a color metal oxide for the conductive layer since it makes the entire film dyed. For a metal forming non-colored metal oxide, there are Zn, Ti, Sn, Al, In, Si, Mg, Ba, Mo, W or V, and thus it is preferable to use a metal oxide employing these metals as their main component.

Specific examples of such metal oxide include ZnO, TiO₂, SnO₂, Al₂O₃, In₂O₃, SiO₂, MgO, BaO, MoO₃, WO₃, V₂O₅ and its complex oxide, and more preferably ZnO, TiO₂ and SnO₂. For an example containing different atoms, there are ZnO added with Al, In, etc., SnO₂ added with Sb, Nb, halogen atom, etc., and TiO₂ added with Nb, Ta, etc.

As disclosed in JP-A No. 59-6235, it is also preferable to use material obtained by attaching the above-mentioned metal oxide to another metal crystal particle or fiber (for example, titan oxide). Considering volume resistance, surface resistance and other properties, it is not reasonable to simply compare them, but the anti-electrostatic layer is preferable to have surface resistance as much as 10⁻¹⁰ (Ω/cm³) or less, more preferably 10⁻⁸ (Ω/cm³) in order to ensure the conductivity which makes volume resistance 10⁻⁸ (Ω/cm³) or less. The surface resistance of the anti-electrostatic layer should be measured under the condition that the anti-electrostatic layer becomes the most outer surface, and can be measured in the course of forming the multilayer film.

(Liquid Crystal Display)

The above-mentioned cellulose acylate film or a polarizing plated obtained by attaching the cellulose acylate film and a polarizing layer is used for a liquid crystal display, especially a transmission type of liquid crystal display. A transmission type of liquid crystal display is formed of a liquid crystal cell and 2 layers of polarizing plates disposed on the both side of the liquid crystal cell. The polarizing plate is formed of a polarizer and 2 transparent protective films disposed on the both sides thereof. A liquid crystal cell contains liquid crystal cell between 2 electrode substrates.

The polarizing plate according to the present invention can be disposed oh one side of the liquid crystal cell or on the both sides thereof. The liquid crystal cell is preferable to be VA mode, OCB mode, IPS mode or TN mode.

In the case of the liquid crystal cell of VA mode, stick shaped liquid crystal molecules orient in the substantially perpendicular direction at the time when voltage is not input. VA mode liquid crystal cell includes (1) VA mode liquid crystal cell in a narrow meaning, where stick shaped liquid crystal molecules orient in the substantially perpendicular direction at the time when voltage is not applied, and orient in the substantially parallel direction when voltage is applied (JP-A No. 2-176625), (2) a (MVA mode) liquid crystal cell obtained by making the VA mode multi-domain aligned in order to enlarge the angle of vision (SED97, Digest of tech papers (draft) 28(1997)845), (3) (n-ASM mode) liquid crystal cell where stick shaped liquid crystal molecules orient in the substantially parallel direction at the time when voltage is not applied, and multi-domain aligned when voltage is applied (Draft of Japan Liquid Crystal Discussion Conference, 58 to 59 (1998)), and (4) SURVIVAL mode of liquid crystal cell (LCD international 98).

In the case of VA mode liquid crystal cell, if just one the polarizing plate according to the present invention is employed, it is preferable to be used on the backlight side.

The OCB mode liquid crystal cell is a bend alignment mode liquid crystal cell where stick shaped liquid crystal molecules are (symmetrically) aligned in the reverse direction on the upper side and lower side of the liquid crystal cell. A liquid crystal display using the bend alignment mode liquid crystal cell is disclosed in U.S. Pat. No. 4,583,825, and U.S. Pat. No. 5,410,422. The bend alignment mode liquid crystal cell has self-optical compensation function since the stick shaped liquid Crystal molecules are symmetrically aligned on the upper and lower sides of the liquid crystal cell. Thus, this liquid crystal mode is called as OCB (Optically Compensatory Bend) liquid crystal mode. A bend alignment mode liquid crystal display is advantageous in high response speed.

In the case of TN mode liquid crystal cell, stick shaped liquid crystal molecules are aligned in the substantially parallel direction, i.e. in 60 to 120 degrees when no voltage is applied. TN mode liquid crystal cell is widely employed for a color TFT liquid crystal display these days, and disclosed in many documents.

### EXAMPLES

Hereinafter, the Examples according to the present invention and Comparative Examples will be described, but the present invention is not limited thereto.

### Examples 1 to 4, Comparative Examples 1 to 2, and Examples 1′ to 4′

### Preparation of a Cellulose Acylate Film

(1) Cellulose Acylate

A cellulose is added by sulfur as a catalyst, and added by carboxylic anhydride serving as a source of acyl functional group to cause acylization reaction. Then, neutralization and can aging are performed. Here, various cellulose acylates which are different in the type of acyl group, the substitution degree, high specific density, polymerization degree, etc. can be obtained by differentiating the amount of catalyst, the type of carboxylic anhydride, the amount thereof, the amount of the neutralizing agent, the amount of water added, reaction temperature, aging temperature, etc. In addition, the cellulose acylate with low molecular weight was removed using acetone.

Using as prepared cellulose acylate, and cellulose acylate whose acetyl group substitution degree is 2.79 and DS6/(DS2+D3+DS6)= 0.322, the following dope was prepared.

(2) Dope Preparation

<1-1> Cellulose Acylate Solution

The following composition was put into a mixing tank, subject to stirring to be solved, then heated at 90° C. for about 10 min and filtered using a paper filter whose average pore diameter is 34 μm and a sintered metal filter whose average pore diameter is 10 μm.

Cellulose acylate solution

| | | |
|---|---|---|
| Cellulose acylate | 100.0 | parts by weight |
| Triphenyl phosphate | 8.0 | parts by weight |
| Biphenyldiphenyl phosphate | 4.0 | parts by weight |
| Methylene chloride | 403.0 | parts by weight |
| Methanol | 60.2 | parts by weight |

<1-2> Matt Disperse Solution

The following composition containing as prepared cellulose acylate solution was input into a disperse machine, to obtain a matt disperse solution.

Matt disperse solution

| | | |
|---|---|---|
| Silica particle with 16 nm average pore diameter | 2.0 | parts by weight |
| (aerosol R972, Japan Aerosol Inc.) | | |
| Methylene chloride | 72.4 | parts by weight |
| Methanol | 10.8 | parts by weight |
| Cellulose acylate solution | 10.3 | parts by weight |

<1-3> Retardation Solution Preparation

The following composition including as prepared cellulose acylate solution was input into a mixer, heated with stirring to obtain a retardation developing agent solution A.

retardation increasing agent solution

| | | |
|---|---|---|
| retardation increasing agent A | 20.0 | parts by weight |
| Methylene chloride | 58.3 | parts by weight |
| Methanol | 8.7 | parts by weight |
| Cellulose acylate solution | 12.8 | parts by weight |

A retardation increasing agent solution containing 100 parts by weight of as prepared cellulose acylate solution, 1.35 parts by weight of matt agent disperse solution, and a retardation increasing agent A in such amount as to be 5.1 parts by weight in the retardation increasing agent solution were mixed to obtain a dope for forming a film.

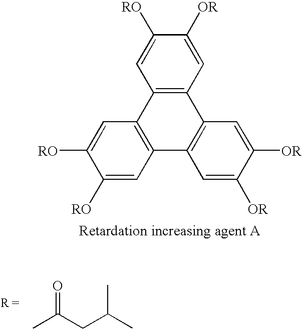

### (Flow Casting)

As prepared dope was subject to flow casting using a glass plate casting device. It was subject to dry using warm air at 70° C. for 6 min, then the film was separated from the glass plate and fixed to a support and dried using warm air at 100° C. for 10 min, and then warm air at 140° C. for 20 min to obtain a cellulose acylate film having a thickness of 108 μm. The glass transition temperature of the cellulose acylate film was 140° C.

As prepared film was subject to stretching process and shrinking, process under such conditions shown in the following Table 1 with supported using a biaxial stretching device (Toyo seiki Inc.). As a common condition, pre-heat was performed on each row by providing air at a temperature for 3 min prior to stretching, and it was checked that the surface temperature of the film was within inlet air ±1° C. when measured using a non-contact infrared ray thermometer. After stretching, it was subject to air quenching for 5 min with supported by a crimp. In the Table, MD indicates flow casting direction (corresponding to the film conveying direction) during the glass plate flow casting process, and TD indicates the film width direction perpendicular to MD direction.

<Re, Rth of the Film at 450, 550, and 650 nm Wave Length>

Re, Rth of the film at 450, 550, and 650 nm wave length were measured according to the aforementioned method using KOBRA 21ADH (Prince measuring machine Inc.). The result was presented on Table 1. According to Table 1, Re, Rth of the cellulose acylate film prepared according to the present, invention at 450, 550 and 650 nm wave length meet the formula (I) to (III).

In the case of Example 3′ and 4′, since wrinkle presented on the film after the stretching and shrinking process, package evaluation were not possible thereafter.

<Humidity Dependency of Re, Rth>

As prepared cellulose acylate film was exposed to 25° C. 10% RH, 20° C. 60% RH over 2 hours, and Re and Rth were measured under that condition. The changes in retardation Re and Rth from 60% RH to 10% RH were ΔRe(550)=|Rₑ(550)10% RH−Rₑ(550)60% RH| and ΔRth(550)=|(Rₜₕ(550)10% RH−Rₜₕ(550)60% RH|, respectively.

The measuring result was evaluated according to the following standard.

A ΔRe(550) is less than 10 nm

B ΔRe(550) is 10 nm or more

A ΔRth(550) is less than 10 nm

B ΔRth(550) is 10 nm or more

Table 1 just shows the measurement result of ΔRth(550).

As shown in Table 1, comparing with the cellulose acylate film of the Comparative Example, the cellulose acylate film prepared according to the present invention shows low ΔRth(550) and Rth humidity dependency decreases.

<Polarizing Plate Preparation>

Iodine was adsorbed to the stretched polyvinyl alcohol film to obtain a polarizing layer.

For the Examples 1 to 4, Comparative Examples 1 to 2, Examples 1′ to 2′ and reference Example, as prepared cellulose acylate film was attached to one side of the polarizing plate using a polyvinyl alcohol adhesive. Canning process was performed under the following conditions. 1.5 mol/l sodium hydroxide solution was prepared and kept at 55° C. 0.01 mol/l nitric acid dilute was prepared and kept at 35° C. As prepared cellulose acylate film, was dipped into the sodium hydroxide solution for 2 min, and then washed using water to remove the sodium hydroxide solution. Then, it was dipped into the nitric acid dilute for 1 min, and washed using water to remove the nitric acid dilute. At last, the sample was dried at 120° C. for 10 min.

A commercially available cellulose acylate film (TAC TD80UD, Fuji photo film Inc.) was subject to a canning process, attached to the opposite side of a polarizer using polyvinyl alcohol adhesive, and then dried at 70° C. for 16 min.

The permeation axis of the polarizing layer and the slow axis of as prepared cellulose acylate film were aligned so as to be parallel to each other. The permeation axis of the polarizing layer and the slow axis of the commercially available cellulose acylate film were aligned so as to be parallel to each other.

<Preparation of Liquid Crystal Cell>

A liquid crystal cell was prepared by keeping the cell gap between substrates 3.6 μm, dropping liquid crystal material (“MLC6608”, Merck Ltd.) with a negative anisotropic dielectric constant between the substrates, and sealing it. The retardation of the liquid crystal layer (i.e., multiplication Δn·d of the thickness of the liquid crystal layer d (μm) and anisotropic refraction index Δn) was 300 nm. The liquid crystal material was aligned hi the vertical direction.

<Seal into VA Panel>

A commercially available super highxontrast product (SanRitz Corp., HLC2-5618) was used for the upper polarizing plate of a liquid crystal display employing as vertically aligned liquid crystal cell (viewer side). A lower polarizing plate (back light side) employing the cellulose acylate film prepared in the Examples 1 to 4, Comparative Examples 1 to 2, Examples 1′ to 2′, and reference Example was disposed such that the cellulose acylate film is located on the liquid crystal side. The upper and lower polarizing plates are attached to the liquid crystal cell by an adhesive. They are crossly disposed so that the transmission axis of the upper polarizing plate is aligned in up-down direction and the lower polarizing plate is aligned in right-left direction.

55 Hz pulse wave voltage was applied to the liquid crystal cell. Normally black mode was employed where white display is 5 V and black display is 0 V. Black display penetration ratio (%) of the black display with viewing angle of an azimuth angle of 45° and a polar angle 60°, and color shift (Δx) between the azimuth angle of 45° and the polar angle of 60°, and the azimuth angle of 180° and the polar angle of 60° were measured. The result is shown in Table 1. Contrast ratio was set to the transmittance ratio (white/black), the viewing angle (the region with no grey level inversion at 10 or more contrast ratio) was measured from the black display (L1) to white display (L8) through 8 steps using a measuring device (EZ-Contrast 160D, ELDIM Inc.) The result is shown in Table 1. After examination, the liquid crystal displays of the Examples 1 to 2 showed natural black, in both front direction and viewing direction. The packaging type of the Examples 3 to 4 showed deteriorated viewing angle characteristic while the packaging type of the Examples 3 to 4 showed good viewing angle characteristic as same as the Examples 9 to 10. In the case of the Examples 1′ to 2′, the optical characteristics were not within a desirable range. In the case of the Examples 3′ to 4′, wrinkle was left. None of the Examples 1′ to 4′ meet the formula (Z), but the Examples 1 to 4 which meet the formula (Z) showed good, characteristic.

Viewing angle (the region with no grey level inversion at 10 or more contrast ratio)

A Polar angle is 80° or more in upper, lower, right and left directions.

B Polar angle is 80° or more in 3 directions among upper, lower, right and left directions.

C Polar angle is 80° or more in 2 directions among upper, lower, right and left directions.

D Polar angle is 80° or more in 0 to 1 direction among upper, lower, right and left directions.

### Color Shift (Δx)

A Less than 0.02

B 0.02 to 0.04

C 0.04 to 0.06

D 0.06 or more

TABLE 1

| | Air | Stretching | Shrink | | | | | | | | | | |
|---|---|---|---|---|---|---|---|---|---|---|---|---|---|
| | Temp. | direction/ | direction/ | Wrinkle | Re | Rth | Formula | Formula | Formula | Formula | ΔRth | Viewing | Color |
| | (° C.) | stretching ratio | shrink ratio | on film | (nm) | (nm) | (I)*1 | (I)*2 | (II) | (III) | (550) | angle | shift |
| Ex. 1 | 160 | TD/20% | MD/13% | A | 45 | 160 | 0.85 | 1.10 | 0.90 | 1.05 | A | B | B |
| Ex. 2 | 180 | TD/35% | MD/30% | A | 69 | 190 | 0.70 | 1.25 | 0.80 | 1.20 | A | A | A |
| Ex. 3 | 180 | TD/30% | MD/15% | A | 52 | 115 | 0.60 | 1.60 | 0.67 | 1.40 | A | D | B |
| Ex. 4 | 180 | TD/20% | MD/25% | A | 55 | 121 | 0.61 | 1.62 | 0.66 | 1.38 | A | D | B |
| Comp. | 160 | TD/15% | MD/fixed | A | 18 | 90 | 1.00 | 1.00 | 1.05 | 0.95 | B | D | D |
| Ex. 1 | | | width | | | | | | | | | | |
| Comp. | 180 | TD/35% | MD/fixed | A | 55 | 185 | 1.00 | 1.00 | 1.05 | 0.95 | B | A | D |
| Ex. 2 | | | width | | | | | | | | | | |
| Ex. 1′ | 160 | TD/15% | MD/7% | A | 23 | 109 | 0.94 | 1.06 | 0.94 | 1.04 | B | D | C |
| Ex. 2′ | 170 | TD/35% | MD/10% | A | 53 | 116 | 0.93 | 1.07 | 0.93 | 1.05 | B | D | C |
| Ex. 3′ | 180 | TD/10% | MD/20% | B | 45 | 160 | 0.85 | 1.10 | 0.90 | 1.05 | A | B | B |
| Ex. 4′ | 180 | TD/20% | MD/40% | B | 69 | 190 | 0.70 | 1.25 | 0.80 | 1.20 | A | A | A |
| Ref | 180 | TD/20% | MD/free | A | 51 | 160 | 0.70 | 1.20 | 0.70 | 1.20 | A | B | B |
| Ex. | | | width | | | | | | | | | | |

Re and Rth mean Re(550) and Rth(550), respectively. The formula (I)*1 is {(Re(450)/Rth(450))/(Re(550)/Rth(550))} and the formula (I)*2 is {(Re(650)/Rth(650))/(Re(550)/Rth(550))}.

“A” in the column “Wrinkle on film” of the table 1 means that wrinkle on the surface of the film was not observed, and “B” in the column means that wrinkle on the surface of the film was observed.

Cellulose acylate film was prepared as same method as the Example 2 except adjusting the relation of the substitution degree DS2 of the hydroxyl group at the 2-position of the glucose unit of the cellulose acylate by the acyl group, the substitution degree DS3 of the hydroxyl group at the 3-position by the acyl group, and the substitution degree DS6 f the hydroxyl group at the 6-position by the acyl group as shown in Table 2. It was processed into a polarizing plate and packaged in VA panel, to be evaluated. The result is shown in Table 2. In the case of die Example 5, neutral black display was shown in both front direction and viewing direction. In the case of the Examples 6 to 8, color shift was small and neutral black display was shown, but either humidity dependency or viewing angle is inferior compared with the Example 5. This result shows that the substitution degree of hydroxyl groups of glucose unit in the cellulose acylate by acyl group, (DS2+DS3+DS6) and DS6/(DS2+DS3+DS6) are important for improving characteristics.

TABLE 2

| | DS2 + DS3 + | DS6/ | Re | Rth | Formula | Formula | Formula | Formula | ΔRth | ΔRe | Viewing | Color |
|---|---|---|---|---|---|---|---|---|---|---|---|---|
| | DS6 | (DS2 + DS3 + DS6) | (nm) | (nm) | (I)*1 | (I)*2 | (II) | (III) | (550) | (550) | angle | shift |
| Ex. 5 | 2.5 | 0.340 | 57 | 180 | 0.85 | 1.15 | 0.85 | 1.1 | A | A | B | A |
| Ex. 6 | 1.9 | 0.330 | 40 | 170 | 0.95 | 1.2 | 0.85 | 1.0 | A | B | C | B |
| Ex. 7 | 2.75 | 0.280 | 35 | 150 | 0.7 | 1.1 | 1.0 | 1.1 | A | A | D | B |
| Ex. 8 | 1.8 | 0.300 | 21 | 130 | 1.0 | 1.2 | 0.8 | 1.2 | A | B | D | B |

Re and Rth mean Re(550) and Rth(550), respectively. The formula (I)*1 represents {(Re(450)/Rth(450))/(Re(550)/Rth(550))} and the formula (I)*2 represents {(Re(650)/Rth(650))/(Re(550)/Rth(550))}.

### Examples 9 to 14, Comparative Example 3, Examples 5′ to 6

### <Package in VA Panel>

A polarizing plate employing the cellulose acylate film prepared in the Examples 3 to 8, Comparative Example 1, and Examples 1′ to 2′ was attached on the both upper polarizing plate (viewer side) and lower polarizing plate (back light side) of a liquid crystal display employing the vertically aligned liquid crystal cell such that the cellulose acylate film is located on the liquid crystal side. They are crossly disposed so that the transmission axis of the upper polarizing plate is aligned in up-down direction and the lower polarizing plate is aligned in right-left direction.

55 Hz pulse wave voltage was applied to the liquid crystal cell. Normally black mode was employed where white display is 5 V and black display is 0 V. Black display transmittance ratio (%) of the black display with viewing angle of an azimuth of 45° and a polar angle of 60°, and color shift (Δx) between the azimuth angle of 45° and the polar angle 60°, and the azimuth angle of 180° and the polar angle of 60° were measured. The result is shown in Table 3. Contrast ratio was set to the transmittance ratio (white/black), the viewing angle (the region with no grey level inversion at 10 or more contrast ratio) was measured from the black display (L1) to white display (L8) through 8 steps using a measuring device (EZ-Contrast 160D, ELDIM Inc.) The result is shown in Table 3. After examination, the Examples 9, 10 and 13 showed natural black in both front direction and viewing direction.

Viewing angle (the region with no grey level inversion at 10 or more contrast ratio)

A Polar angle is 80° or more in upper, lower, right and left directions.

B Polar angle is 80° or more in 3 directions among upper, lower, right and left directions.

C Polar angle is 80° or more in 2 directions among upper, lower, right and left directions.

D Polar angle is 80° or more in 0 to 1 directions among upper, lower, right and left directions.

Color shift (Δx)

A Less than 0.02

B 0.02 to 0.04

C 0.04 to 0.06

D 0.06 or more

TABLE 3

| | DS2 + DS3 + | DS6/ | Re | Rth | Formula | Formula | Formula | Formula | ΔRth | ΔRe | Viewing | Color |
|---|---|---|---|---|---|---|---|---|---|---|---|---|
| | DS6 | (DS2 + DS3 + DS6) | (mm) | (nm) | (I)*1 | (I)*2 | (II) | (III) | (550) | (550) | angle | shift |
| Ex. 9 | 2.79 | 0.322 | 52 | 115 | 0.60 | 1.60 | 0.67 | 1.40 | A | A | A | A |
| Ex. 10 | 2.79 | 0.322 | 55 | 121 | 0.61 | 1.62 | 0.66 | 1.38 | A | A | A | A |
| Comp. | 2.79 | 0.322 | 18 | 90 | 1.00 | 1.00 | 1.05 | 0.95 | A | A | B | D |
| Ex. 3 | | | | | | | | | | | | |
| Ex. 5′ | 2.79 | 0.322 | 23 | 109 | 0.99 | 1.00 | 1.05 | 0.95 | A | A | A | D |
| Ex. 6′ | 2.79 | 0.322 | 53 | 116 | 0.97 | 1.00 | 1.05 | 0.95 | A | A | A | D |
| Ex. 11 | 2.5 | 0.340 | 57 | 180 | 0.85 | 1.15 | 0.85 | 1.1 | A | A | D | A |
| Ex. 12 | 1.9 | 0.330 | 40 | 170 | 0.95 | 1.2 | 0.85 | 1.0 | A | B | C | B |
| Ex. 13 | 2.75 | 0.280 | 35 | 150 | 0.7 | 1.1 | 1.0 | 1.1 | A | A | A | A |
| Ex. 14 | 1.8 | 0.300 | 21 | 130 | 1.0 | 1.2 | 0.8 | 1.2 | A | B | C | B |

### Example 15

### Package Evaluation in OCB Panel

(Alkali Treatment)

The cellulose acylate film prepared in the Example 1 is coated with 10 cc/m² of 1.0N potassium hydroxide solution (solvent: water/isopropyl alcohol/propylene glycol=69.2 parts by weight: 15 parts by weight: 15.8 parts by weight), laid at 40° C. for 30 seconds. Then, the alkali solution is washed out using ionized water and the water spot is removed using an air knife. Then, the film is dried at 100° C. for 15 seconds. The contact angle of the surface subject to alkali treatment against the ionized water is 42°.

<Preparation of Alignment Layer>

The following coating solution for forming an alignment layer is coated on the surface subject to alkali treatment in the thickness of 28 ml/m². The surface was dried with warm air at 60° C. for 60 seconds and then with warm air at 90° C. for 150 seconds to form an alignment layer.

alignment layer coating composition

| | | |
|---|---|---|
| Modified polyvinyl alcohol below | 10 | parts by weight |
| Water | 371 | parts by weight |
| Methanol | 119 | parts by weight |
| Glutaraldehyde (cross-linking agent) | 0.5 | parts by weight |
| Citric acid ester (AS3, Sankyo chemical Inc.) | 0.35 | parts by weight |

Modified polyvinyl alcohol

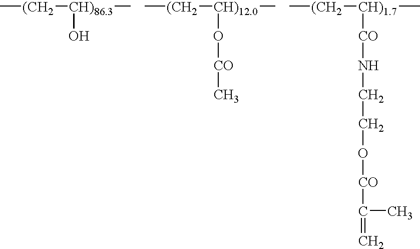

(Rubbing Treatment)

A transparent substrate employing an alignment layer is transferred at the speed of 20 m/min, and then the surface of the alignment layer on the transparent substrate is subject to rubbing treatment by rotating the rubbing roll (300 mm diameter) at a speed of 650 rpm which is disposed so that the rubbing treatment can be performed in the 45° direction against the longitude. The contact length between the rubbing roll and the transparent substrate is 18 mm.

(Formation of an Additional Optically Anisotropic Layer)

41.02 Kg of the disc type of liquid crystal compound used in the Example 1, 4.06 Kg of ethylenepxide-metamorphic-trimethylolpropane triacrylate (V#360, Osaka organic chemical Inc.), 0.35 kg of cellulose acetate butyrate (CAB531-1, Eastman Chemical Inc.), 1.35 kg of photo polymerizing initiator (Irgacure-907, Ciba-Geigy Corp.), 0.45 kg of a sensitizer (KAYACURE DETX, Nippon Kayaku Co., Ltd.) are dissolved into 102 kg of methylethylketone. 0.1 kg of a copolymer containing a fluorohydrocarbon group (MEGAFAC F780, Dainippon ink and Chemicals, Inc.) is added to the solution to prepare a coating composition. The coating composition is coated on the alignment layer on the transparent substrate transferred at the speed of 20 m/min by rotating #3.2 wire bar at the speed of 391 cycles in the same direction as the moving direction of the film.

The film is continuously heated from room temperature up to 100° C. to remove the solvent, and then heated in a dry zone at 130° C. for 90 seconds under the condition that the wind speed on the surface of the disc shaped optically anisotropic layer is 2.5 m/sec, thus aligning the disc shaped liquid crystal compound. Then, the film is transferred to a dry zone at 80° C. and then is subject to irradiation by ultraviolet ray with 600 W power for 4 seconds using a ultraviolet ray irradiation device (ultraviolet ray lamp: power 160 W/cm, irradiation length 1.6 m) under such condition that the surface temperature of the film is 100° C., thus causing the cross-linking reaction to fix the alignment of the disc shaped liquid crystal compound. Then, the film is cooled down to room temperature and taken up on a cylinder to make it in a roll type. In this result, the roll shaped optical compensation film (KH-3) is obtained.

The viscosity of the optically anisotropic layer measured when the surface temperature is at 127° C. is 695 cp. The result is obtained by measuring the viscosity of the liquid crystal layer with the same composition ratio as the optically anisotropic layer (except, solvent) using a heating E type viscometer.

A part of as prepared roll type optical compensation film KH-3 is sampled and its optical characteristic is measured. Re retardation of the optically anisotropic layer measured at wavelength 546 nm is 38 nm. The angle (slant) between the disc surface of the disc shaped liquid crystal compound in the optically anisotropic layer and the surface of the substrate continuously varies along the thickness direction of the layer and the average is 28°. In addition, the optically anisotropic layer is separated from the sample to measure the average direction of the molecular symmetrical axis of the optically anisotropic layer, and the result is 45° against the longitude direction of the optical compensation film.

(Preparation of Polarizing Plate)

Iodine was adsorbed to the elongated polyvinyl alcohol film to obtain a polarizing layer. As prepared film (KH-3) was attached to the one side of the polarizing layer using a polyvinyl alcohol adhesive. The penetration axis of the polarizing layer was disposed so as to be parallel to the slow axis of the phase shifter (KH-3).

A commercially available cellulose acylate film (TAC TD80UD, Fuji photo film Inc.) was subject to a canning process, attached to the opposite side of the polarizing plate using a polyvinyl alcohol adhesive, to finish a polarizing plate.

<Preparation of a Bend Aligned Liquid Crystal Cell>

A polyimide layer serving as an alignment layer was formed on a glass substrate employing ITO electrode, and the alignment layer was subject to rubbing treatment. 2 glass substrates, as prepared were combined so that the rubbing directions were parallel with keeping a cell gap of 14.7 μm. A liquid crystal compound whose Δn is 0.1396 (ZLI1132, Merck Ltd.) was injected into the gap to obtain a bend aligned, liquid crystal cell. 2 polarizing plates were attached thereto so that as prepared bend aligned cell was narrowed. The optically anisotropic layer of the polarizing plate was disposed on the cell substrate so that the rubbing direction of the liquid crystal cell and the rubbing direction of another optically anisotropic layer facing against thereto were not parallel.

55 Hz pulse wave voltage was applied to the liquid crystal cell. Normally white mode was employed where white display is 2 V and black display is 5 V. A voltage at which the penetration ratio at the front is least, i.e., black voltage, was applied to examine the liquid crystal display as prepared. After examination, it showed natural black display in both front direction and viewing direction.

### Examples 16 to 17 and Comparative Examples 4 to 5

In addition to as prepared cellulose acylate, using a cellulose acylate whose acetyl group substitution degree is 2.00, the propionyl group substitution degree is 0.60, and the viscosity average polymerization degree is 350, 100 parts by weight of cellulose acylate, 5 parts by weight of ethylphthalylethylglycolate, 3 parts by weight of triphenyl phosphate, 290 parts by weight of sodium methylene, and 60 parts by weight of ethanol were put into a sealed container and heated up to 80° C. during 60 min with keeping stirred. The pressure in the container was kept at 1.5 atm. As obtained dope was filter using an Azumi paper filter No. 244 (Azumi paper filter Inc.) and then left to stand for 24 hours to remove bubble in the dope.

In addition, an ultraviolet absorbing agent solution was prepared by mixing and stirring 5 parts by weight of as prepared cellulose acylate, 5 parts by weight of TINUVIN 109 (Ciba Specialty Chemicals Inc.), 15 parts by weight of TINUVIN 326 (Ciba Specialty Chemicals Inc.), 0.5 parts by weight of AEROSIL R972V (Japan Aerosol Inc.), 94 parts by weight of sodium methylene, and 8 parts by weight of ethanol. R972V was added by dispersing in the ethanol in advance.

100 parts by weight of as prepared dope and 6 parts by weight of as prepared ultraviolet absorbing agent solution were sufficiently mixed using a static mixer.

(Flow Casting)

As prepared dope was subject to flow casting in the same way as the Example 1 to form a cellulose acylate film as thick as 108 μm. The glass transition temperature of the cellulose acylate film was 140° C. This film was subject to stretching and shrinking process under the conditions shown in Table 4 in the same way as described in (Flow casting) using 2 axis stretching device with its 4 sides held.

Using the film after stretching and shrinking, <Re, Rth of the film at wave length 450, 550, 650> and <preparation of a polarizing plate> were performed in the same method described in Example 1. Then, <preparation of a liquid crystal cell> and <packaging in VA panel> were performed in the same way as described in the Example 1 and Example 9, respectively. The result is shown in Table 4.

TABLE 4

| | Air | Stretching | Shrink | | | | | | | | |
|---|---|---|---|---|---|---|---|---|---|---|---|
| | Temp. | direction/ | direction/ | Re | Rth | Formula | Formula | Formula | Formula | Viewing | Color |
| | (° C.) | stretching ratio | shrink ratio | (nm) | (nm) | (I)*1 | (I)*2 | (II) | (III) | angle | shift |
| Ex. 16 | 160 | TD/20% | MD/10% | 45 | 127 | 0.9 | 1.10 | 0.9 | 1.15 | A | A |
| Ex. 17 | 180 | TD/30% | MD/15% | 60 | 116 | 0.85 | 1.15 | 0.8 | 1.2 | A | A |
| Comp. | 160 | TD/20% | MD/fixed | 40 | 120 | 1.0 | 1.0 | 1.05 | 0.95 | A | B |
| Ex. 4 | | | width | | | | | | | | |
| Comp. | 180 | TD/20% | MD/fixed | 55 | 110 | 1.05 | 0.9 | 1.1 | 1.0 | A | B |
| Ex. 5 | | | width | | | | | | | | |

### Examples 18 to 20

A cellulose acylate was prepared in the same way as the Example 16 except changing the substitution degree of acetyl group (which may be abbreviated as Ac), a propionyl group (which may be abbreviated as Pr), a butyryl group (which may be abbreviated as Bt), and benzoyl group (which may be abbreviated as Bz) as shown in Table 5. Measurement and packaging evaluation are also performed in the same way as the Example 16.

TABLE 5

| | Ac | Pr | Bt | Bz | | | | | | | | |
|---|---|---|---|---|---|---|---|---|---|---|---|---|
| | substitution | substitution | substitution | substitution | Re | Rth | Formula | Formula | Formula | Formula | Viewing | Color |
| | degree | degree | degree | degree | (nm) | (nm) | (I)*1 | (I)*2 | (II) | (III) | angle | shift |
| Ex. 18 | 1.98 | 0.72 | 0 | 0 | 45 | 128 | 0.9 | 1.1 | 0.85 | 1.1 | A | A |
| Ex. 19 | 2.0 | 0 | 0.7 | 0 | 41 | 122 | 0.8 | 1.15 | 0.9 | 1.2 | A | A |
| Ex. 20 | 2.0 | 0 | 0 | 0.7 | 50 | 130 | 0.86 | 1.2 | 0.8 | 1.15 | A | A |

As shown in Table 5, when a cellulose acylate film according to the present invention whose substitution degree B by a propionyl group, a butyryl group or a benzoyl group is above 0, a cellulose acylate film whose entire substitute is acetyl was used. The viewing angle and color shift as much as Examples 9, 10 and 13 were obtained without adding a retardation increasing agent.

### INDUSTRIAL APPLICABILITY

According to one aspect of the present invention, a liquid crystal cell precisely compensates, high contrast, and improvement on color shift depending the viewing angle at black display time are realized. Especially, VA, IPS or OCB mode of cellulose acylate film, the preparation method thereof, a polarizing plate employing the cellulose acylate plate are disclosed. According to one aspect of the present invention, the contrast is improved, the color shift depending on the viewing angle at the black display time is improved, and especially VA, IPS or OCB mode of liquid crystal display is disclosed.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application Nos. JP2005-263668, JP2005-299129 and JP2006-91751, filed Sep. 12 of 2005; Oct. 13 of 2005 and Mar. 29 of 2006, respectively the contents of which are incorporated herein by reference.

1. A method for producing a cellulose acylate film, comprising the steps of:
a stretching step of stretching a film; and
a shrinking step of shrinking the film.

2. The method according to claim 1, wherein the stretching step comprises stretching the film in a direction of conveying the film, and the shrinking step comprises shrinking the film in a width direction of the film while gripping the film.

3. The method according to claim 1, wherein the stretching step comprises stretching the film in a width direction of the film, and the shrinking step comprises shrinking the film in a direction of conveying the film.

4. The method according to claim 1, wherein at least a part of the stretching step and at least a part of the shrinking step are performed simultaneously.

5. The method according to claim 1, wherein formula (Z) is satisfied:
400−4000/\sqrt{100+X}≧Y≧100−1000/\sqrt{100+X} (Z)
wherein X represents a stretch ratio of the film in the stretching step, and Y represents a shrink ratio of the film in the shrinking step.

6. The method according to claim 1, wherein the stretching and shrinking steps are performed at a temperature higher by 25 to 100° C. than a glass transition temperature of the film at the beginning of each of the stretching and shrinking steps.

7. A cellulose acylate film produced by a method according to claim 1.

8. The cellulose acylate film according to claim 7, which satisfies formula (A):
10≧|Rth(550)10% RH−Rth(550)60% RH|

wherein Rth(550)10% RH and Rth(550)60% RH are retardations in a film thickness direction at a wavelength of 550 nm at 25° C. and at 10% RH and 60% RH, respectively.

9. The cellulose acylate film according to claim 7, which has an in-plane retardation Re of 20 to 100 nm at a wavelength of 550 nm and has a retardation in a film thickness direction Rth of 100 to 300 nm at a wavelength of 550 nm.

10. The cellulose acylate film according to claim 7, which satisfies formulae (I) to (III):
0.4<{(Re(450)/Rth(450))/(Re(550)/Rth(550))}<0.95 and 1.05<{(Re(650)/Rth(650))/(Re(550)/Rth(550))}<1.9 (I)
0.1<(Re(450)/Re(550))<0.95 (II)
1.03<(Re(650)/Re(550))<1.93. (III)
wherein Re(λ) is an in-plane retardation Re at a wavelength of λ nm, and Rth(λ) is a retardation in a film thickness direction Rth at a wavelength of λ nm.

11. The cellulose acylate film according to claim 7, which comprises cellulose acylate satisfying formulae (IV) and (V):
2.0≦(DS2+DS3+DS6)≦3.0 (IV)
DS6/(DS2+DS3+DS6)≧0.315 (V)
wherein DS2 is a substitution degree of a hydroxyl group at 2-position of a glucose unit in the cellulose acylate, DS3 is a substitution degree of a hydroxyl group at 3-position of the glucose unit, and DS6 is a substitution degree of a hydroxyl group at 6-position of the glucose unit.

12. The cellulose acylate film according to claim 7, which comprises a cellulose acylate satisfying formulae (VI) and (VII):
2.0≦A+B≦3.0 (VI)
0<B (VII)
wherein A is a substitution degree of a hydroxyl group in a glucose units of the cellulose acylate by an acetyl group, and B is a substitution degree of substitution of a hydroxyl group in the glucose unit by one of a propionyl group, a butyryl group and a benzoyl group.

13. The cellulose acylate film according to claim 7, which comprises a retardation increasing agent.

14. A polarizing plate comprising: a polarizer; and a pair of protecting films sandwiching the polarizer, wherein at least one of the protecting films is a cellulose acylate film according to claim 7.

15. A liquid crystal display comprising a cellulose acylate film according to claim 7.

16. A liquid crystal display comprising: a liquid crystal cell of one of IPS, OCB and VA modes; and a pair of polarizing plates sandwiching the liquid crystal cell, wherein at least one of the polarizing plates is a polarizing plate according to claim 14.

17. The liquid crystal display according to claim 16, wherein the liquid crystal cell is of VA mode, and the at least one of the polarizing plates is between the liquid crystal cell and a backlight.
